(19) United States
(12) Patent Application Publication
(10) Pub. No.: US 2019/0178657 A1
(43) Pub. Date: Jun. 13, 2019

(54) SYSTEMS AND METHODS FOR VISUALIZING, CONTROLLING AND DELIVERING CONTENT

(71) Applicant: Figayou LLC, Boston, MA (US)

(72) Inventors: Hamid Benbrahim, Boston, MA (US); Greta Meszoely, Boston, MA (US)

(21) Appl. No.: 16/216,573

(22) Filed: Dec. 11, 2018

Related U.S. Application Data
(60) Provisional application No. 62/597,684, filed on Dec. 12, 2017.
(60) Provisional application No. 62/597,691, filed on Dec. 12, 2017.
(60) Provisional application No. 62/597,688, filed on Dec. 12, 2017.
(60) Provisional application No. 62/597,696, filed on Dec. 12, 2017.
(60) Provisional application No. 62/597,693, filed on Dec. 12, 2017.

(51) Int. Cl. G01C 21/34; H04W 4/08; G06Q 50/00

(52) U.S. Cl. CPC G01C 21/3438; G06Q 50/01; H04W 4/08; G01C 21/3476

(57) ABSTRACT

The present disclosure describes systems and methods for users to interact with one another by communicating through the user interface of their respective client devices. One aspect of this communication includes the ability for users to form a communication group with at least one other user. A communication group may be a computing group in which users within that group communicate various content items (e.g., images, text messages, current location, relative location, group invitations, directions request, third-party information, point of interest request etc.) with one another using their respective client devices to the exclusion of other users not included in that group.

### CROSS-REFERENCE TO RELATED APPLICATIONS

The present application claims the benefit of and priority to each of U.S. Provisional Application No. 62/597,684, titled “DISTRIBUTIVE VIEW CONTROL AND JOINT-SCROLLING,” filed Dec. 12, 2017, U.S. Provisional Application No. 62/597,688, titled “EVENT DRIVEN CONTENT DELIVER AND ACCESS,” filed Dec. 12, 2017, U.S. Provisional Application No. 62/597,691, titled “CO-LOCATION TRANSACTION VALIDATION,” filed Dec. 12, 2017, U.S. Provisional Application No. 62/597,693, titled “CALENDAR NAVIGATION AND RATIONALIZATION,” filed Dec. 12, 2017, U.S. Provisional Application No. 62/597,696, titled “DYNAMICALLY COORDINATED GROUP NAVIGATION,” filed Dec. 12, 2017, the disclosures of which are incorporated herein by reference in their entireties for all purposes.

### FIELD OF THE DISCLOSURE

The present solution relates generally to systems and methods for screen-sharing and joint screen control among users of computer devices.

The present solution relates generally to computer systems that deliver and provide access to content to users upon the occurrence of one or more events.

The present solution relates to computerized validations of transactions through proof of co-location of transaction parties and of transaction content.

The present solution relates generally to visualization of scheduled events in a computer system and computer-generated notifications relating to the scheduling of events.

The present solution relates generally to coordinating navigation among a group of computer device users.

### BACKGROUND

Unless otherwise indicated herein, the materials described in this section are not prior art to the present disclosure and are not admitted to be prior art by inclusion in this section.

### Distributive View Control and Joint-Scrolling

In today's technological environment where computer device users share images, maps, messages and many more content items with one another and with groups simultaneously, it may be difficult for users to communicate efficiently about the items being shared.

Current computer systems exist in which many users can simultaneously view the same document in real time from individual devices, such as Google Docs. Systems also currently exist where a user can broadcast their screen to one or more devices, and users viewing those devices can follow the broadcast user's actions in real time, such as Crestron.

However, current systems do not allow multiple users to simultaneously share their screens with one another and control in real time the viewing screen of other users in a group.

### Event Driven Content Delivery and Access

Information is provided to individuals through a variety of means which may include news services and peer to peer communications.

Various geofencing mechanisms exist which enable content to be delivered to a users' computer device when that user associates with a defined geographic area.

Computer applications may not enable one or more users to receive content from one another and upon the occurrence of one or more events. Computer application may also not aggregate content regarding one or more events through an artificial intelligence process and present that information to a user.

### Co-Location Transaction Validation

In today's commercial environment, many transactions are conducted by individuals with minimal oversight. A seller may represent a product for sale on a website, such as Craigslist, as having certain functionalities or warrant the product as being of a certain quality. A buyer may wish to purchase that product based on the seller's representations and warranties and meet the seller in person to conduct a transaction. Not all transactions are without incident.

The buyer may later discover the purchased product does not match the representations and/or warranties made by the seller. Accordingly, the buyer may wish to request a refund or otherwise seek legal recourse against the seller.

However, the seller likely advertised the product through a website using an alias and the transaction likely proceeded simply by the seller exchanging the product for the buyer's consideration, without much more. If the buyer cannot prove the seller's identity, that the buyer and seller were co-located at the time of the transaction and the details of the transaction, the buyer may not have sufficient documentation to file a claim for the refund in a court or other tribunal against the seller.

Likewise, a seller will want documentation of the transaction to prove that the seller did not misrepresent the product to a buyer if the buyer later seeks recourse against the seller.

### Calendar Navigation and Rationalization

People can be ambitious in trying to cram as many events into their schedule as possible. Many times, a person may be too ambitious and not realize the practical time constraints in attending all events in their schedule. Google Calendar enables a users' calendar events to be mapped onto Google Maps to enable a user to visualize their schedule of events.

However, that system may simply show events at their times and locations relative to one another and may not alert a user of the feasibility of attending a series of events nor alert a user if intervening events occur which may affect the feasibility of an event schedule.

### Dynamically Coordinated Group Navigation

People have minds of their own. When people form groups, problems arise where one or more individuals may separate from the group, pursue their own adventure and get lost. It can be difficult to keep a group together and to monitor the locations of individuals should they deviate from the group, particularly in unfamiliar locations.

This problem becomes particularly difficult, for example, when a professor brings a student group to a foreign city. Students may not know their way around and may not be able to communicate in the local language.

Programs, such as Google maps, enable users to obtain directions to points of interest. Users may also use Google maps to send their location to others by dropping a pin. Programs, such as GroupMe and WhatsApp, allow users to communicate in groups.

However, solutions do not exist that enables users to simultaneously monitor the locations of other users in the same group, communicate with those users and choose specified meeting points for the group to encourage coordinated group behavior.

The details of one or more examples are set forth in the accompanying drawings and the description below. Other features, objects, and advantages will be apparent from the description and drawings, and from the claims.

### SUMMARY

### Distributive View Control and Joint-Scrolling

The present solution enables users of grouped computing devices to control in real time the screen of at least one other user's computing device in the same group. The system comprises at least one server which generates a unique identification number for the account of each user. The server may have a message broker system enabled. In the system, users may choose to form a group whereby the server aggregates users into chosen groups organized by the users' unique identification numbers.

The at least one server of the system may implement algorithms which capture at least one user's content browsing actions in real time and simultaneously broadcast those actions to at least one other user in the group. Algorithms may be associated with one or more mathematical models and/or machine learning techniques. Algorithms and associated mathematical models may be defined by human who may program functionality of a server. An algorithm implemented by a server may also predict user actions through one or more machine learning techniques and broadcast user actions predicted by the one or more machine learning techniques to one or more other users.

In one embodiment, a user may use their computing device to actively send content items to the computing devices of one or more other users in a group which may include, text messages, photos, maps, internet links and social media posts. Content items may be sent from the device of one user to at least one server of the system, which may relay the content item to at least one other client device in a group. When a user views content delivered from another user's device, for example, a thumbnail matrix of five images or a list of three images, the user may scroll, swipe, tab or otherwise browse through the content items by using, for example, a touch-screen of the user's device.

In yet another embodiment, the content items may be displayed and scrolled through simultaneously on devices of a user group through a process that combines explicit user action, artificial intelligence, third party event information and device location. It is envisioned herein that one of ordinary skill in the art would appreciate the interchangeability of the methods and systems set forth herein and the ability to aggregate the methods and systems set forth herein, without departing from the spirit and scope of the present solution.

### Event Driven Content Delivery and Access

The systems and methods described herein enable a computer application to deliver various content items to the computer device of a user via a server having a message broker system enabled. Content items may be location-based messages which may be influenced by artificial intelligence learning of activities of a user, timed messages which may be communicated to one or more users by a server and/or by another user of a computer device, and event messages which may constitute information aggregated by an artificial intelligence process executed on a server and be delivered to a user upon occurrence of one or more events.

The systems and methods described herein enable a computer application to deliver content items to one or more users of computer devices through a variety of methods. The computer application may deliver content items to computer devices of one or more users via a server which may have a message broker system enabled. Content items may be delivered to one or more users according to their individual and/or collective physical locations, a timing feature and/or the occurrence of one or more events which may trigger delivery of specific content items and/or content items associated with the one or more events.

### Co-Location Transaction Validation

The systems and methods of the present solution enable buyers and sellers to validate transactions through documentation of co-location of the parties at the time of the transaction and written descriptions of the transaction details. The systems and methods of the present solution enable users to initiate a co-location transaction validation, agree on content of the transaction, certify the content is an accurate representation of the transaction, archive a report of the transaction in at least one server and retrieve that report should disputes between the transacting parties arise later.

The systems and methods of the present solution may also be used to validate the presence of at least one user at a specific location or to validate any form of communication which may occur between individuals, including document certification.

### Calendar Navigation and Rationalization

The systems and methods of the present solution may enable one or more users of computerized calendars and/or any type of event schedule to visualize their scheduled events on a map viewport and receive appropriate alerts. In an embodiment, the systems and methods of the present solution may alert the user of the feasibility of attending a specific schedule of events and/or alert the user of intervening events which may affect the feasibility of attending a specific schedule of events. In an embodiment, the systems and methods of the present solution may prompt a user to rationalize their calendar of events to exclude certain events and/or to determine a more rational series of events so that the user may feasibly attend and/or participate in all events in that users' calendar.

### Dynamically Coordinated Group Navigation

The systems and methods of the present solution enable groups of computerized device users to choose mutual points of interest on a map, visualize simultaneously the locations of other group members and communicate interactively with one another.

The present solution enables each member of a group to visualize their own location relative to the location of other group members. The present solution also enables group members to visualize group members' locations relative to one or more points of interest relevant to the group.

Visual representation of the group's behavior enables group members to easily converge at a common meeting point and to stay together within a given area.

### BRIEF DESCRIPTION OF THE DRAWINGS

The foregoing and other objects, aspects, features, and advantages of the present solution will become more apparent and better understood by referring to the following description taken in conjunction with the accompanying drawings, in which:

FIG. 1 is a block diagram depicting an example computing environment with various components of the systems and methods described herein.

FIG. 2 is a block diagram depicting interrelationships between client devices in at least one embodiment of the system of the present solution. When any user in a group acts upon content elements shared among members of a group, other users of that group may see the acts upon the content items taken by other members of the group simultaneously and in real time.

FIG. 3A is a screenshot of a client device operating a map viewport in a home messaging screen in accordance with at least one embodiment of the systems and methods described herein.

FIG. 3B is a screenshot of a client device operating a group in accordance with at least one embodiment of the systems and methods described herein.

FIG. 3C is a screenshot of a client device operating a map viewport showing two users locating one another in accordance with at least one embodiment of the systems and methods described herein.

FIG. 4 is a flow diagram showing actions taken on content items by users, artificial intelligence and servers in facilitating the distributive view control and joint-scrolling mechanism of at least one embodiment of the present solution.

FIG. 5 is a block diagram depicting interrelationships between client devices in one or more embodiments of the system of the present solution. Users may form groups with one another through which they may communicate and visualize one another's calendars and/or schedules of events on an interactive map viewport.

FIG. 6 is a flow diagram describing a series of actions taken by a server, by one or more users, an/or by a computer application in delivering content items to the one or more users in accordance with one or more embodiments of the present solution.

FIG. 7 is a screenshot of a client device operating a computer application in accordance with one or more embodiments of the present solution. The screenshot shows a map viewport in a home messaging screen in accordance with at least one embodiment of the systems and methods described herein.

FIG. 8A is a screenshot of a client device operating a computer application in accordance with one or more embodiments of the present solution. The screenshot shows a group interface where one user is pictured composing a location-based content item to a second user who is a party to the same group interface.

FIG. 8B is a screenshot of a client device operating a computer application in accordance with one or more embodiments of the present solution. The screenshot shows a group interface where one user has communicated a location-based content item to a second user, which that second user may only access when that second user arrives at a specific geographic location.

FIG. 9 is a block diagram depicting interrelationships between client devices in at least one embodiment of the system of the present solution. Users may co-locate with one another and subsequently form a group to which content items may be added, which may include: a photo of the product sold, representations and warranties of the seller, a text description of the sale agreement and a certification by the parties that the information is agreed upon and accurate. These content items may be saved in a server and retrieved upon user request.

FIG. 10A is a screenshot of a client device operating a computer application in accordance with one or more embodiments of the present solution. The screenshot shows a map viewport in a home messaging screen in accordance with at least one embodiment of the systems and methods described herein.

FIG. 10B is a screenshot of a client device operating a computer application in accordance with one or more embodiments of the present solution. The screenshot shows a group between users of the computer application in which users may, for example, share content items with one another.

FIG. 10C is a screenshot of a client device operating a computer application in accordance with one or more embodiments of the present solution. The screenshot shows a map viewport where two users of different client devices have located one another and enabled a directions feature between their respective positions.

FIG. 11A is a flow diagram showing actions taken by one or more users through a computerized device and by at least one server to initiate and consummate a co-location transaction validation, in accordance with one or more embodiments of the present solution.

FIG. 11B is a flow diagram showing actions taken by one or more users through a computerized device, by at least one server, and by a third-party agency to certify documents in accordance with one or more embodiments of the present solution.

FIG. 12A is a pictorial representation of a screenshot of a buyer client device completing a co-location transaction validation in accordance with one or more embodiments of the present solution.

FIG. 12B is a pictorial representation of a screenshot of a seller client device completing a co-location transaction validation in accordance with one or more embodiments of the present solution.

FIG. 13 is a block diagram depicting interrelationships between client devices in one or more embodiments of the system of the present solution. Users may form groups with one another through which they may communicate and visualize one another's calendars and/or schedules of events on an interactive map viewport.

FIG. 14A is a flow diagram describing a series of actions taken by a computer system in mapping calendar events and alerting the user of the feasibility of an event schedule in accordance with one or more embodiments of the present solution.

FIG. 14B is a flow diagram describing a series of actions taken by a computer system in alerting a user of travel time notifications related to events in a user's calendar in accordance with one or more embodiments of the present solution.

FIG. 15A is a screenshot of a client device operating a computer application in accordance with one or more embodiments of the present solution. The screenshot shows a map viewport in a home messaging screen in accordance with at least one embodiment of the systems and methods described herein.

FIG. 15B is visual representation of a computer application showing a map viewport which includes a visual representation of four scheduled events, numbered 1, 2, 3, 4, travel paths and a travel time between those events, and an alert symbol in accordance with one or more embodiments of the present solution.

FIG. 15C is a screenshot of a client device operating a computer application in accordance with one or more embodiments of the present solution. The screenshot shows a map viewport where two users of different client devices have located one another and enabled a directions feature between their respective positions.

FIG. 15D is a screenshot of a client device operating a computer application in accordance with one or more embodiments of the present solution. The screenshot shows a group between users of the computer application in which users may, for example, share content items with one another.

FIG. 16A is a screenshot of a schedule of events in a calendar of a computer application.

FIG. 16B is a screenshot of certain events from the schedule of events shown in FIG. 5A displayed in a map viewport in accordance with one or more embodiments of the present solution.

FIG. 17 is a block diagram depicting interrelationships between client devices in at least one embodiment of the system of the present solution. Users may form groups with one another through which they may communicate and visualize one another's locations on an interactive map.

FIG. 18 is a flow diagram describing a series of actions taken by a user and computer system in one or more embodiments of the present solution.

FIG. 19A is a screenshot of a client device operating a computer application in accordance with one or more embodiments of the present solution. The screenshot shows a map viewport in a home messaging screen in accordance with at least one embodiment of the systems and methods described herein.

FIG. 19B is visual representation of a map viewport of a user which includes a central point of interest, locations of other group members, location of the user and directions from the user's location to the point of interest.

FIG. 19C is a screenshot of a client device operating a computer application in accordance with one or more embodiments of the present solution. The screenshot shows a map viewport where two users of different client devices have located one another and enabled a directions feature between their respective positions.

FIG. 19D is a screenshot of a client device operating a computer application in accordance with one or more embodiments of the present solution. The screenshot shows a group between users of the computer application in which users may, for example, share content items with one another.

FIG. 20 is a screenshot of a client device operating a computer application in accordance with one or more embodiments of the present solution. The screenshot shows an activated point of interest navigation showing the locations of the client devices of five users in relation to a point of interest and a statistical distribution indicator.

In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a computing environment which may be useful for practicing embodiments described herein.
Section B describes embodiments of systems and methods for distributive view control and joint-scrolling.
Section C describes embodiments of systems and methods for event driven content delivery and access.
Section D describes embodiments of systems and methods for co-location transaction validation;
Section E describes embodiments of systems and methods for calendar navigation and rationalization.
Section F describes embodiments of systems and methods for dynamically coordinated group navigation.

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure.

### A. Computing Environment

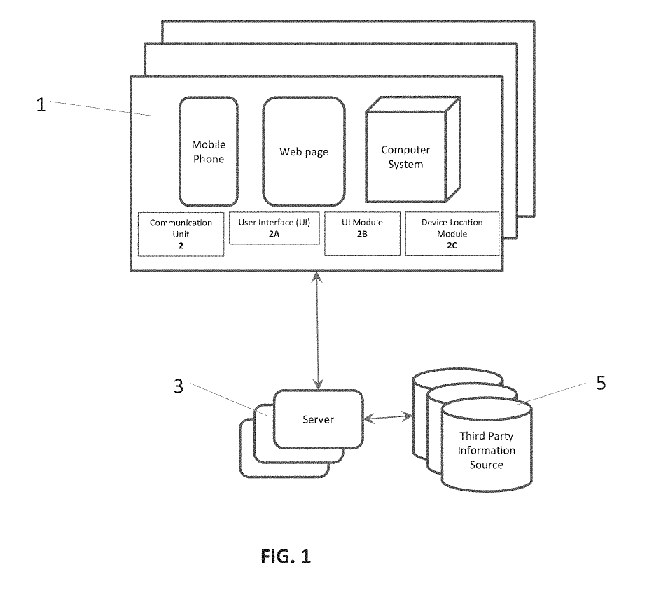

FIG. 1 depicts a pictorial representation of a computing environment with various components of the systems and methods described herein in which illustrative embodiments may be implemented. As shown in FIG. 1, client device 1 may be, but is not limited to portable, mobile, or other devices, such as mobile phones (including smartphones), laptop computers, desktop computers, tablet computers, smart television platforms, personal digital assistants (PDAs), server computers, mainframes, and the like. The client device 1 may include at least one communication unit 2, at least one user interface 2A and at least one device location module 2B. The client device 1 may be associated with at least one user or user account existing in the server 3, which may have a message broker system enabled.

Client device 1, in one example, utilizes communication unit 2 to communicate with external client devices via one or more servers 3 or third-party information sources 5 (e.g., a wired or wireless network, an Internet page, a website populated with consumer reviews, event information, etc.). Communication unit 2 may include a server 3 or third-party information source interface card, such as an Ethernet card, an optical transceiver, a radio frequency transceiver, or any other type of device that can send and receive information. Other examples of such server 3 or third-party information source interfaces may include Bluetooth, 3G and WiFi radio components as well as Universal Serial Bus (USB). In some examples, client device 1 may utilize communication unit 2 to communicate, via server 3 or a third-party information source 5, with another client device 1.

In the example of FIG. 1, client device 1 may include a user interface (UI). The UI may serve as an input device, as an output device, or as both an input and output device. A UI may be implemented using various technologies. For example, a UI may serve as an input device by a user using the UI of client device 1 as a presence-sensitive input screen, such as a resistive touchscreen, a surface acoustic wave touchscreen, a capacitance touchscreen, a projective capacitance touchscreen, a pressure sensitive screen, an acoustic pulse recognition touch screen, or another presence-sensitive technology. The UI of client device 1 may include a presence-sensitive screen that may receive tactile input from a user of the client device 1. The US of client device 1 may receive indications of the tactile input by detecting one or more gestures from the user (e.g., when the user touches of points to one or more locations of the UI of client device 1 with a finger or a stylus pen).

Client device 1 may function as an output (e.g., display) device using any of one or more display technologies, such as liquid crystal display (LCD), dot matrix display, light emitting diode (LED) display, organic light emitting diode (OLED) display, e-ink, or similar monochrome or color display capable of outputting visible information to a user of client device 1. For example, the UI of client device 1 may present output to a user of client device 1 at a presence-sensitive screen. The UI may present the output as a graphical user interface (GUI) which may be associated with functionality provided by client device 1. For example, UI of client device 1 may present various user interfaces of applications executing at or accessible by client device 1 (e.g., an electronic message application, an Internet browser application, etc.). A user of client device 1 may interact with a respective UI of an application to cause client device 1 to perform operations relating to a function.

In the example of FIG. 1, client device 1 may include a user interface (UI) module 2B device location module 2C. Modules 2B and 2C may perform operations described using hardware, software, firmware, or a mixture of hardware, software and firmware residing in and/or executing at client device 1 and/or at server 3. Client device 1 and/or server 3 may execute modules 2B and 2C with one processor or with multiple processors. In some embodiments, client device 1 and/or server 3 may execute modules 2B and 2C as a virtual machine executing on underlying hardware. Modules 2B and 2C may execute as a service of an operating system or computing platform or may execute as one or more executable programs at an application layer of a computing platform.

UI module 2B may be operable (e.g., by one or more processors of client device 1, or by one or more processors of an external client device through the server 3), to receive input from client device 1 or from an external client device through the server 3. For instance, UI module 2B may receive one or more actions of user input from client device 1. Responsive to receiving a user input, UI module 2B may provide data, based on the received action, to one or more other components of client device 1 (e.g., device location module 2C), and may also provide data from client device 1 to the server 3, which may be communicated by the server 3 to an external client device. UI module 2B may be operable to provide client device 1 output for display, and for transmittal of display of UI module 2B to the server 3 which may broadcast the UI module of client device 1 to one or more external client devices. Responsive to receiving data for display, UI module 2B on client device 1 or on an external client device, may cause UI module 2B to display one or more graphical user interfaces. That is, UI module 2B may, in some examples, enable one or more components of client device 1 to receive user input performed on client device 1, and/or provide output to a user at client device 1 and/or communicate the output displayed on client device 1 to server 3, which may, in some examples, communicate the output displayed on client device 1 in real time to one or more external client devices.

Device location module 2C may be operable (e.g., by one or more processors of client device 1 and/or through communication of client device 1 with one or more processors of server 3) to determine a current location of client device 1 and a current time. For example, client device 1 may include a global positioning system (GPS) radio (not shown) for receiving GPS signals (e.g., from a GPS satellite). Device location module 2C may analyze the GPS signals received by the GPS radio and determine the current location of client device 1 and the current time. Client device 1 may include other radios or sensor devices (e.g., cellular radio, WiFi radio, cellular ID, inertial sensors, a barometer, radio-frequency identification (RFID), near-field communication (NFC), Bluetooth including Bluetooth beacons, terrestrial transmitters, etc.) capable of receiving signal data from which device location module 2C may determine location information as coordinate location information. In other embodiments, device location module 2C may determine location information as one or more general or relative locations, such as an address, a place, a country, a city, a type of building (e.g., a library, an airport, etc.) and may also determine relative location information from location of client device 1 in relationship to at least one other external client device. Client device 1 may immediately transmit through communication unit 2 the determined current or relative location information, or may store one or more determined current or relative locations (e.g., as determined previous locations and previous times), and transmit the stored information at a later time. Communication unit 2 may transmit one or more locations and times from client device 1 via server 3 and may also receive one or more locations and times from at least one external client device via server 3 or directly from a third-party information source accessible by client device 1 through a network.

Client device 1 may determine a current location of client device 1 and a current time if client device 1 receives permission from the user to determine the information. Further, client device 1 may determine a relative location of client device 1 to at least one external client device if user of client device 1 gives permission to communicate location information to the at least one external client device. This communication may be accomplished by client device 1 enabling permission to share location information which is relayed to server 3, and server 3 subsequently may relay that permission of user of client device 1 to the at least one external device. Additionally, client device 1 may transmit location information if client device 1 receives permission from the user to share location information (e.g., with a contact). That is, in situations in which client device 1 may collect, data mine, analyze and/or otherwise make use of personal information about the user, the user may be provided with an opportunity to control whether programs or features of client device 1 can collect user information (e.g., previous communications, information about a user's email, a user's social network, social actions or activities, a user's preferences, a user's current location, a user's location history, or a user's website history, etc.). The user may also be provided with an opportunity to control whether and how client device 1 may transmit such user information, including to server 3, to third-party sources of information 5 and to at least one external client device through the server 3. In addition, certain data may be treated in one or more ways before it is stored (e.g., on server 3 or on client device 1), transmitted (e.g., from client device 1 to server 3 and subsequently from server 3 to at least one external client device or from server 3 to a third-party information source 5), or used by client device 1, so that personally identifiable information is removed. Thus, the user of client device 1 may have control over how information is collected about the user and used by client device 1 and server 3.

### B. Distributive View Control and Joint-Scrolling

With reference now to the figures, exemplary diagrams of data processing environments are provided in which illustrative embodiments may be implemented. It should be appreciated that FIGS. 1 and 2-4 are only exemplary and are not intended to assert or imply any limitation with regard to the environments in which different embodiments may be implemented. Many modifications to the depicted environments may be made.

Account of each device w/Server; Communication w/Server

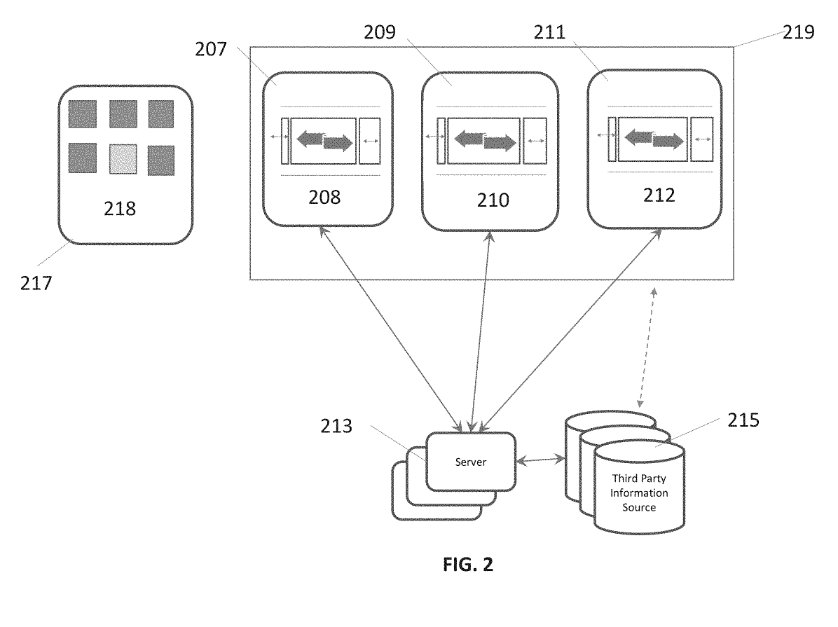

FIG. 2 depicts information exchange architecture between at least one client device 207, 209, 211 associated with a user and at least one server 213, which may have a message broker system enabled and may also exchange information with at least one third-party information source 15 in at least one embodiment of the system of the present solution. Each client device 207, 209, 211 has at least one UI 208, 210, 212, and each client device 207, 209, 211 also has a communication unit 2, UI module 2B and device location module 2C as described above. A user of a client device 207, 209, 211 may enter information through the UI 208, 210, 212 to create an account. The user entered information is received by a server 213 and the server 213 creates an account for the user by assigning the user a unique identification number, which may correspond to each client device used by that user or may correspond to a subset of client devices associated with a given user's account. For the purposes of FIG. 2 and the following exemplary embodiments of the present solution, User A is associated with client device 207, User B is associated with client device 209 and User C is associated with client device 211.

### Grouping

The present solution enables users to interact with one another by communicating through the UI 208, 210, 212, of their respective client devices 207, 209, 211. One aspect of this communication includes the ability for users to form a communication group 219 with at least one other user. A communication group 19 may be a computing group in which users within that group communicate various content items (e.g., images, text messages, current location, relative location, group invitations, directions request, third-party information, etc.) with one another using their respective client devices 207, 209, 211 to the exclusion of other users not included in that group.

In one embodiment, a communication group 219 may be formed when, for example User A, using client device 207, explicitly invites User B and User C to join a group. This group invitation may be communicated from User A's client device 207 to a server 213, which may communicate the group invitation to Users B and C by the unique identification number associated with each Users' respective account. Users B and C may individually accept or reject User A's group invitation. If Users B and C reject User A's group invitation, then no group is formed. If Users B and C accept User A's invitation, then server 13 may aggregate Users A, B and C into a group 19 by the unique identification number associated with each user's account.

Once users are aggregated into a group 219, messages may be communicated to and received on each client device 207, 209, 211 associated with an account as defined by the unique identification number and be accessible on the first device to access the message associated with that account. Messages may also be communicated to and received by all client devices associated with a unique identification number (e.g., iPhone, iPad and Android device all associated with same user's account) and be accessible on each device associated with that account, regardless of temporal access.

Once the server 13 aggregates, for example, User A, User B and User C into a group 19 each user may control in real time the screen of at least one other user's UI 208, 210, 212 in that same group 219 by, for example, swiping, scrolling, or tabbing through content items in the shared group UI 208, 210, 212, which is common among users within a group 219. The server 213 may aggregate content information together (e.g., images 1, 2, 3 and 4) and this content may be held in a queue in the server as well as being displayed to users in that group 219. Each item of content information communicated by a user in a group may constitute an informational payload, which describes the action taken by a user on the content information (e.g., user scrolling from image 1 to image 2 to image 3). The action taken by a user on the informational payload may be transmitted in real time via the server 213 to all or a subset of client devices in the group 219. The server 213 may broadcast actions taken by each user on their separate devices in a group 219 to all or a subset of devices aggregated by the server 213 to be in a single group 219.

The joint-scrolling methods as described herein could also occur through the grouping of client devices associated with users with outside client devices not associated with a user. For example, an outside client device not associated with a user could be a television screen, a billboard, or any other display device which may associate with a network or server. The server 213 could generate a code which could be entered into the outside client device via a UI or entered into client devices associated with users, or both. The outside device could also automatically connect to any or a subset of client devices in a given area, the ability of devices to connect with one another may be controlled through user preferences. All or a subset of connected devices may connect the server 213 and form a group 219 together and therefore be enabled to accomplish a joint-scrolling method with grouped devices through at least one method as described herein.

Users in groups may share content items with one another. Through at least one method and system described herein, user actions taken on those content items may be broadcast to other devices in a group via at least one server 213, which may instruct grouped devices to take the same actions on the content items as have been taken by other users in the group. These actions may be viewed differently on different devices within a group, for example, one client device could be configured for vertical scrolling, one client device could be configured for horizontal scrolling, one client device could be configured to not scroll, but rather show content items, such as images, as they are acted upon by users of other devices in a “highlighted” or “colored” form, for example in a thumbnail matrix. The joint-scrolling feature may be enabled and/or disabled by each user in the group according to individual preferences of the user. A user may also program how content items are acted upon and broadcast to other users in a group, for example, a user could program images 1, 2, 3 and 4 where image 1 is shown for two seconds, then image 2 is shown for 6 seconds, then image 3 is shown for 4 seconds, and then image 4 is shown for 1 second. These programming instructions for various content items can take myriad forms as is known by one of ordinary skill in the art without departing from the spirit and scope of the present solution.

### Explicit User Action (on Content Item)—Joint Scrolling

For example, as shown in FIG. 2, when client devices 207, 209, 211 are in a group 219, the users of those client devices may each have the same display on their respective UI's 208, 210, 212 showing the group 219. When one user, for example, User A on client device 207, swipes, scrolls, tabs or otherwise acts on a content item in UI 208, such as a group of images, that action will be broadcast in real time to the UI's 210, 212 of Users B and C's client devices 209, 211 via the server 213.

Although FIG. 2 shows UI's 208, 210, 212 having horizontal scrolling features, it should be appreciated by one of ordinary skill in the art that content items may be acted on in a manner which may be determined by user preferences (e.g., horizontally, vertically, in a thumbnail matrix, etc.) and each user action on a content item may be displayed on the UI of all or a subset of client devices in a group 19. For example, FIG. 2 shows client device 217 having a UI 218 with content items arranged as a thumbnail matrix. When a user acts on a content item, such as by selecting, scrolling, tabbing, etc., that action will be broadcast in real time to all or a subset of client devices in the group 219. The display of the UI in broadcasting the joint-scrolling of content items by users may be mixed (e.g., User A of client device 207 may have horizontal display enabled, User B of client device 209 may have vertical display enabled, and User C of client device 211 may have a thumbnail matrix or other display form of content items enabled), and when any user takes action on a content item, that action may be displayed in real time to other users in that group 219 in a manner consistent with the user's enabled display preferences.

A user may also enable and/or disable the joint-scrolling feature in their own preferences and if the joint-scrolling feature is disabled, a user's device will not display the actions taken on content items by other users in the group 219.

### Event Driven Actions (Location/Event)

In an embodiment of the present solution, the content items displayed to users of client devices 207, 209, 211 may be populated in accordance with events. An event may be location of a client device, time, third party promotional information, a problem occurring at a specific location in a factory, a disease outbreak, or any other event which may be populated from a third-party information source such as a wired or wireless network. If an event occurs, the server 213 may update the UI of the client devices of all or a subset of users in a group or separately update individual devices not in a group, content information according to the event triggered.

For example, client devices 207, 209, 211 of Users A, B and C are in a group 219 in accordance with an embodiment of the present solution of FIG. 2. The users may be traveling in a remote area of the world, for example, in an African jungle with location module enabled on their respective client devices. An Ebola outbreak starts in the vicinity of the Users which is known through publication of this health information on a third-party information source 215, such as a website. The server 213 may retrieve this Ebola outbreak content information and in real time populate the group 219 of Users A, B and C with this outbreak content information. This information retrieved through the server 213 and populated to the group 219 may include, for example, photos of the Ebola disease so the users know signs to look for, information about outbreak geographic areas so the users know areas to avoid, a map showing outbreak areas which may be color-coded or otherwise marked to indicate outbreak frequency, and any other content information which may be relevant to the event occurring and the users. Once content information is populated to the group 219, the Users may scroll, select, swipe through, tab, or take any other action on the content information and these actions may be displayed to all or a subset of other users in the group 219 so that, for example, the users may coordinate a route to leave outbreak areas and also coordinate the delivery of aid to outbreak areas with one another in real time.

In an example of another embodiment of the present solution of FIG. 2, client devices 207, 209, 211 of Users A, B and C are in a group 219 with their respective device location modules enabled. The users may be in a museum and wish take a tour of the museum. The museum could create an account with the server 213 and invite users through their client devices to join a group 219 for, for example, the Saturday at 10:35 am tour. The museum may also generate a code through the server 13 which users may enter on their client devices to join a group 219 for, for example, the Saturday at 11:00 am tour. The museum may have an expert who leads tours of exhibits, who may do so remotely using an embodiment of the present solution. For example, once the users accept the invitation to join a museum tour group 219 or enter the code of a museum tour group 219, the users will be able to share content and joint-scroll one another's screens through the group 219. However, the group 219 may also be enabled to give different users different abilities to control joint-scrolling or to share content items with the group. For example, the museum expert may be enabled to share content items with users and joint-scroll the UI's of the devices of the group 219, while the users may merely be able to view the group 219 UI as controlled by the expert.

As the group begins their tour and moves from exhibit to exhibit, the museum expert may send the group 219 text, voice, video, or any other form of content information describing the exhibit the group 219 is currently near, as determined by the client device location modules of the users. The museum expert may explicitly populate the group 219 with content information, or may do so automatically through the server 213 sending the user's client devices specific content information triggered by the location of the users in the museum. The museum expert may act upon the content information, such as by scrolling or swiping to a specific image or description of an exhibit, which may be displayed on the UI of the client device of all or a subset of users within a group 219. The content information may also be acted upon, for example, scrolled or swiped through, automatically as determined by the location, either absolute or relative, of a given user's client device. In this example, the museum expert could be at their own computing device not physically associated with the tour group, and provide all this information to the tour group in real time as they move through the museum, just as if the expert were with the group. The expert could also simultaneously control the UI of all or a subset of client devices in the group 219 through joint-scrolling among content information provided to the group 219. The museum expert's tour could also be fully automated and populate the group 219 with content information based on the locations and movement of client devices throughout the museum. Users could also ask questions or give comments to the museum expert directly through the group 219 interface, which could be answered by the expert either explicitly or through an automated response.

Incorporating 3^{rd} Party Info into Acted Upon Content Items

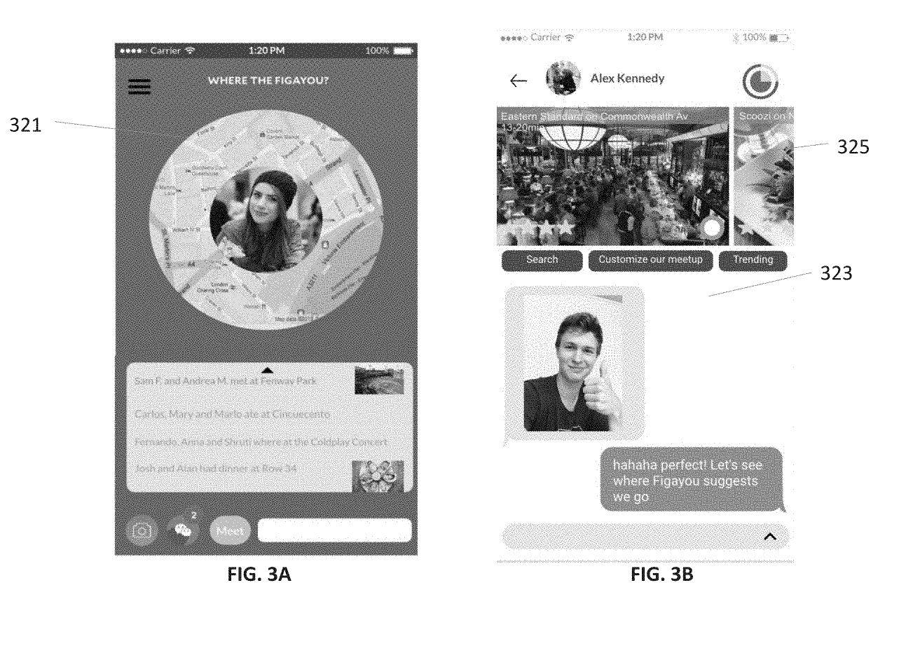

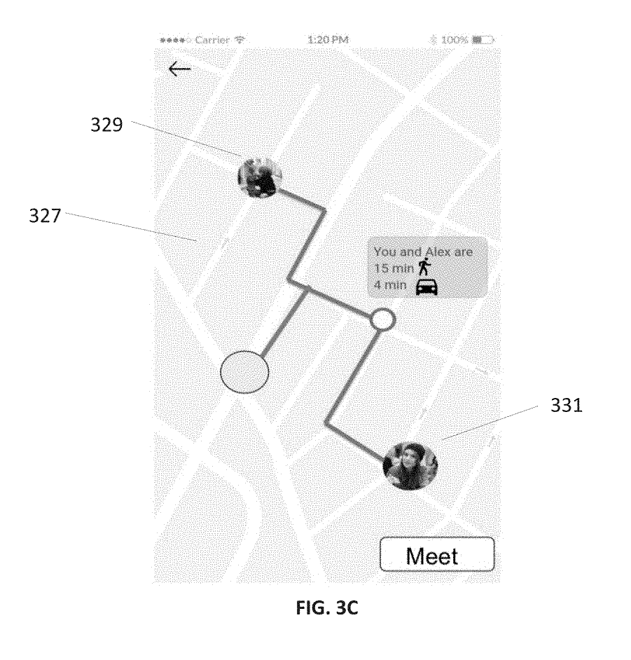

In a further embodiment of the present solution described in FIG. 2, User A of client device 207 may send, for example, a map to at least one other user in the same group 219, for example, to Users B and C of client devices 209 and 211, respectively. The map may be enabled through a third-party source, such as Google maps (see, FIG. 3A and FIG. 3C), which may enable multiple users within a group 219 to control the map viewport (see, FIG. 3A 321) simultaneously through the joint-scrolling mechanism as described above. Joint-scrolling of the map viewport may change the points of interest shown in the map viewport FIG. 3A 321, and this updating may be accomplished by the present solution in various ways.

When one user viewing the map sent by another user acts on that map by, for example, changing the map viewport 321 to a different location, the server 213 may automatically conduct a Google search and update the map viewport 321 with points of interest from Google maps in the new location shown in the map viewport 321. These updates may be automatically communicated from the server 213 to each client device within the group 219 so that all client devices are shown the same map viewport 321 having updated content.

Similarly, the server 213 may automatically communicate with at least one third-party information source 215 and update client devices in a group 219 when any type of content item is communicated within a group, which may include, for example, reviews of restaurants in a given area, a poll populated with third-party information such as store names, images, etc. For example, FIG. 3B shows an example of a group 219 interface and FIG. 3A may show the UI of a single client device. The content items 325 may be populated automatically by the server 213 to the group 219 based on the server 213 updating client devices automatically when, for example, the client devices view the map viewport 321 in a specific location.

In a further embodiment of the above example, one user may viewing a map sent by another user and may act on that map by, for example, changing the map viewport 321 to a different location. In this situation, rather than each client device receiving updated information through a network search conducted by the server, one device in the group 219 may receive updated information of the different map viewport 321 location and then automatically update the map viewports 321 of all or a subset of other devices in the group 219. This client device updating method may be accomplished in various ways. For example, the client device which updates the map viewports of at least one other client device in the group 219 may conduct a network search, such as a Google search, through the server 213 and subsequently populate the map viewports 321 of at least one other client device in the group 219 with the results obtained from the search. Additionally, the client device which updates the map viewports 21 of at least one other client device in the group 19 may conduct a network search, such as a Google search, directly through the Google website without interacting with the server 213. Each client device may be connected to a third-party information source 215, such as a wired or wireless internet network, without interacting with a server 213. Each client device may also be connected to a server 213 which does not prevent a client device from bypassing the server 213 to directly access a third-party information source, such as a network.

### Artificial Intelligence (Content Items Populated+Scrolled Via AI)

In another embodiment, the content items displayed to a group 219 can be defined by and populated according to a script or process incorporating artificial intelligence of at least one user in the group 219 processed through a server 213. Artificial intelligence of a user may include any available information or history about a user, which may be, for example, age, user preferences, available history of using a computer application such as an application associated with the system and methods described herein, available internet history, social media history, current location, historical locations, events which may occur or have occurred at a given location associated with a user. The content items displayed to at least one user of a group 19 may be any list of information that can be displayed that may be acted upon by a user, for example, by scrolling through, clicking on, selecting, tabbing through, swiping, etc. The artificial intelligence script or process may aggregate artificial intelligence from one or more users in a group 219 and may maximize, minimize, or in any other way statistically determine preferences of a group 219 or individual user. The artificial intelligence script or process may populate content items to the group 219 based on artificial intelligence of an individual user or an aggregate group of users.

In an embodiment, a server and/or computer application may implement algorithms which capture at least one user's content browsing actions in real time and simultaneously broadcast those actions to at least one other user in the group. Algorithms may be associated with one or more mathematical models and/or machine learning techniques. Algorithms and associated mathematical models may be defined by human who may program functionality of a computer application and/or a server. An algorithm implemented by a server and/or a computer application may also predict user actions through one or more machine learning techniques and broadcast user actions predicted by the one or more machine learning techniques to one or more other users.

In an embodiment, an algorithm may apply a number of machine learning technique to capture actions taken by one or more users on a content item and broadcast that action to the client device of one or more other users. An embodiment of a machine learning technique applied by an algorithm of the present solution may include any machine learning technique such as backpropagation, a clustering technique such as K-means, neural networks, a regression analysis such as logistic regression, or any other machine learning technique.

The one or more machine learning techniques applied by an algorithm may assign a value to an action taken by a user on a content item, such as swiping, highlighting, or scrolling. The value assigned may be defined by the action taken and may also be defined by the relevance of that action to one or more other users. Actions which have one or more values above a threshold may be chosen by a machine learning technique and may be broadcast to the client devices of one or more users. The client devices of users to which an action may be broadcast may be defined by a threshold value for a user. For example, the machine learning technique may discriminate among users and only broadcast one or more actions taken by a first user to one or more other users whose value, as defined by a machine learning technique, is above or below a threshold.

In an embodiment, an algorithm of the present solution may apply a machine learning technique which aggregates all or a subset of a user's history of actions taken on all or a subset of content items. For example, a machine learning technique may aggregate the deletion actions of a user on photos provided by one or more other users in a group within the past two years, two weeks, or any other time period which may be defined by a user, by a server, by an algorithm, or may be defined in any other way. Using this aggregated data, an algorithm may create an action-reaction map which may associate user actions with the subsequent actions of one or more other users.

An action-reaction map may be in many forms which may include a lookup table where an action by one user is defined in a first row and a reaction by one or more other users is defined in a second row. An action-reaction map may be a mathematical function which defines an action by one user as an input and computes the reaction of one or more other users as an output. The above examples are non-limiting and the algorithm may aggregate data in any way accessible and/or computable via a computer. One or more algorithms may run in series and/or in parallel with one or more other algorithms. Each algorithm may apply one or more machine learning techniques.

A machine learning technique applied by an algorithm may analyze an action-reaction map and may apply a machine learning technique, such as backpropagation, to discover a mathematical model that may predict reactions based on actions from the action-reaction map. Backpropagation may be an algorithmic machine learning technique which updates values of a set of parameters in a set of mathematical functions. In an embodiment, a backpropagation model may correlate reaction outputs to action inputs and/or correlate action inputs to reaction outputs. A model may be discovered through backpropagation which predicts reactions from actions. From this model, an algorithm may predict an action which may be taken by a user when a content item is sent to them. That predicted action done by a user on a content item may be displayed to one or more other users in accordance with the prediction.

One or more secondary algorithms may apply a model and/or prediction outputs as determined by an initial algorithm. The one or more secondary algorithms may apply an identical and/or different machine learning technique from the initial algorithm. The one or more secondary algorithms may use one or more outputs of other algorithms as inputs to other machine learning techniques and/or mathematical models which may exist individually and/or as a system. A system of machine learning techniques and associated algorithms may be programmed by a human and/or by one or more machine learning techniques over a period of time to process data inputs and outputs in a certain way.

A machine learning technique may learn parameters associated with one or more user actions and assign one or more values to those user actions. Parameters associated with one or more user actions and the values assigned to an action may be corrected over time through an iterative error calculation and correction process. An iterative error calculation and correction process may compute a prediction for a given reaction of one or more other users based on the action of a user. The algorithm may apply the machine learning technique to observe the actual reaction taken by one or more other users. The machine learning technique may then compute a difference between the prediction and the actual reaction, which is the error. The error may then be backpropagated through a mathematical model which updates the parameters of the mathematical model in real time to minimize error.

Over time through iterative error corrections, a machine learning algorithm applied by an algorithm of an implementation of the present solution may enhance predictions of user actions on content items and of reactions taken by one or more other users to that user action. Predictions may be used to inform decisions of a server and/or of a computer application executing an algorithm about which actions to broadcast and how. A server and/or computer application may broadcast an action to one or more other users based on a prediction value determined by a machine learning algorithm. User actions on content items may also be broadcast to one or more other users in real time outside of an algorithmic prediction relating to that action.

In another embodiment, content items may be displayed to a user or user group by at least one server according to artificial intelligence obtained from at least one user within a group. Artificial intelligence of users may include all or a subset of available history of a user or user group and may also include third party intelligence, which may include user age, preferences, historical use of the present system, social media history, location and current events occurring in that location. The artificial intelligence algorithm may determine the content items displayed to a user or user group through an algorithm executed by at least one server of the system that may maximize or minimize at least one utility function, such as aggregate user preferences or aggregate available history, of the users of a group. The server may distribute content items determined by that artificial intelligence algorithm to a user or user group and at least one user in a group may take action on the content items displayed, such as by swiping, scrolling or tabbing through the displayed content items, and these actions may be simultaneously broadcast in real time to at least one other user in the group.

In an embodiment, an artificial intelligence algorithm may apply a machine learning technique which may build similarity measures between users and available user histories, build clusters of users based on available data, predict user actions, and refine predictive algorithms based on collected user data. From inputting available user data such as social media history and interactions (e.g., likes, retweets, friends, etc.), internet browsing data and any other available data, content items may be selected and distributed to one or more users. The distribution of content items to one or more users may be defined by a similarity measure and/or by clustering of users.

A similarity measure may determine, for example, how similar two users are to one another based on available data and/or how well a certain user fits within a group of users based on available data. An algorithm may apply a variety of techniques to determine a similarity measure, for example, hemming distance. A plurality of users may be determined to be similar when a machine learning technique determined that the users' history of actions are similar. For example, an algorithm may look up an action taken by one user in an action-reaction map defined by a specific circumstance. The algorithm may compare that action taken in that specific circumstance with an action taken by one or more other users in a similar or identical circumstance. The comparison of actions in similar circumstances may cause an algorithm to predict an action, and this prediction may serve as a basis for selecting and distributing content to the one or more similar users.

An algorithm may apply a machine learning technique to cluster groups of a plurality of users together based on a number of human-chosen and/or algorithmically determined attributes of those users. For example, a plurality of users may be clustered into a group based on the type of content each user shares with their friends, time spent by each user viewing or interacting with a type of content, the number of times each user interacts with a server and/or computer application each day, or any other available data about one or more users. Users may be clustered by any clustering technique known in the art, for example, K-means. A machine learning technique applied by an algorithm may learn behavior of the one or more users through, for example, creation and analysis of an action-reaction map for each user which may be updated in real time. Based on the machine learning technique analysis, the algorithm may be able to predict actions of a plurality of users in a category. From these predicted actions, an algorithm may distribute content items to the plurality of users in a cluster and move through that content (e.g., swipe or scroll from one content item to the next), jointly on the client devices of all or a subset of clustered users.

In an embodiment, an algorithm which may apply a machine learning technique may maximize and/or minimize a utility function. Maximization and/or minimization of one or more utility functions may influence the type and timing of content items distributed to one or more users. A utility function may be a value an algorithm and/or machine learning technique seeks to maximize and may be associated with a business objective. For example, a business may want to target advertisements to a cluster of users that maximizes profitability for that business, profitability being the utility function. The business may distribute an advertisement through a server and/or computer application to client devices of users. The algorithm applying a machine learning technique may track user reactions to the advertisement, e.g., who clicks on advertisement and who buys an advertised product after clicking. The algorithm may cluster users who bought items pursuant to the first advertisement into a group to which a second advertisement may be sent at a later date, the maximum profitability group. The algorithm will iterate this process again for the second advertisement and so on to track individual users and/or clusters of users to whom advertisements may be most effectively sent to maximize profitability of those advertisements. The algorithm may employ a machine learning technique, such as neural networks, to generate predictions of future user actions based on previous actions. Advertisements may be distributed and displayed jointly to clusters of individuals based on user actions learned through a machine learning technique that maximizes a desired utility function. An algorithm may adjust the parameters of an advertisement distribution through an iterative error minimization process refined through a machine learning technique.

Predicting may be used by a server and/or computer application to broadcast content items to the client devices of users, determine similarity of users, group users in clusters, or to accomplish any other function desired by a human and/or computer.

In another embodiment, the content items may be displayed to a user or user group by at least one server according to third party information, such as an event, or according to a device's location. An event may be defined by third party information, such as promotional advertising, a problem occurring in a specific location in a factory, a remote medical event such as a disease outbreak, and may also be defined by location of a client device, such as the location of a user's device in a museum. The content items may be displayed to a user or user group according to such event or location when, for example, an algorithm of at least one server of the system is triggered by the occurrence of an event or by a location change, which may cause the server to retrieve content from third parties, such as the world wide web or social media platforms, and display that retrieved content to a user or user group. A user may then scroll, swipe or tab through the displayed content items on the user's device and these actions taken on the content items may be broadcast simultaneously and in real time to at least one other user's device in the group.

For example, a server and/or computer application may apply an algorithm to determine a distribution strategy for content items, such as advertisements, that maximizes a utility function, for example, profitability. One or more distribution strategies may be defined by a human user and/or discovered through a machine learning technique which may create a mathematical model that may maximize a utility function. Models may be computed in series, in parallel, and/or in any combination with another model or sub-model which may perform similar and/or disparate functions. A utility function may be determined by a user, by a server, by a computer application, by other software, and/or by any computer-readable means. An algorithm may apply a mathematical model which may predict a distribution strategy based on, for example, characteristics indicated by a business as being common among their customer base. Advertisements may be distributed to a plurality of users' client devices clustered by the defined characteristics. The algorithm may analyze the actions taken by the plurality of users and score that distribution strategy according to observed outcomes (e.g., level of customer engagement and purchases completed) and score a strategy according to the observed outcomes. Through subsequent iterations of this prediction, distribution, observance, and scoring process, an algorithm may determine a distribution strategy that maximizes the utility function of profitability.

The display of content items populated to a group 219 can be controlled through an artificial intelligence script or process accomplished through a server 213. For example, the artificial intelligence process (e.g., an algorithm), may determine preferences categories for a group 219 of users. The artificial intelligence script could determine the content items being displayed to a user group 219 in accordance with the preference categories determined by the artificial intelligence process. For example, the script could instruct the server 213 to display “Category A content item for three minutes, then Category B content item for five minutes” and the artificial intelligence script could decide which content item in a list is the Category A item and which content item in a list is the Category B item. The choosing of which image to display can be determined by any artificial intelligence factor, including but not limited to any available information or history about a user, which may be, for example, age, user preferences, available history of using a computer application such as an application associated with the system and methods described herein, available internet history, social media history, current location, historical locations, events which may occur or have occurred at a given location associated with a user. The artificial intelligence script or process may aggregate artificial intelligence from one or more users in a group 219 and may maximize, minimize, or in any other way statistically determine preferences of a group 219 or individual user. The artificial intelligence script or process may scroll or otherwise change the display of content items to the group 19 based on artificial intelligence of an individual user or an aggregate group of users.

No embodiment discussed above should be viewed as limiting, as the systems and methods described herein may populate content items to a group 219 and joint-scroll or otherwise change in real time the display of content items to a group 219 through a mixture of all or a subset of the embodiments described herein.

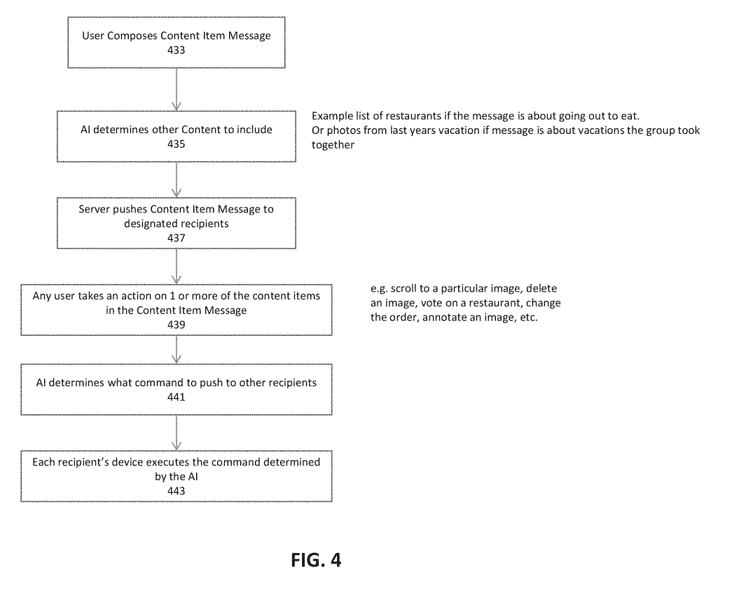

In an embodiment of the present solution, FIG. 4 shows communication of content items by users, artificial intelligence actions on those content items and actions of servers in facilitating distributive view control and joint-scrolling. For example, a user may compose a content item message 433 through a computer application accessible through the UI 208 of the user's client device 207. This content item message 433 may be communicated to one or more other users of a group 219.

An artificial intelligence process 435 may determine additional content items 435 to include with the user's content item message. The artificial intelligence may be determined by available data of all or a subset of users in a group 219. For example, if a user's content item message pertains to going out to eat, an artificial intelligence process 435 may provide a list of restaurants within a specific geographic area. The list of restaurants may be generated according to a feature of the content item message, for example, a list of French restaurants in a specific geographic area may be included if the term “French restaurant” is present in the user's content item message. In another example, if a user references a vacation, the artificial intelligence process may aggregate available photos from a vacation that all or a subset of the users within that group went on last year and include those photos as content items with the content item message composed by a user. All or a subset of users in a group 219 may enable and/or disable an artificial intelligence feature that may include additional content in a content item message composed by a user. A content item message and additional content items determined by an artificial intelligence process 435 may be sent from a client device 207 to at least one other user's client device 209, 211 via a server 213 as individual messages or the content may be packaged together.

The server 213 may push 437 the content item message of the user separately from or packaged together with the content items included by an artificial intelligence process 435. The server 213 may also include some but not all content determined by the artificial intelligence process 435 in the user's content item message 433 when the server pushes 437 the content item message to at least one other user's client device 209, 211. Users many manually or through preference settings control what content determined by the artificial intelligence process 35 may be included when the server 213 pushes 437 the content item message to the client devices 209, 211 of designated user recipients.

Once the server 213 pushes 437 a content item message to the client devices 209, 211, of designated user recipients, the content item message may be viewable by each user who received the content item message on their client device, through a computer application, for example. The content item message may be viewable by all or a subset of users in a group 19 in a group interface 323, an example of which is shown in FIG. 3B. As shown in FIG. 3B, the content items may be shown in a thread which may add content item messages to the group interface 323 sent by each user who is a party to the group 219. Third-party information, for example FIG. 3B 325, may be viewable separate from or aggregated in the same format as other content item messages sent by users.

When a content item message is viewable by one or more other users in the group interface 323, all or a subset of users in that group may take an action on that content item 439. For example, a user may scroll to a particular content item, as shown for example in FIG. 3B 325 where a user may scroll among images of various restaurants, a user may also delete an image, vote on a content item, change the order of content items, annotate a content item such as an image, or take any other action executable by a user through the UI of a computerized device. The user action taken on a content item 439 may be transmitted to a server 213.

Each content item in a group interface may be enabled or disabled to become a poll on which users may vote. This allows users to interactively engage with content items shared by other users in real time. Voting of content items may be enabled automatically, through the preferences of each user, or users may selectively enable voting on specific content items either they themselves or another user may publish to the group interface.

The results of polling may be viewable in myriad formats, which may include, change in color based on level of voting, any type of chart viewable through the user's UI, highlighting of content items, etc.

An artificial intelligence process executable through the server 213, such as an algorithm or script, may determine 441 the action taken by a user on a content item and determine what command to push via the server 213 to at least one other user in the same group 219.

For example, if a user scrolls from image 1 to image 2 of a content item message, that scroll action may be captured by the artificial intelligence process executable through the server. The artificial intelligence process may determine to push that command (e.g., “scroll from image 1 to image 2”) via the server 213 to other devices in the same group 219. Each user may enable or disable via user preferences the ability of the artificial intelligence process 441 to execute that command 443 on their client device. If a user enables artificial intelligence to execute commands 43 on the user's client device, the artificial intelligence process will execute that command 443 on the user's device as determined by the artificial intelligence process 441. Therefore, each client device in a group 219 will execute the user's “scroll from image 1 to image 2” action so that all enabled devices in a group may view the actions of other users in real time.

### C. Event Driven Content Delivery and Access

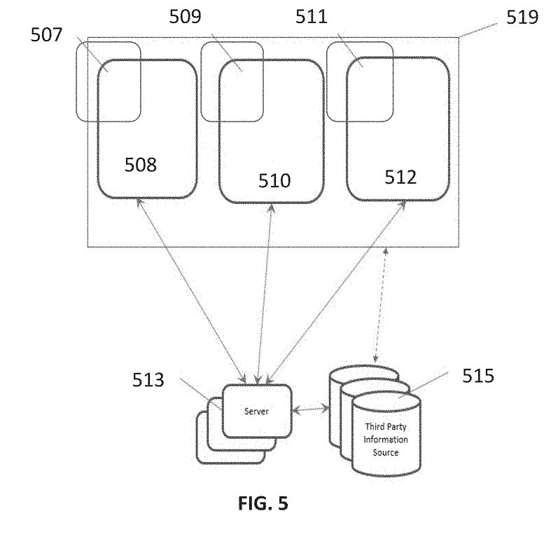

With reference now to the figures, exemplary diagrams of data processing environments are provided in which illustrative embodiments may be implemented. It should be appreciated that FIGS. 1 and 5—8B are only exemplary and are not intended to assert or imply any limitation with regard to the environments in which different embodiments may be implemented. Many modifications to the depicted environments may be made without departing from the spirit and scope of the present solution.

Account of Each Device w/Server; Communication w/Server

FIG. 2 depicts information exchange architecture between at least one client device 507, 509, 511 associated with a user and at least one server 513, which may have a message broker system enabled and may also exchange information with one or more third-party information sources 515 in at least one embodiment of the system of the present solution. Each client device 507, 509, 511 has at least one UI 508, 510, 512, and each client device 507, 509, 511 also has a communication unit 2, UI module 2B and device location module 2C as described above. A user of a client device 507, 509, 511 may enter information through the UI 508, 510, 512 to create an account. The user entered information is received by a server 513 and the server 513 creates an account for the user by assigning the user a unique identification number, which may correspond to each client device used by that user and/or may correspond to a subset of client devices associated with a given user's account.

One or more client devices 507, 509, 511 may communicate through various methods without departing from the spirit and scope of the present solution. In an embodiment, a plurality of client devices 507, 509, 511 may communicate with each other peer-to-peer, i.e., directly from one device to another through, for example, a wireless network and/or a 3G network, etc. In another embodiment, one or more client devices 507, 509, 511 may communicate with a server 513. That server 513 may act as a central control point in broadcasting content communicated from one device 507 to one or more additional devices 509, 511. In an embodiment, the server 513 may have a message broker system enabled which may enable the server 513 to communicate content items between one or more client devices 507, 509, 511 through one or more computing units in a server 513.

For the purposes of FIG. 2 and the following exemplary embodiments of the present solution, User A is associated with client device 507, User B is associated with client device 509 and User C is associated with client device 511.

### Grouping

The present solution enables users to interact with one another by communicating through the UI 508, 510, 512, of their respective client devices 507, 509, 511. One aspect of this communication includes the ability for users to form a communication group 519 with at least one other user. A communication group 19 may be a computing group in which users within that group communicate various content items (e.g., images, text messages, current location, relative location, group invitations, directions request, third-party information, point of interest request, event schedule, etc.) with one another using their respective client devices 507, 509, 511 to the exclusion of other users not included in that group 519.

In one embodiment, a communication group 519 may be formed when, for example User A, using client device 507, explicitly invites User B and User C to join a group. This group invitation may be communicated from User A's client device 507 to a server 513, which may communicate the group invitation to Users B and C by the unique identification number associated with each Users' respective account. Users B and C may individually accept or reject User A's group invitation. If Users B and C reject User A's group invitation, then no group is formed. If Users B and C accept User A's invitation, then server 513 may aggregate Users A, B and C into a group 519 by the unique identification number associated with each user's account.

In another embodiment, a communication group 519 may be formed when one or more users choose to join an existing group associated with a specific subject matter. For example, a company may create a group 519 accessible on a server 513 which the company may enable users to join. A user may access this group 519 and join that group 519 which may enable communication between users who chose to join that group.

In another embodiment, a communication group 519 may be formed among users in a specific geographic location. For example, a school may create a group 519 on a server 513 and enable users on that school's campus or in that school's building to join the group 519. A user may choose whether or not to join a group 519 and may also automatically join groups in specific geographic locations. A creator of a group 519 may control access to a group with certain security features, which may include a username and password combination. A creator of a group 519 may designate one or more users to supervise a group 519 and/or to control the users in a group 519 and may further control the content published in that group 519.

Once users are aggregated into a group 519, content items may be communicated to and received on each client device 507, 509, 511 associated with an account as defined by the unique identification number and be accessible on the first device to access the content item associated with that account. Content items may also be communicated to and received by all client devices associated with a unique identification number (e.g., iPhone, iPad and Android device all associated with same user's account) and be accessible on each device associated with that account, regardless of when access.

A user may enable or disable the device location module 2C of their client device 507, 509, 511 from transmitting location and/or time information to a server 513. If a user has enabled the device location module 2C of their client device 507, 509, 511 to transmit location and/or time information to a server 513, then a server 513 may analyze that location and/or time information and decide which events to process from the location data and how those events will be processed in accordance with the location data 73. If the device location module 2C is enabled on a client device 507, 509, 511, that device may constantly and/or intermittently transmit location and/or time information to a server 513.

A server 513 and/or computer application may analyze location and time data as transmitted from the device location module 2C of the client device 507, 509, 511 of one or more users.

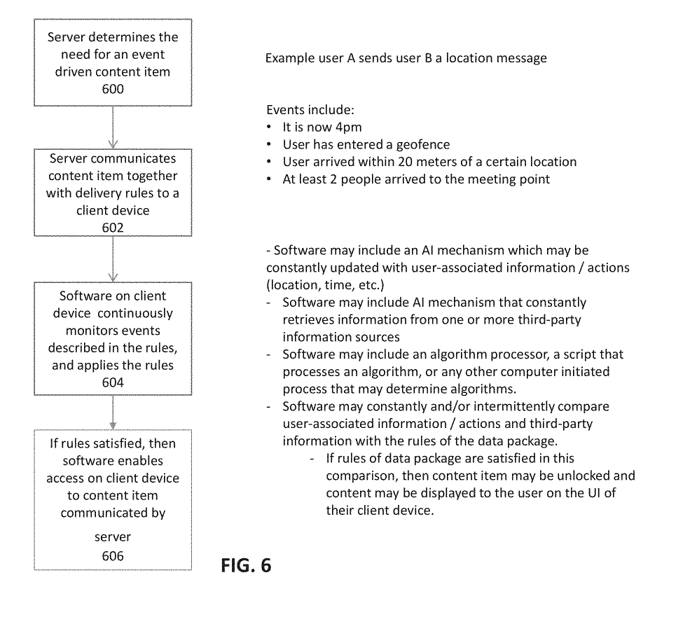

An embodiment of the systems and methods of the present solution is shown in FIG. 6. One or more users may communicate a content item (e.g., images, text messages, current location, relative location, group invitations, directions request, point of interest request, third-party information, etc.) to one another via a server 513. A content item may also be populated to a server 513 by a third-party, such as a company, and stored in a server 513 until accessible by a user.

Content items communicated among one or more user client devices 507, 509, 511 and/or between a server 513 and one or more client devices 507, 509, 511 may be human readable content items and/or may be instructions to software of a computer application installed on a client device 507, 509, 511 of a user and may be instructions to a server 513. Instructions may be in any computer readable format, such as an algorithm, script, a script which may execute an algorithm, etc.

Human readable content items may also be operably coupled with instructions/rules to software of a computer application as a “data package”. A data package may include instructions to the server 513 and/or the software of the computer application indicating when, how and why content items packaged with those instructions may be revealed to a user.

In the systems and methods of the present solution described herein, a server 513 may determine whether a content item and/or data package need be delivered 600 to the client device of one or more users. The need for a content item and/or data package to be delivered via a server 513 to a client device 507, 509, 511 of one or more users may be determined by the occurrence of any event. The occurrence of an event which may trigger a server 513 to determine the need for a content item to be delivered in accordance with that event may be determined by the instructions/rules coupled to a content item in a data package. The server 513 may constantly and/or intermittently monitor one or more pieces of data associated with a users' client device 507, 509, 511 to determine whether an event may or has occurred which may trigger the delivery of a content item and/or data package associated with an event.

For example, a company may create instructions to send a certain advertisement to users having a computer application installed on their client device 507, 509, 511 when that user is at a specific location, at a specific time, and/or when the client devices 509, 511 of two other users associated with that user are at a certain location.

In an embodiment, if the server 513 determines an event has occurred or may occur in accordance with one or more instructions/rules coupled to a content item, the server 513 may communicate that content item and/or data package with coupled instructions/rules to one or more client devices 602.

### Data Package Types

Various data package types may be communicated from the client device 507, 509, 511 of one user to another via a server 513 and from a server 513 to one or more client devices 507, 509, 511. The data package type may depend on the instructions packaged with the content items communicated.

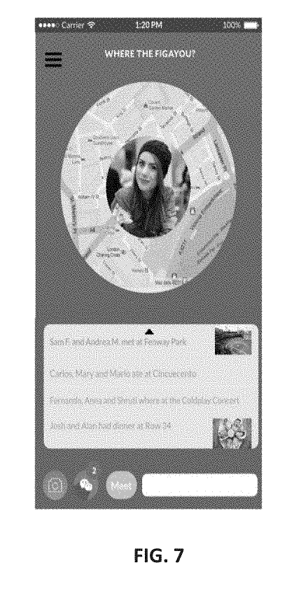

For example, a location-based data package may include a content item coupled with instructions for the computer application and/or server 513 to only allow access to that content item when the client device 507, 509, 511 of a user is at or within a specific geographic area. The users' device may have the device location module 2C enabled, which may continuously transmit the location of that device to a server 513. When a client device 507, 509, 511 is at or within the geographic area defined by the instructions coupled to the content item, the software and/or server 513 will enable the content item to be displayed on the UI 508, 510, 512 of the client device 507, 509, 511.

[Description of FIG. 7]

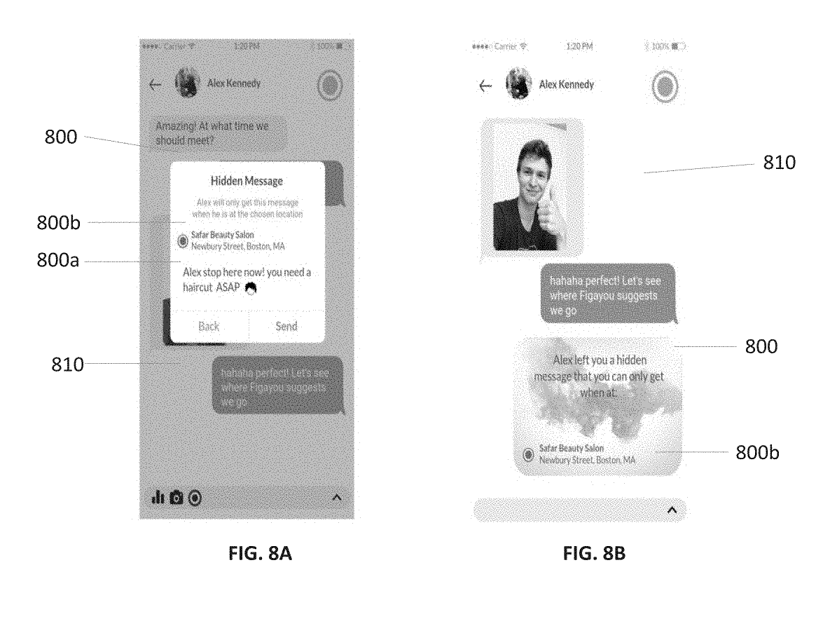

An example of a location-based data package is shown in FIG. 8A and FIG. 8B. FIG. 8A is a screenshot of a client device 507 of a user who is composing a location-based data package 800 in a group interface 810 through operating a computer application that facilitates communication of data packages, in accordance with one or more embodiments of the present solution. The location-based data package 800 which contains a content item 800a, here shown as a text message, and a rule 800b which enables access to that content item 800a by a user. The user of the client device 509 to which this message may be communicated will only be able to access the content item 800a contained in this location-based data package 800 when the client device 509 of that user is at the location specified in the rule 800b.

FIG. 8B shows a screenshot of a client device 509 of a user who has received the location-based data package 800 in the group interface 110 in a computer application, in accordance with one or more embodiments of the present solution. The user who has received the location-based data package 800 is shown here being notified of the existence of a message sent from another user along with the rule 800b which that receiving user must satisfy to view content item 800a in the location-based data package.

The rule 800b enabling a receiving user to access a content item 800a in a data package 800 may also be a time-based rule 800b. For example, a user may communicate a data package 800 to one or more other users containing a rule 800b that enables the one or more receiving users to access the content item 800a at a certain time of day (e.g., enable access at 2:00 pm). A user may also communicate a data package 800 to one or more other users containing a rule 800b that enables the one or more receiving users to access the content item 800a after a certain time has elapsed (e.g., enable access in seventeen minutes).

In an embodiment, a data package may be communicated from the device 507, 509, 511 of one user to another and/or from a server 13 to one or more client devices 507, 509, 511 upon the occurrence of an event. An event may be specified in a rule 800b in a data package 800 and may also be specified in instructions in a computer application in accordance with one or more embodiments of the present solution.

An event may be any event defined by a rule 800b that a user may set to enable access to a content item 800a communicated by that user. An event may also be any event defined by a rule 800b that a third-party and/or server 513 may set to enable access to a content item 800a. Non-limiting examples of an event may be when the S&P 500 drops by 4%, a promotional commercial activity, the presence of a device in a location (geofence), a time, an indication that one or more other devices in a group or otherwise associated with a user have reached a specified location, or any other occurrence or action which may be communicated through a computer medium.

The location-based data package 800, in some embodiments, may not show the receiving user the rule 800b associated with the location-based data package, but may show that a location-based data package has been communicated to that user. The location-based data package 800, in some embodiments, may not be shown to the receiving user in a group interface 810. In some embodiments, one user of a client device 507 may communicate a data package 800 to a server 513 which will not be shown on the receiving users' client device 509 until the server 513 determined the rule 800b has been satisfied. Once the server 513 determines the rule 800b has been satisfied, the server 513 may push the data package 800 to the receiving user.

One or more content items 800a may also be severable from one or more rules 800b in a data package 800. For example, a server 513 may determine one or more rules 800b in a data package 800 have been satisfied according to collected data. The server 513 may then send a user a content item 800a without the rules 800b attached.

In an embodiment, a user may enable and/or disable pushing of a data package 800 and/or a content item 800a from that users' device via a server 513. A user may enable and/or disable their device to pull by downloading a data package 800 and/or a content item 800a from a server 513.

In an embodiment, users may be aggregated in a group 519 of one or more users. A user within a group may control by setting user preferences whether or not their device may download data packages 800 and/or content items 800a sent by one or more other users from a server 513. A user within a group may also control by setting user preferences whether or not the server 513 may push data packages 800 and/or content items 800a sent by one or more other users to that users' device.

### Methods for Content Item Access

Software installed on the client device 507, 509, 511 of one or more users may continuously monitor events described in one or more rules 800b in a data package and apply the rules when an event satisfies the one or more rules 604, enabling a user to access a content item 800a in the data package.

Software of a computer application in an embodiment of the present solution may include an artificial intelligence mechanism, such as an algorithm and/or script, which may constantly and/or intermittently retrieve available user information and/or actions (e.g., current and past locations, time, stores visited, etc.). The software's artificial intelligence mechanism may constantly and/or intermittently retrieve information which may or may not be associated with a user from one or more third-party information sources (e.g., social media history, available internet history, etc.). Software may include an algorithm processor, a script that runs an algorithm and/or any other computer initiated process that may execute an algorithm. The software through an algorithm and/or script may constantly and/or intermittently compare data collected via the artificial intelligence mechanism with one or more rules 800b of the data package 800. If the one or more rules 800b of a data package 800 are satisfied via the algorithm and/or scripts comparison of collected information, then the content item 800a may be sent by a server 513 and/or revealed to a user on the UI of that users' client device 606.

Enabling access to one or more content items 800a in a data package 800 and/or sending via a server 508 content items 800a in a data package 800 may be accomplished through a variety of systems and methods.

In an embodiment, a computer application and/or a server may implement one or more algorithms which may be associated with one or more mathematical models and/or machine learning techniques. Algorithms and associated mathematical models may be defined by human who may program functionality of a computer application and/or a server. An algorithm implemented by a computer application and/or server may also predict user actions through one or more machine learning techniques and define content items to be delivered to a user based on actions predicted by the one or more machine learning techniques from the user and/or from one or more other users.

In an embodiment, an algorithm may apply a number of machine learning techniques to capture actions taken by one or more users on a content item and determine content delivery pursuant to historical user actions. An embodiment of a machine learning technique applied by an algorithm of the present solution may include any machine learning technique such as backpropagation, a clustering technique such as K-means, neural networks, a regression analysis such as logistic regression, or any other machine learning technique.

The one or more machine learning techniques applied by an algorithm may assign a value to an action taken by a user on a content item, such as swiping, highlighting, or scrolling. The one or more machine learning techniques may also assign a value to an action taken by a user in a geographic space, such as visiting a certain store repeatedly, visiting a location at a specific time of the day, etc. The value assigned may be defined by the action taken and may also be defined by the relevance of that action to one or more other users. Actions which have one or more values above a threshold may be chosen by a machine learning technique and may determine one or more content items and/or data packages to deliver to that user, to a group of users associated with that user, and/or to a cluster of users having similar characteristics to that user as determined by a machine learning technique. The client devices of users to which a content item and/or data package may be delivered may be defined by a threshold value assigned to actions of one or more users.

For example, the machine learning technique may discriminate among users and only deliver content items and/or data packages to users who visit specific store a certain number of times per week, such as Starbucks. A value may be assigned to a user by the machine learning technique based on any parameter which may be digitally and/or geographically related to the client device of a user or plurality of users. An algorithm may deliver a content item and/or a data package to one or more users whose value, as defined by a machine learning technique, is above or below a threshold. A content item and/or data package may be presented in any computer readable format, for example an image, a text message, a filename, a URL, a unique identifier, etc.

In an embodiment, an algorithm of the present solution may apply a machine learning technique which aggregates all or a subset of a user's history of actions taken on all or a subset of content items. For example, a machine learning technique may aggregate the store visit actions of a user within the past two years, two weeks, or any other time period which may be defined by a user, by a server, by an algorithm, or defined in any other way. Using this aggregated data, an algorithm may create an action-reaction map which may associate user actions with the subsequent actions of one or more other users.

An action-reaction map may be in many forms which may include a lookup table where an action by one user is defined in a first row and a reaction by one or more other users is defined in a second row. An action-reaction map may be a mathematical function which defines an action by one user as an input and computes the reaction of one or more other users as an output. The above examples are non-limiting and the algorithm may aggregate data in any way accessible and/or computable via a computer. One or more algorithms may run in series and/or in parallel with one or more other algorithms. Each algorithm may apply one or more machine learning techniques.

A machine learning technique applied by an algorithm may analyze an action-reaction map and may apply a machine learning technique, such as backpropagation, to discover a mathematical model that may predict reactions based on actions from the action-reaction map. Backpropagation may be an algorithmic machine learning technique which updates values of a set of parameters in a set of mathematical functions. In an embodiment, a backpropagation model may correlate reaction outputs to action inputs and/or correlate action inputs to reaction outputs. A model may be discovered through backpropagation which predicts reactions from actions. From this model, an algorithm may predict an action which may be taken by a user when a content item and/or data package is sent to them. That predicted action done by a user on a content item may be displayed to one or more other users in accordance with the prediction

One or more secondary algorithms may apply a model and/or prediction outputs as determined by an initial algorithm. The one or more secondary algorithms may apply an identical and/or different machine learning technique from the initial algorithm. The one or more secondary algorithms may use one or more outputs of other algorithms as inputs to other machine learning techniques and/or mathematical models which may exist individually and/or as a system. A system of machine learning techniques and associated algorithms may be programmed by a human and/or by one or more machine learning techniques over a period of time to process data inputs and outputs in a certain way.

A machine learning technique may learn parameters associated with one or more user actions and assign one or more values to those user actions. Parameters associated with one or more user actions and the values assigned to an action may be corrected over time through an iterative error calculation and correction process. An iterative error calculation and correction process may compute a prediction for a given reaction of one or more other users based on the action of a user. The algorithm may apply the machine learning technique to observe the actual reaction taken by one or more other users. The machine learning technique may then compute a difference between the prediction and the actual reaction, which is the error. The error may then be backpropagated through a mathematical model which updates the parameters of the mathematical model in real time to minimize error.

Over time through iterative error corrections, a machine learning algorithm applied by an algorithm of an implementation of the present solution may enhance predictions of user actions and therefore optimize distribution of content items and/or data packages to a user based on predicted actions. Predictions may be used to inform decisions of a server and/or of a computer application executing an algorithm about which data packages and/or content items to distribute to a user and when to distribute. A server and/or computer application may distribute a data package to one or more users based on a prediction value determined by a machine learning algorithm. Data packages and/or content items may also be delivered to one or more users in real time outside of an algorithmic prediction.

In another embodiment, content items and/or data packages may be delivered to a user or user group by at least one server according to artificial intelligence obtained from at least one user within a group. Artificial intelligence of users may include all or a subset of available history of a user or user group and may also include third party intelligence, which may include user age, preferences, historical use of the present system, social media history, location and current events occurring in that location. The artificial intelligence algorithm may determine the content items displayed to a user or user group through an algorithm executed by at least one server of the system that may maximize or minimize at least one utility function, such as aggregate user preferences or aggregate available history, of the users of a group. The server may distribute content items and/or data packages determined by that artificial intelligence algorithm to a user or user group which may be determined by a similarity measure and/or clustering.

In an embodiment, an artificial intelligence algorithm may apply a machine learning technique which may build similarity measures between users and available user histories, build clusters of users based on available data, predict user actions, and refine predictive algorithms based on collected user data. From inputting available user data such as social media history and interactions (e.g., likes, retweets, friends, etc.), internet browsing data and any other available data, content items may be selected and distributed to one or more users by a server.

A similarity measure may determine, for example, how similar two users are to one another based on available data and/or how well a certain user fits within a group of users based on available data. An algorithm may apply a variety of techniques to determine a similarity measure, for example, hemming distance. A plurality of users may be determined to be similar when a machine learning technique determined that the users' history of actions are similar. For example, an algorithm may look up an action taken by one user in an action-reaction map defined by a specific circumstance. The algorithm may compare that action taken in that specific circumstance with an action taken by one or more other users in a similar or identical circumstance. The comparison of actions in similar circumstances may cause an algorithm to predict an action, and this prediction may serve as a basis for selecting and distributing content to the one or more similar users.

An algorithm may apply a machine learning technique to cluster groups of a plurality of users together based on a number of human-chosen and/or algorithmically determined attributes of those users. For example, a plurality of users may be clustered into a group based on the type of content each user shares with their friends, time spent by each user viewing or interacting with a type of content, number of times each user interacts with a server and/or computer application each day, or any other available data about one or more users. Users may be clustered by any clustering technique known in the art, for example, K-means. A machine learning technique applied by an algorithm may learn behavior of the one or more users through, for example, creation and analysis of an action-reaction map for each user which may be updated in real time. Based on the machine learning technique analysis, the algorithm may be able to predict actions of a plurality of users in a category. From these predicted actions, an algorithm may distribute content items to the plurality of users in a cluster and move through that content (e.g., swipe or scroll from one content item to the next), jointly on the client devices of all or a subset of clustered users.

In an embodiment, an algorithm which may apply a machine learning technique may maximize and/or minimize a utility function. Maximization and/or minimization of one or more utility functions may influence the type and timing of content items distributed to one or more users. A utility function may be a value an algorithm and/or machine learning technique seeks to maximize and may be associated with a business objective. For example, a business may want to target advertisements to a cluster of users that maximizes profitability for that business, profitability being the utility function. The business may distribute an advertisement through a server and/or computer application to client devices of users. The algorithm applying a machine learning technique may track user reactions to the advertisement, e.g., who clicks on advertisement and who buys an advertised product after clicking. The algorithm may cluster users who bought items pursuant to the first advertisement into a group to which a second advertisement may be sent at a later date, the maximum profitability group. The algorithm will iterate this process again for the second advertisement and so on to track individual users and/or clusters of users to whom advertisements may be most effectively sent to maximize profitability of those advertisements. The algorithm may employ a machine learning technique, such as neural networks, to generate predictions of future user actions based on previous actions. Advertisements may be distributed and displayed jointly to clusters of individuals based on user actions learned through a machine learning technique that maximizes a desired utility function. An algorithm may adjust the parameters of an advertisement distribution through an iterative error minimization process refined through a machine learning technique.

Predicting may be used by a server and/or computer application to deliver content items and/or data packages to the client devices of users, determine similarity of users, group users in clusters, or to accomplish any other function desired by a human and/or computer.

In another embodiment, the content items and/or data packages may be delivered to a user or user group by at least one server according to third party information, such as an event, or according to a device's location. An event may be defined by third party information, such as promotional advertising, a problem occurring in a specific location in a factory, a remote medical event such as a disease outbreak, and may also be defined by location of a client device, such as the location of a user's device in a museum. The content items and/or data packages may be delivered to a user or user group according to such event or location when, for example, an algorithm of at least one server of the system is triggered by the occurrence of an event or by a location change, which may cause the server to retrieve content from third parties, such as the world wide web or social media platforms, and deliver that retrieved content to a user or user group.

For example, a server and/or computer application may apply an algorithm to determine a distribution strategy for content items, such as advertisements, that maximizes a utility function, for example, profitability. One or more distribution strategies may be defined by a human user and/or discovered through a machine learning technique which may create a mathematical model that may maximize a utility function. Models may be computed in series, in parallel, and/or in any combination with another model or sub-model which may perform similar and/or disparate functions. A utility function may be determined by a user, by a server, by a computer application, by other software, and/or by any computer-readable means.

An algorithm may apply a mathematical model which may predict a distribution strategy based on, for example, characteristics indicated by a business as being common among their customer base. Advertisements may be distributed to a plurality of users' client devices clustered by the defined characteristics. The algorithm may analyze the actions taken by the plurality of users and score that distribution strategy according to observed outcomes (e.g., level of customer engagement and purchases completed) and score a strategy according to the observed outcomes. Through subsequent iterations of this prediction, distribution, observance, and scoring process, an algorithm may determine a distribution strategy that maximizes the utility function of profitability.

A data package may contain one or more rules which may be required to be satisfied to enable a user to view a content item of that data package. A machine learning technique of an algorithm may read the one or more rules of the data package and determine the parameters of the rules. The machine learning technique may constantly and/or intermittently search through available information, such as GPS location, third-party information, etc. to determine whether a user has satisfied the rules. The one or more rules may be presented as a rules engine, which may be any form of organizing data in a computer which an algorithm may compare searched information to, such as a table. A rules engine table may have two columns, with a rule condition in the first column and a second column which the algorithm may populate once information satisfying that rule has been retrieved by the machine learning technique. Once the algorithm confirms a match, a user may view the content item of the data package. This may occur by any means, for example, a server may send the content item to the client device of a user once a rule has been satisfied, or a software feature of a computer application may be enabled based on the satisfaction of a rule. An example may be that once a rule is satisfied, software may be instructed to display the content item on the UI of a client device.

In an embodiment, a server 513 may constantly and/or intermittently monitor the location of a client device 507, 509, 511 and communicate a content item to that client device 507, 509, 511 once that client device is in a specific location. For example, a supermarket may want to know if their customers like where they placed diapers in the store. The supermarket may communicate a poll with various answer options to a server 513 which may be relayed to the client device of a user when that user is at the location of the diapers in the store. The location of diapers in the store will be the rule 800b which must be satisfied in order for the user to gain access to the associated poll content item 800a. When a user with a computer application installed on their client device 507, 509, 511 that communicates with the server 13 enters a location associated with those diapers, the server 13 may communicate that poll to the client device of the user.

In an embodiment, a server 13 may make a content item 800a in a data package 800 available to a user on their client device, but the computer application may control access to the content item 800a. The computer application itself on a users' client device may have received all or a subset of data packages for a given user from the server 13. The computer application may compare collected information from the user with the one or more rules 800b in the data package and determine whether or not the rules 800b have been satisfied, and therefore whether the content item 800a may be accessed by the user.

In an embodiment, a server 13 may also call a computer application installed on a client device and communicate to the user application that the server 513 has a data package 800 for that client device once that device satisfies one or more rules 800b. The client device may communicate information to the server 13 constantly and/or intermittently which may or may not satisfy the rules 800b. If the information communicated by the client device to the server 13 satisfies the rules 800b of the data package 800, the content item 800a associated with that package may be accessed by the user.

In an embodiment, access to a content item 800a in a data package 800 may change based on the status of information communicated from a client device 507, 509, 511 to a server 513. A server 513 may communicate the change in access status to the client device 507, 509, 511. For example, when a client device is at a first location, the location rule 800b in the data package 800 may be satisfied, so the server 513 may enable the client device to access the content item 800a in that data package 800. If a client device moves to a second location which does not satisfy the location rule 800b in the data package 800, the server 513 may notify the client device that access to the content item 800a has been disabled. The server 513 may notify the client device of a change in enabled and/or disabled access upon the occurrence of any event which may implicate one or more rules 800b in a data package 800.

In an embodiment, a server 513 may push a content item 800a and/or data package 800 directly to the client device of a user based on the satisfaction of one or more rules 800b of the data package 800. In another embodiment, a client device may pull by downloading a content item 800a and/or data package 800 from a server 513 based on the satisfaction of one or more rules 800b of the data package 800.

In an embodiment, the server 513 may push and/or the client device may pull by downloading a location and/or set of rules 800b which must be satisfied to enable access to a content item 800a. The rules 800b and/or location required to be satisfied to access a content item 800a may be viewable in the UI of the client device separately from any information associated with what the content item is. The server 513 may also communicate to a device that access to a content item 800a may be enabled in a specified period of time, which may be separate from or coupled with any information regarding what that content item 800a is.

### D. Co-Location Transaction Validation

With reference now to the figures, exemplary diagrams of data processing environments are provided in which illustrative embodiments may be implemented. It should be appreciated that FIGS. 1 and 9-12B are only exemplary and are not intended to assert or imply any limitation with regard to the environments in which different embodiments may be implemented. Many modifications to the depicted environments may be made.

Account of Each Device w/Server; Communication w/Server

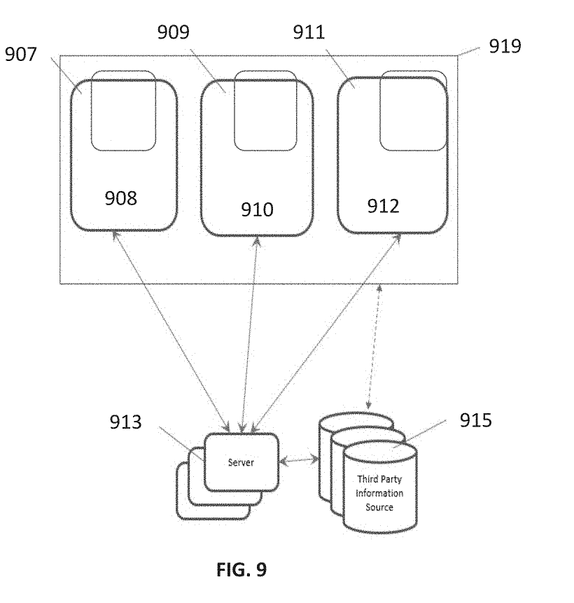

FIG. 9 depicts information exchange architecture between at least one client device 907, 909, 911 associated with a user and at least one server 913, which may have a message broker system enabled and may also exchange information with at least one third-party information source 15 in at least one embodiment of the system of the present solution. Each client device 907, 909, 911 has at least one UI 908, 910, 912, and each client device 907, 909, 911 also has a communication unit 2, UI module 2B and device location module 2C as described above. A user of a client device 907, 909, 911 may enter information through the UI 908, 910, 912 to create an account. The user entered information is received by a server 913 and the server 913 creates an account for the user by assigning the user a unique identification number, which may correspond to each client device used by that user or may correspond to a subset of client devices associated with a given user's account. For the purposes of FIG. 9 and the following exemplary embodiments of the present solution, User A is associated with client device 907, User B is associated with client device 909 and User C is associated with client device 911.

### Grouping

The present solution enables users to interact with one another by communicating through the UI 908, 910, 912, of their respective client devices 907, 909, 911. One aspect of this communication includes the ability for users to form a communication group 919 with at least one other user. A communication group 919 may be a computing group in which users within that group communicate various content items (e.g., images, text messages, current location, relative location, group invitations, directions request, third-party information, etc.) with one another using their respective client devices 907, 909, 911 to the exclusion of other users not included in that group.

In one embodiment, a communication group 19 may be formed when, for example User A, using client device 907, explicitly invites User B and User C to join a group. This group invitation may be communicated from User A's client device 907 to a server 913, which may communicate the group invitation to Users B and C by the unique identification number associated with each Users' respective account. Users B and C may individually accept or reject User A's group invitation. If Users B and C reject User A's group invitation, then no group is formed. If Users B and C accept User A's invitation, then server 913 may aggregate Users A, B and C into a group 919 by the unique identification number associated with each user's account.

Once users are aggregated into a group 919, content items may be communicated to and received on each client device 907, 909, 911 associated with an account as defined by the unique identification number and be accessible on the first device to access the content item associated with that account. Content items may also be communicated to and received by all client devices associated with a unique identification number (e.g., iPhone, iPad and Android device all associated with same user's account) and be accessible on each device associated with that account, regardless of when access.

In an embodiment of the solution shown, for example, in FIG. 9, a user may initiate a co-location transaction validation with at least one other user. In initiating a co-location transaction validation, a first user, may enter an initiation request into, for example, a computer application, accessible through the UI 908 of the first user's client device 907. This initiation request may be communicated from the communication unit 2 of the first user's client device 907 to a server 913. When the initiation request is communicated by a first user, location and time information may be captured by the client device 907, by the server 913, or through any other means, and transmitted to the server 913. This location information may be aggregated with data associated with the initiation request and subsequent communications between parties to the transaction, so that location of the parties, content of the transaction, and certification of accuracy by the parties may be stored together to validate these elements and more of the transaction, which may be retrieved upon request.

When a user communicates an initiation request to a server 913, the server 913 may also generate an event number for the initiation request. All data associated with an initiation request and subsequent transaction may be aggregated by a server 913 under the event number. The data associated with an initiation request may be saved under a single event number in the server 13 and all communications between parties pursuant to that event number may be saved under that event number. It is also envisioned herein that where validation initiation requests are made multi-directionally (e.g., a plurality of users make initiation requests pursuant to the same transaction), multiple identifiers and event numbers may be generated for a single transaction, and users may agree to link event numbers with one another so that data associated with each initiation request may be saved together, even though that data may be associated with multiple event numbers.

Data aggregated under an event number may include data regarding which user accepts which identifier, location information associated with the devices and/or users participating in the transaction, data of content items shared between users which may memorialize the transaction or event that occurred at the location, and timestamp data indicating when a user entered the identifier generated by another user's initiation request, timestamp data for when content items are shared between users, agreements among parties certifying that content items shared and/or data associated with a transaction are true, and may also include retrieval requests by a party to access the transaction history.

Pursuant to the first user's initiation request, the server 913 may then generate a code, token, pattern, or other identifier that specifically corresponds to the first user's initiation request which is distributed by the server 913 to the client device 907 of the first user and may also be distributed by the server 913 to any device of one or more other user who may be designated by or geographically associated with the first user. A second user may enter and/or accept the code, token, pattern, or other identifier distributed by the server 13 to the first user pursuant to the first user's initiation request. The code, token, pattern, or other identifier may be entered and/or accepted through the second user's client device 909 through, for example, a computer application accessible through the UI 910 of the client device. The identifier may be entered through a variety of means (e.g., scanning of bar code, taking and entering a photo of the token from the first user's device, typing the code text into the computer application, activation of an “accept co-location validation” of first user button in the computer application, etc.), or any other method known to those of ordinary skill in the art. Entrance and/or acceptance of the identifier by the second user is communicated to the server 913, which validates that the identifier generated upon the first user's initiation request is the same identifier entered by the second user into the second user's client device 9. When the initiation request is entered and/or accepted by the second user, location and time information may be captured by the client device 909, by the server 913, or through any other means, and transmitted to the server 913. This location information may be aggregated with data associated with the initiation request and subsequent communications between parties to the transaction, so that location of the parties, content of the transaction, and certification of accuracy by the parties may be stored together to validate these elements and more of the transaction, which may be retrieved upon request.

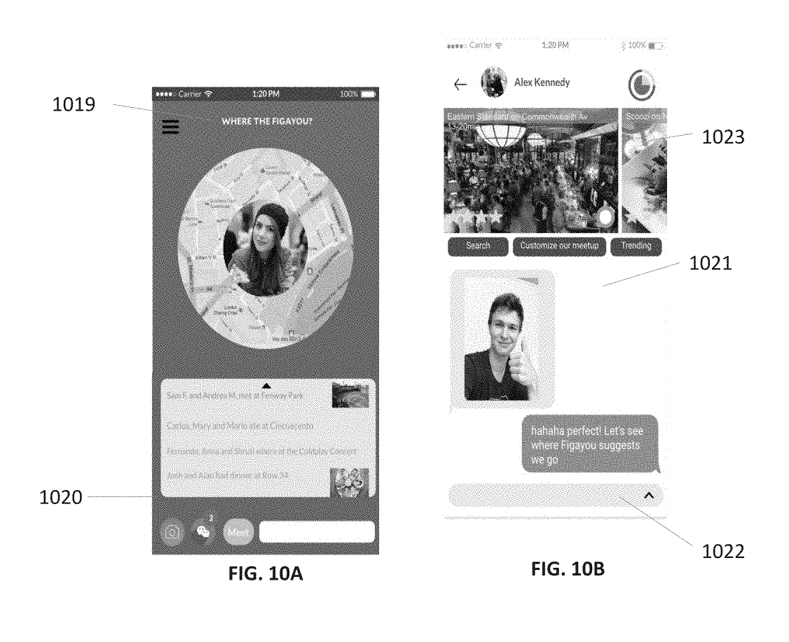

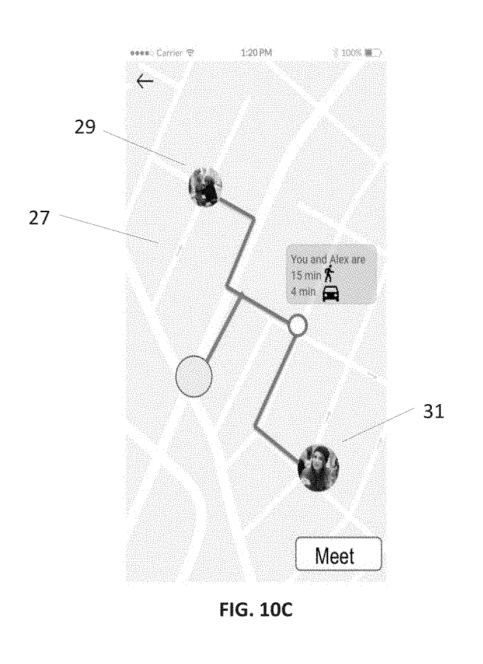

Once the server 913 validates the identifier between the first user and the second user, the server 913 notifies each device associated with the transaction that the co-location transaction validation has been initiated. The server 913 may create a content item thread (e.g., FIG. 10B 1021) between the users who have validly initiated the co-location transaction validation, and may generate a unique event number for the validation. The validation of users who are parties to the transaction validation may be stored in a server 913 or other third-party storage source and may be aggregated with any other data associated with the transaction.

### Content—Hash/Timestamp Validation of Messages

Once the server 913 validates an identifier entered or agreed to by a plurality of users, the server 913 creates a content item thread, as is shown, for example in FIG. 10B 1021, between the users who have validly initiated the co-location transaction validation. In the content item thread 1021 created by the server 913, users who are parties to the validated co-location transaction may publish and import content items. Content items which may be published or imported include text messages, images, linked content from a third-party information source such as a webpage, a description of an item which may be imported from a website such as Craigslist or eBay, maps, or any other information communicable between users of computer devices. A user may input a content item or import data for example using a share content feature 1022 such as that shown in FIG. 10B. When a user inputs a content item to the content item thread, other users who are parties to the same content item thread will be prompted by a server, through a message or other electronic means such as a button activation, to acknowledge receipt of the content item being shared and agree to include the content item in the content item thread. Once the content item is acknowledged and agreed to by the other users, the user who shared the content item may be notified of the other users' acknowledgment and acceptance of that content item. The content items shared, acknowledged and agreed to among users will populate the group screen 1021 so that all users who are parties to that group can view the content items shared, acknowledged and agreed to by the parties.

In at least one embodiment of the present solution, when a user shares content items with a group 1021, a server may attach a seal of verified co-location to the content item to prove the item was shared at a time when users were within a given distance of one another. This seal of verified co-location may include a timestamp and hash containing location information captured by the device at the time the content item is shared. The content items shared between users may be subject to approval by at least one other party in a group. For example, if a first user shared a photo of an item being sold to a second user, the second user may be prompted by a button or other form of acknowledgment to agree that the photo be included in the content item thread between the parties.

In a further example, User A and User B get into a car accident. User A and User B may each take photos of the damage and may agree on the series of events that lead to the accident. User A and User B may initiate and consummate a co-location transaction validation which enables a content item thread between User A and User B. User A may add the photos they took and descriptions they wrote to the content item thread and User B may likewise do the same. When any content item is added to the content item thread by User A, User B may be prompted to acknowledge receipt of the content item and agree to include the content item in the content item thread between the users. Once a content item is acknowledged and agreed to by another party to the content item thread, that item is populated to the thread with a seal of verified co-location. The seal of verified co-location attached to each message may provide documentation of a timestamp and for the location of the parties individually and relative to one another at the time the content items were shared. A copy of each message may be stored on the client device of each party to the content item thread and may also be stored on at least one server of the system of the present solution.

For example, User A, who may be the buyer or seller in a transaction, may enter an initiation request into, for example, a computer application, through the UI 908 of User A's client device 907. This initiation request may be communicated from the communication unit 2 of the client device 907 to a server 913. The server 913 may then generate a code, token, pattern, or other identifier that specifically corresponds to User A's initiation request.

User B, who may be the buyer or seller in a transaction, may enter the code, token, pattern, or other identifier that specifically corresponds to User A's initiation request into User B's client device 909 through, for example, a computer application accessible through UI 910. The identifier may be entered through a variety of means (e.g., scanning of bar code, taking ang entering a photo of the token from User A's device, typing the code text into the computer application, etc.), or any other method known to those of ordinary skill in the art. User B's entrance of the identifier is communicated to the server 913 which validates that the identifier generated upon User A's initiation request is the same identifier entered into User B's client device.

Once the server 913 validates the identifier between User A and User B, the server 913 notifies each of the users that the co-location transaction validation has been initiated, creates a content item thread (FIG. 10B 1021) between the users who have validly initiated the co-location transaction validation, and generates a unique event number for the validation. The validations of users who are parties to the transaction validation are stored in a server 913 or other third-party storage source and may be aggregated with any other data associated with the transaction.

The co-location transaction validation systems and methods described herein may be used to validate the occurrence of an action or communication event. For example, a first user and a second user communicate with one another via a phone conversation. The first user may initiate and consummate a co-location transaction validation with the second user to memorialize the users' respective locations at the time of the conversation, the time of the conversation, and the content of the conversation through a written memo that would be acknowledged and agreed to by the other party.

It is envisioned herein that any number of parties may validate the transaction, both unidirectionally and/or multi-directionally, and by acting as one or more individuals and/or acting as one or more groups.

For example, a first user may initiate a co-location transaction validation request. A server responsive to that request may generate an identifier for that request, which may be distributed to the first user and/or to any other user designated by the first user or geographically associated with the first user pursuant to the first user's initiation request. All subsequent communications between parties pursuant to that initiation request will be saved under a single event number associated with the identifier, which the server may generate.

Each other user may consummate the co-location validation request by entering the identifier from the first user's initiation request and/or accepting the co-location validation request through a computer program accessible through the UI of that user's device. Once a server matches the identifier generated by the server in response to the first user's request with the identifier entered or accepted by at least one other user, a content item thread is generated and the users who have validated the initiation request by entering or accepting the co-location validation request will be able to share content items with one another and agree on the validity of the content.

In another embodiment, a co-location validation request can be initiated by multiple users pursuant to the same transaction, which may enable each user to have an individualized record of the transaction.

For example, a first user may initiate a co-location transaction validation request. A server responsive to that request may generate an identifier for that request, which may be distributed to the first user and to any other user designated by the first user or geographically associated with the first user pursuant to the first user's initiation request.

Pursuant to the same transaction, a second user and a third user may also initiate co-location transaction validation requests. A server responsive to those second and third requests may generate an identifier and event number for each request, which will be different than the identifier and event number generated in response to the first user's initiation request and the second identifier and event number will be different from the third identifier and event number. The second and third identifiers may be distributed to the second user and third user, respectively, and to any other user designated by the second and third users (e.g., the first user, the second user, the third user, etc.) or geographically associated with the second and/or third user pursuant to the second and/or third user's initiation request. The first user may enter or accept the identifier generated by the server in response to the second user's initiation request, and then a content item thread may be generated between the first and second users. The second user may enter or accept the identifier generated by the third user's initiation request, and then a content item thread may be generated between the second and third users. Further, the third user may enter or accept the identifier generated by the first user's initiation request, and then a content item may be generated between the third and first users. Any number of users may be involved in initiating a co-location transaction request for a given transaction, which may be accepted and/or entered and thereby consummated by any number of other users associated with that same transaction without departing from the spirit and scope of the present solution.

The ability of multiple parties to initiate a co-location transaction validation and consummate the transaction with any other user or group of users may have many uses. For example, if a seller first user is selling a car to a buyer second user, the seller and buyer may want a record of that sales transaction between them. The seller and buyer would therefore initiate and consummate a co-location transaction validation in which the seller and buyer may populate the content item thread with data such as, location information, the seller's representations and warranties of the car, images of the car, and an image of the certificate of title being transferred. This would create a documentation record of the sales contract, which may be retrieved at a later date by the seller and buyer.

For due diligence purposes, the buyer may bring a certified mechanic with him to the sale to conduct an on-the-spot inspection of the vehicle to investigate the seller's representations and warranties. The buyer may want to enter into a services agreement with this mechanic to investigate the car. The buyer and the mechanic would therefore initiate and consummate a separate co-location transaction validation where the buyer and mechanic could populate the content item thread with the representations and warranties and the mechanic could make notes about whether he agrees with the representations and warranties as written, or the mechanic may make notes about how the car deviates from the representations and warranties and also make notes about any details which should be investigated further if a more comprehensive evaluation of the car is needed beyond what the mechanic can provide. This would create a documentation record of the services contract, which may be retrieved later by the buyer and the mechanic.

The time and location information captured by the devices and/or server about the seller, buyer, and mechanic would have legal significance in proving the parties were together at the time of the respective transactions. Further, the ability for the parties to agree on content items related to a transaction validation and storage of this agreed content enables the parties to create a continuous list of contractual elements which may be modified and updated by the parties should a situation arise where the parties wanted to modify or update their agreement.

It is further envisioned herein that by agreement, multiple parties may aggregate their respective co-location transaction validation data which may facilitate the formation of a comprehensive record of the locations of and agreements, rights and obligations created by and among parties in a specific transaction or series of transactions.

### Non-User Machine Location Validation—EX: Attendance

In some embodiments, a co-location transaction validation can be initiated and consummated between a human user and a machine, which may be used, for example, to validate human behavior. A machine may be any device which includes a television, a computer system, a billboard, a radio frequency transmitter, an iPad, etc.

The machine may display a code, token, pattern or other identifier which may be a fixed code for that machine or may be generated, for example, on command by a user of the machine, five minutes before a class begins, or every day at 8:00 am, etc. The identifier may be the same or different upon each generation. Unique identifiers may also be generated by the machine that correspond to individual human users.

A human user may enter the identifier presented by the machine into the user's device through, for example, a computer application accessible through a UI. The user's entrance of the machine's identifier may be sent to a server, which may validate, for example, the user's account via its unique identification number, the identifier from the machine entered by the user, the location of the user's device at the time the identifier was entered, the time of entry of the code, or any additional requirements. Additional requirements to and/or modifications to the exemplary data listed above may be made by a person or agent with permission to add requirements to and/or modify data requirements to the server program, such as a parole officer or teacher of a driver's education course. This process validates that a human user is present at the location of a machine at a given time. This presence at a location at a given time, i.e., “attendance,” may be augmented with additional requirements.

For example, the human user may not only be required to be at a certain location at a certain time, but may also be required to stay at that location for a certain duration of time.

If the server determines, based on the server's programming, that additional actions are required, the server will take additional steps. For example, if a human user may be required to be present at a rehab facility at 8:00 am on a Monday, that human user may also be required to stay at that same rehab facility until 4:00 pm on Monday. The rehab facility will have a machine that generates identifiers which the human user will enter to prove compliance with these location and time requirements. If a server determines the human user complied with a first course of action (e.g., being present at the rehab facility at 8:00 am on a Monday), the server may be programmed to provide a second unique identifier to the machine at, for example, 4:00 pm. The human user would enter this second unique identifier presented by the machine into the user's device through, for example, a computer application accessible through a UI. A user's entrance of this second unique identifier together with associated data of time, location, account information, etc. validates that a user was present at a specific location for a specific period of time. Further, the device location module of the user's client device may be enabled to report location of the device throughout a given time period. If enabled, the user's location not only at the start and end points of the given time period, but throughout the given time period may be recorded by the server.

This user data may be selectively transmitted by the server to the client device of a given individual or agency and/or selectively stored in a database accessible by a specific person or group of persons. For example, this system and method may be used to validate than an individual attended 40 hours of drunk driving school based on the location, time and co-location validations.

In an embodiment of the present solution, the content item thread may be certified by the users as the entirety of information they may wish to include in the transaction record.

When the server 913 validates an identifier entered or agreed to by a plurality of users, the server 913 creates a content item thread, as is shown (e.g., FIG. 10B 1021), between the users who have validly initiated and consummated the co-location transaction validation. In the content item thread 1021 created by the server 913, users who are parties to the validated co-location transaction may publish and import content items.

When a user inputs a content item to the content item thread, other users who are parties to the same content item thread will be prompted by the server, through a message or other electronic means such as a button activation, to acknowledge receipt of the content item being shared and agree to include the content item in the content item thread. Once the content item is acknowledged and agreed to by the other users, the user who shared the content item may be notified of the other users' acknowledgment and acceptance of that content item. The content items shared, acknowledged and agreed to among users will populate the group screen 21 so that all users who are parties to that group can view the content items shared, acknowledged and agreed to by the parties.

In an embodiment of the systems and methods of the present solution, users who are parties to a given content item thread will be enabled to agree that the contents of the content item thread constitute the entirety of the content between the parties pursuant to a specific co-location transaction validation through an “integration request”. In contract terms, this action is akin to incorporating an integration clause into the content item thread, which declares the content contained in the content item thread is the entirety of the relevant content between the parties.

One user may communicate an integration request to all or a subset of other users who are parties to the content item thread through the server which will be received on those other users' devices. The other users may agree to the integration request. If the other users agree to the integration request, all of the data contained in the content item thread existing at that time will be packaged together and stored in a server and/or by a third-party custodian under the event number. A user who is a party to the same content thread may wish to subsequently amend, modify, delete, or otherwise alter the content that was previously agreed to. If so, that user may alter the content they wish to be altered in the content item thread of their own device, communicate a new integration request to all or a subset of other users who are parties to the content item thread with the altered content, and if those other users agree, the entirety of data in that altered content item thread will be packaged and stored in a server and/or by a third-party custodian under the same event number. The newly agreed to and stored content item thread may not override the previously agreed to content item thread. The agreement by the parties to an integration request saves the entirety of data pursuant to that request as a packaged block, similar to blockchain. Therefore, if users who are parties to a given content item thread change the content of that thread through agreement, documentation of the original agreement together with all associated data will be maintained. Thus, users will be able to maintain a documented record of the original integrated content thread and be able to compare subsequent changes to that original content thread through a record of each individual integration agreement. The integrity of the content may be guaranteed through electronic digital signatures or other means, such as a notary.

Further, the contents of a content item thread between parties to a transaction may be integrated within a specific time period. For example, if users communicate through a content item thread for five weeks, users may make and agree to an integration request for only the content of the content item thread between weeks two and three, or between weeks four and five, or only for a single day, or for any other time period during which a content item thread has been used for communication between parties. The parties could further specify which content items contained in the content item thread during a specified time period would be included with the integration request. Content item threads may be deleted from the device of an individual user, which may eliminate that thread from their device.

Data subject to storage, which may be all or a subset of data of the parties relevant to a specific co-location transaction validation, may be packaged together or may be saved as individual data elements. The data may be stored under the event number generated at the initiation request and may also be aggregated with data stored under other event numbers as agreed to by the parties to a specific transaction. The data may be packaged by a given user's client device and sent to a server and/or a third-party custodian. The data may then be sent from the server and/or third-party custodian to each user associated with a given co-location transaction validation. The users to whom the data may be sent may be controlled through a user's preferences or by agreement among the parties to a specific co-location transaction validation. The contents of any data associated with a specific co-location transaction validation, including the content item thread, may be saved for an infinite or finite time period.

A user may request retrieval of stored data and may be provided with all data relevant to the user request and may be presented in a specific form which may be defined by a user preference or request.

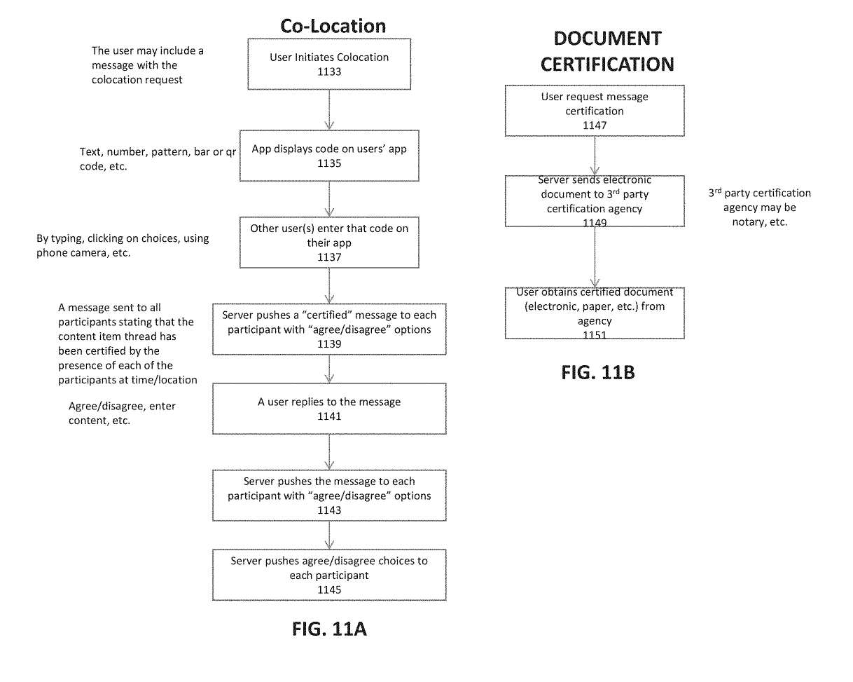

FIG. 11A is an embodiment of the present solution detailing one or more systems and methods in which the present solution may be practiced. A user may initiate a co-location transaction validation 1133 which may include a message, for example a text message. This co-location request may be communicated to the client devices of at least one other user via a server 913. When a user initiates a co-location transaction validation, a code, toke, pattern, bar code, QR code, or any other type of unique identifier may be displayed on the UI of the user's client device 1135 in, for example, a computer application associated with the systems and methods described herein.

Other user's may view that code as displayed on the requesting user's UI through a computer application and enter that unique identifier 1137 on their own client device through, for example, a computer application accessible through the UI of their own client device. Other users may enter and/or accept the unique identifier 1137 of the user requesting the co-location by, for example, typing in the unique identifier, clicking on an activator which may have been sent to their client device via a server 913, taking a photo of the code using a camera associated with the client device, a scanning mechanism, or any other method of inputting a unique identifier known by those of ordinary skill in the art.

When one or more other users have entered and/or accepted 1137 the unique identifier, a server 13 may push a “certified” message to each user participating in the co-location 39. A certified message may be a message sent to all user participants who have validly entered and/or accepted the unique identifier, which may state that the content item thread created pursuant to the users' participation in the co-location has been certified by the presence of user participants at the particular time and location of the co-location. Time and location data may be captured by the device of each user participating in the co-location at the time the unique identifier is entered and/or accepted by that user. This time and location data may be aggregated with the data of the content item thread and with any other data associated with the parties. Capture and storage of time and location data of each device entering and/or accepting the unique identifier may confirm that the user participants were located in the same place at the same time the transaction occurred. The certified message may show this time and location data to the participants and may further contain an “agree/disagree” option. The agree/disagree option enables one or more users participating in a transaction to certify that they in fact are parties to the transaction and may further enable the users to agree/disagree to data associated with the transaction.

All or a subset of users participating in a co-location may reply to the certified message 1141. If a user agrees to the certified message, a content item thread may be created via the server 913 and be viewable by the parties. A user who has agreed to the certified message may enter content items into the content item thread.

Each content item entered, for example, a list of representations and warranties of a good being sold, may be agreed with or disagreed with by the parties 1143. The ability of users to agree and/or disagree to content may be altered through user preferences, may be fixed for a specific transaction or fixed for a specific type of transaction. As content items are added to the content item thread between user participants in the transaction, users may agree or disagree to their inclusion in the content item thread. Through this feature, only data that is agreed to by the user participants may be included within the content item thread between the user participants. Accordingly, the content items populated to the content item thread may be mutually agreed upon before any inclusion, so that each user participant has control over what may be included in the documented record of exchange between the parties.

Once a user agrees and/or disagrees to the inclusion of a content item in the content item thread, that user decision may be pushed via the server +13 to all or a subset of other user participants to the transaction 1145. For example, if User 1 publishes a content item to the content item thread and User 2 disagrees with inclusion of that content item, User 2's disagreement may be pushed by the server just to User 1 or also to User 3 and User 4, so that all participants know each action was attempted and subsequently accepted and/or rejected.

### FIG. 11B

FIG. 11B is an embodiment of the present solution detailing one or more systems and methods in which the present solution may be practiced which may include a document certification. In one or more embodiments of the present solution, a user may request that a content item message, a content item thread, or a specific subset of a content item thread be certified by a third-party agency, such as a notary. A user who may be a participant in a co-location transaction validation may request a certification of a specific content item message, an entire content item thread, or a specific subset of a content item thread 1147. A user participant may make such certification request, by, for example, communicating the request from their client device to the server by sending a message, activating a button that requests certification, highlighting certain content, etc. Once a certification request is made, that request may be communicated from the client device of the requesting user to a server 913. The server may then communicate an electronic document (e.g., a PDF file, a Microsoft Word file, or any other electronic means of communicating visible information) to a third-party certification agency 49 (e.g., a notary or any other entity which is qualified to certify documents). Along with the data sought by the user to be certified, the system and methods of the present solution may provide a specific level of information about the users who may be participants to the data sought to be certified. For example, if highly sensitive information such as medical records are sought to be certified, the third-party agency may require significant personal information of the users to complete the certification. If a contract is sought to be certified, the third-party agency may merely need user data which may include the names of the users and an agreement in writing that the contents of the data sought to be certified was in fact agreed to by the parties.

The certification agency may certify the document requested by the user and send a certified copy of the document back to the user 1151. The certified copy of the document may be sent via mail, email, through a computer application to which both the certification agency and user have access, or any other electronic or non-electronic means of communicating information. Through this process, a user may obtain certified documentation of a content item message, a content item thread, or a specific subset of a content item thread, which may or may not have legal significance.

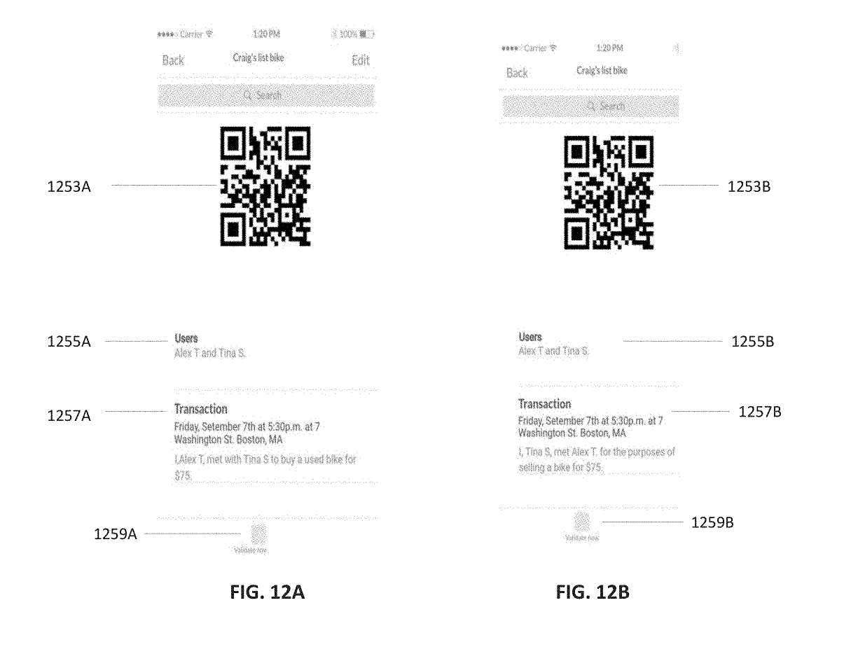

FIG. 12A and FIG. 12B are pictorial representations of a screenshots of two client devices completing a co-location transaction validation in accordance with one or more embodiments of the present solution. FIG. 12A shows a screenshot of the buyer in the transaction. FIG. 12B shows a screenshot of the seller in the transaction.

FIGS. 12A and 12B show a unique identifier 1253A and 1253B which may have been generated by the server upon a request by either user to initiate a co-location transaction validation. The users who are parties to that specific transaction may be depicted as shown in 1255A and 1255B. The user who did not request to initiate the co-location transaction validation may have used their device's camera or scanner to scan the QR code shown as the unique identifier. Once scanned or otherwise entered by the non-initiating party, the content item thread 1257A and 1257B may appear on the UI of both users and each user may publish content items in that content item thread 1257A/1257B. Further, location and time data of the transaction may be shown in the content item thread 1257A/1257B. This location and time data may have been captured by the user's devices and/or manually entered by the users. This content item thread 1257A/1257B is not limited to text and may further include images, imported content from third-party information sources, internet links to internet content, a voice message or any other content agreed upon by the parties communicable through a computerized medium.

The data contained in this content item thread and all data associated with the content shown on these screens may be validated by the parties through an activation of the button shown in 1259A/1259B. Once a party validates the contents of the co-location transaction validation by activating the 1259A/1259B button, the other party will be notified and be able to agree and/or disagree to the entirety of the content or a subset of the content. If both parties to this co-location transaction agree to validate the contents, that package of data will be stored together in a server 913 or third-party custodian of records.

The co-location transaction validation shown may be available to the parties for a finite or infinite period of time. If the parties seek to later modify or amend their agreement, they may agree on content to include in the content item thread 1257A/1257B and agree to validate that modification or amendment. This second validation may save all data related to the transaction as modified, as a package separately from the originally saved data package. In this way, the parties may have a record of the complete original agreement, as well as any modifications agreed upon at a later date. The users who are parties to a transaction may also agree to delete a saved file and/or overwrite a previously saved file through a mechanism provided by, for example, a computer application.

### E. Calendar Navigation and Rationalization

A feature of an embodiment of the systems and methods described herein may enable a user and/or a group of users to schedule events in one or more computerized event calendars and map those events on one or more computer applications. One or more features of the system and methods of the present solution may also enable one or more users to receive alerts relating to the feasibility of completing a schedule of events and to intervening events which may affect the ability of one or more users to complete a schedule of events. An embodiment of the systems and methods of the present solution may also prompt a user to re-order a schedule of events based on time constraints and may automatically generate suggested changes that may enable feasible completion one or more schedules of events. A schedule of events may be any information relating to time and/or date of an occasion, which may include a meeting at a geographic location, a virtual meeting for example a videoconference, a phone call, or any other occasion which an individual may attend and/or participate in. In an embodiment of the present solution, the schedule of events may be contained in a computer application which may be associated with one or more other computer applications through a server, network, or other means.

With reference now to the figures, exemplary diagrams of data processing environments are provided in which illustrative embodiments may be implemented. It should be appreciated that FIGS. 1 and 13-16B are only exemplary and are not intended to assert or imply any limitation with regard to the environments in which different embodiments may be implemented. Many modifications to the depicted environments may be made without departing from the spirit and scope of the present solution.

Account of Each Device w/Server; Communication w/Server

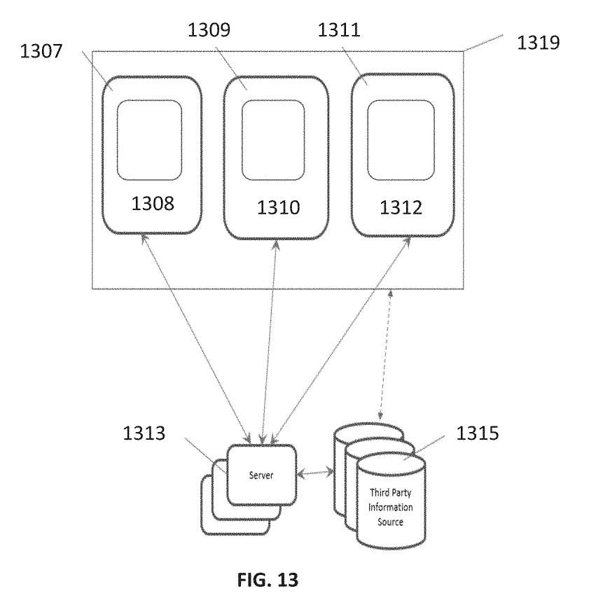

FIG. 13 depicts information exchange architecture between at least one client device 1307, 1309, 1311 associated with a user and at least one server 13, which may have a message broker system enabled and may also exchange information with one or more third-party information sources 1315 in at least one embodiment of the system of the present solution. Each client device 1307, 1309, 1311 has at least one UI 1308, 1310, 1312, and each client device 1307, 1309, 1311 also has a communication unit 2, UI module 2B and device location module 2C as described above. A user of a client device 1307, 1309, 1311 may enter information through the UI 1308, 1310, 1312 to create an account. The user entered information is received by a server 1313 and the server 1313 creates an account for the user by assigning the user a unique identification number, which may correspond to each client device used by that user and/or may correspond to a subset of client devices associated with a given user's account. For the purposes of FIG. 13 and the following exemplary embodiments of the present solution, User A is associated with client device 1307, User B is associated with client device 1309 and User C is associated with client device 1311.

### Grouping

The present solution enables users to interact with one another by communicating through the UI 1308, 1310, 1312, of their respective client devices 1307, 1309, 1311. One aspect of this communication includes the ability for users to form a communication group 1319 with at least one other user. A communication group 19 may be a computing group in which users within that group communicate various content items (e.g., images, text messages, current location, relative location, group invitations, directions request, third-party information, point of interest request, event schedule, etc.) with one another using their respective client devices 1307, 1309, 1311 to the exclusion of other users not included in that group 1319.

In one embodiment, a communication group 1319 may be formed when, for example User A, using client device 1307, explicitly invites User B and User C to join a group. This group invitation may be communicated from User A's client device 1307 to a server 1313, which may communicate the group invitation to Users B and C by the unique identification number associated with each Users' respective account. Users B and C may individually accept or reject User A's group invitation. If Users B and C reject User A's group invitation, then no group is formed. If Users B and C accept User A's invitation, then server 1313 may aggregate Users A, B and C into a group 1319 by the unique identification number associated with each user's account.

In another embodiment, a communication group 1319 may be formed when one or more users choose to join an existing group associated with a specific subject matter. For example, a company may create a group 1319 accessible on a server 1313 which the company may enable users to join. A user may access this group 1319 and join that group 1319 which may enable communication between users who chose to join that group.

In another embodiment, a communication group 1319 may be formed among users in a specific geographic location. For example, a school may create a group 1319 on a server 1313 and enable users on that school's campus or in that school's building to join the group 1319. A user may choose whether or not to join a group 1319 and may also automatically join groups in specific geographic locations. A creator of a group 1319 may control access to a group with certain security features, which may include a username and password combination. A creator of a group 1319 may designate one or more users to supervise a group 1319 and/or to control the users in a group 1319 and may further control the content published in that group 1319.

Once users are aggregated into a group 1319, content items may be communicated to and received on each client device 1307, 1309, 1311 associated with an account as defined by the unique identification number and be accessible on the first device to access the content item associated with that account. Content items may also be communicated to and received by all client devices associated with a unique identification number (e.g., iPhone, iPad and Android device all associated with same user's account) and be accessible on each device associated with that account, regardless of when access.

A user of a client device 1307, 1309, 1311 which may have a calendar and/or event schedule feature enabled through for example, a computer application accessible through a UI 1308, 1310, 1312, may input a schedule of events into that event schedule feature.

One or more users of a client device 1307, 1309, 1311 may also create a group 1319 and input a schedule of events for the one or more members of the group 1319 into an event schedule feature enabled through a computer application. The schedule of events inputted for the group 1319 may be a common set of one or more events which each user in that group 1319 may be scheduled to attend and/or participate in. For example, a husband and wife may input a schedule of events they may attend and/or participate in during a vacation trip, which may be common to both users.

One or more users who may be in a group 1319 may also input a schedule of events into an event schedule feature enabled through a computer application containing one or more events common to the group and containing one or more events which may only apply to a subset of users in that group 1319. For example, a business team may travel to a location to conduct a variety of meetings. The business team may have one or more common events in which all members of that team are to attend and/or participate in. An accountant on that business team may be scheduled to attend one or more events that may be different from those scheduled for a lawyer on that business team. The accountant and the lawyer may enter their respective schedules into an event schedule feature in a computer application, which may aggregate in the group 1319 and may show commonalities and differences between the schedules of certain users.

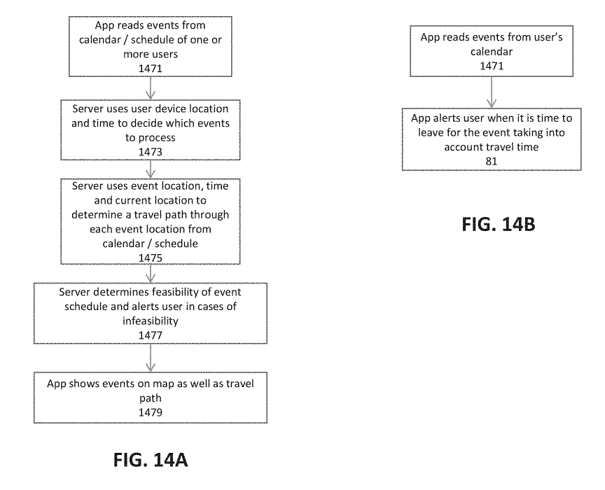

In an embodiment, for example in the embodiment shown in FIG. 14A and FIG. 14B, a computer application associated with the client device 1307, 1309, 1311 of one or more users and associated with systems and methods described herein, may read a calendar/schedule of one or more users 1471. A computer application may read the calendar/schedule in various ways. For example, a server 1313 may import data from the calendar/schedule of a client device 1307, 1309, 1311 of one or more users and may process that data through an algorithm and/or script executable by the server 13. A user may give permission to the server 1313 to access that schedule data and/or the schedule data may be automatically retrieved by a server 1313. Once the algorithm and/or script is executed, the schedule data of one or more users may be aggregated together.

In another example, one or more users may permit a server 1313 to access schedule data on all or a subset of their client devices 1307, 1309, 1311. The server 1313 may execute an artificial intelligence algorithm and/or script which may aggregate schedule data from the client devices 1307, 1309, 1311 of one or more users. A computer application associated with the systems and methods described herein may also read and/or aggregate schedule data from one or more client devices in any other way known by those of ordinary skill in the art.

In an embodiment, a computer application and/or a server may implement one or more algorithms which may be associated with one or more mathematical models and/or machine learning techniques. Algorithms and associated mathematical models may be defined by human who may program functionality of a computer application and/or a server. An algorithm implemented by a computer application and/or server may also predict user actions through one or more machine learning techniques and define content items to be delivered to a user based on actions predicted by the one or more machine learning techniques from the user and/or from one or more other users.

In an embodiment, an algorithm may apply a number of machine learning techniques to determine one or more travel paths for a user from an event schedule. An embodiment of a machine learning technique applied by an algorithm of the present solution may include any machine learning technique such as backpropagation, a clustering technique such as K-means, neural networks, a regression analysis such as logistic regression, or any other machine learning technique.

A machine learning technique applied by an algorithm may retrieve schedule information from the client devices of one or more users and may aggregate the schedule information of one or more users together. The one or more machine learning techniques applied by an algorithm may assign a value to a travel path based on a variety of factors, which may include, fastest travel time, shortest travel distance, points of interest along a travel path such as a user-frequented coffee shop, or any other variable which may be relevant to a user traveling from one place to another.

The one or more machine learning techniques may also assign a value to an action taken by a user in a geographic space, such as visiting a certain store repeatedly, visiting a location at a specific time of the day, etc. The value assigned may be defined by the action taken and may also be defined by the relevance of that action to a user's schedule, such as dry-cleaners on the way to a schedule interview may be scored higher. Actions which have one or more values above a threshold may be chosen by a machine learning technique and may determine one or more travel paths for a user, to a group of users associated with that user, and/or to a cluster of users having an identical schedule to that user as determined by a schedule, such as an education group having an identical class schedule. A travel path between one or more scheduled events may be defined by a value assigned to that path, which may be required to meet a threshold value to be displayed to a user.

A value may be assigned to a travel path according to certain schedule information. For example, if an algorithm determines that two events are scheduled to end only thirty minutes apart, but the travel time required between the locations of those two events will be sixty minutes, the algorithm may assign that travel path a value which may trigger a notification to the user of the infeasibility of completing those events as scheduled. An algorithm may further determine an alternate schedule plan which may enable a user to complete a series of scheduled events according assigned values and may notify a user of that feasible alternate schedule.

Travel paths may be scored by an algorithm according to a score which may weigh parameters of a travel path, such as fastest travel time or points of interest along the route. Weights assigned to a given parameter may be user determined, for example, a user may only care about fastest travel time and thus weight that parameter 100%, and another user may love flowers and therefore weigh florist shops along a travel route highly to account for, for example 50% of the weight given to a travel path determination.

A machine learning technique of an algorithm may retrieve information from third-party information sources, such as a traffic subscription and add that information into a calculation of the time of a travel path. The algorithm may retrieve information in real time and calculate a number of alternative routes of travel which may be weighted in accordance with their significance to a user's schedule. The algorithm may calculate a probability that a user may be late to a scheduled event through a mathematical model that takes into account available information, such as from a traffic subscription.

An algorithm may determine one or more travel paths by coordination of the GPS location of a client device with any coordinate mapping system, such as Google maps. To obtain a travel path, an algorithm may require the current GPS location of a user's client device and GPS location of a destination, which will be mapped onto an available coordinate mapping system. Alternatively, travel paths may be determined for a schedule of events where no current GPS location is known merely by mapping the location of scheduled events onto an available coordinate mapping system.

In an embodiment, an algorithm of the present solution may apply a machine learning technique which aggregates all or a subset of a user's history of actions. For example, a machine learning technique may aggregate the store visit actions of a user within the past two years, two weeks, or any other time period which may be defined by a user, by a server, by an algorithm, or defined in any other way. Using this aggregated data, an algorithm may create an action-reaction map which may associate user actions with the subsequent actions of one or more other users.

An action-reaction map may be in many forms which may include a lookup table where an action by one user is defined in a first row and a reaction by one or more other users is defined in a second row. An action-reaction map may be a mathematical function which defines an action by one user as an input and computes the reaction of one or more other users as an output. The above examples are non-limiting and the algorithm may aggregate data in any way accessible and/or computable via a computer. One or more algorithms may run in series and/or in parallel with one or more other algorithms. Each algorithm may apply one or more machine learning techniques.

A machine learning technique applied by an algorithm may analyze an action-reaction map and may apply a machine learning technique, such as backpropagation, to discover a mathematical model that may predict optimal travel paths based on actions from the action-reaction map. Backpropagation may be an algorithmic machine learning technique which updates values of a set of parameters in a set of mathematical functions. In an embodiment, a backpropagation model may correlate reaction outputs to action inputs and/or correlate action inputs to reaction outputs. A model may be discovered through backpropagation which predicts reactions from actions. From this model, an algorithm may predict a travel path according to historical data of traffic, parades, etc. which may affect travel time. Predicted travel times which may take into account historical data may be displayed to a user and/or group of users together with and/or separate from a currently estimated travel path.

One or more secondary algorithms may apply a model and/or prediction outputs as determined by an initial algorithm. The one or more secondary algorithms may apply an identical and/or different machine learning technique from the initial algorithm. The one or more secondary algorithms may use one or more outputs of other algorithms as inputs to other machine learning techniques and/or mathematical models which may exist individually and/or as a system. A system of machine learning techniques and associated algorithms may be programmed by a human and/or by one or more machine learning techniques over a period of time to process data inputs and outputs in a certain way.

A machine learning technique may learn parameters associated with one or more user actions and assign one or more values to those user actions. Parameters associated with one or more user actions and the values assigned to an action may be corrected over time through an iterative error calculation and correction process. An iterative error calculation and correction process may compute a prediction for a given reaction of one or more other users based on the action of a user. The algorithm may apply the machine learning technique to observe the actual reaction taken by one or more other users. The machine learning technique may then compute a difference between the prediction and the actual reaction, which is the error. The error may then be backpropagated through a mathematical model which updates the parameters of the mathematical model in real time to minimize error.

Over time through iterative error corrections, a machine learning algorithm applied by an algorithm of an implementation of the present solution may enhance predictions of user actions and therefore optimize travel paths between scheduled events. Predictions may be used to inform decisions of a server and/or of a computer application executing an algorithm about which travel paths a user may desire and/or be likely to take between one or more scheduled events. A server and/or computer application may determine one or more travel paths based on a prediction value determined by a machine learning algorithm. Travel paths between scheduled events may also be delivered to one or more users in real time outside of an algorithmic prediction.

Artificial intelligence of users may include all or a subset of available history of a user or user group and may also include third party intelligence, which may include user age, preferences, historical use of the present system, social media history, location and current events occurring in that location. The artificial intelligence algorithm may determine the travel paths between scheduled events displayed to a user or user group through an algorithm executed by at least one server of the system that may maximize or minimize at least one utility function, such as aggregate user preferences or aggregate available history, of the users of a group. The server may display travel paths between scheduled events determined by that artificial intelligence algorithm to a user or user group which may be determined by a similarity measure and/or clustering.

In an embodiment, an artificial intelligence algorithm may apply a machine learning technique which may build similarity measures between users and available user histories, build clusters of users based on available data, predict user actions, and refine predictive algorithms based on collected user data. From inputting available user data such as social media history and interactions (e.g., likes, retweets, friends, etc.), internet browsing data, historical GPS data, historical scheduling data, and any other available data, travel paths between scheduled events may be determined.

A similarity measure may determine, for example, how similar two users are to one another based on available data and/or how well a certain user fits within a group of users based on schedule information. An algorithm may apply a variety of techniques to determine a similarity measure, for example, hemming distance. A plurality of users may be determined to be similar when a machine learning technique determined that the users schedule histories are similar. For example, an algorithm may look up a travel path taken by one user in an action-reaction map defined by a specific circumstance. The algorithm may compare that travel path taken in that specific circumstance with an action taken by one or more other users in a similar or identical circumstance. The comparison of actions in similar circumstances may cause an algorithm to predict a travel path, and this prediction may serve as a basis for determining a travel path for a user in a current schedule.

An algorithm may apply a machine learning technique to cluster groups of a plurality of users together based on a number of human-chosen and/or algorithmically determined attributes of those users. For example, a plurality of users may be clustered into a group based on their schedule information. Users may be clustered by any clustering technique known in the art, for example, K-means. A machine learning technique applied by an algorithm may learn behavior of the one or more users through, for example, creation and analysis of an action-reaction map for each user which may be updated in real time. Based on the machine learning technique analysis, the algorithm may be able to predict actions and/or travel paths of a plurality of users in a category. From these predicted actions, an algorithm may determine travel paths between scheduled events on the client devices of all or a subset of clustered users.

In an embodiment, an algorithm which may apply a machine learning technique may maximize and/or minimize a utility function. Maximization and/or minimization of one or more utility functions may influence the type and timing of travel paths determined for one or more users. A utility function may be a value an algorithm and/or machine learning technique seeks to maximize and may be associated with a business objective. For example, a business may want to target advertisements to a cluster of users that maximizes profitability for that business, profitability being the utility function. The business may distribute an advertisement through a server and/or computer application to client devices of users. The algorithm applying a machine learning technique may track user travel paths related to the business and/or advertisement, e.g., who travels near a store, who clicks on advertisement and who buys an advertised product after clicking. The algorithm may cluster users who bought items pursuant to the first advertisement into a group to which a second advertisement may be sent at a later date, the maximum profitability group. The algorithm will iterate this process again for the second advertisement and so on to track individual users and/or clusters of users to whom advertisements may be most effectively sent to maximize profitability of those advertisements. The algorithm may employ a machine learning technique, such as neural networks, to generate predictions of future user actions based on previous actions. Advertisements may be distributed and displayed jointly to clusters of individuals based on user actions and/or travel paths learned through a machine learning technique that maximizes a desired utility function. An algorithm may adjust the parameters of an advertisement distribution through an iterative error minimization process refined through a machine learning technique.

Predicting may be used by a server and/or computer application to determine travel paths between scheduled events, determine similarity of users, group users in clusters, or to accomplish any other function desired by a human and/or computer.

In another example, one or more users may permit a computer application with a server 1313 access to their schedule and/or calendar on a remote server, database, and/or device (e.g., Google Calendar, a local or cloud database, a second client device, etc.). A server 1313 may import that schedule information to a computer application. A user may also manually enter events into a computer application accessible on a server 13. A computer application and/or a server 1313 may individually or in combination with one another may read the schedule of the one or more users. The schedule of one or more users may be read by a computer application and/or server 1313 using one or more algorithms which may be combined with one or more scripts which may determine which schedule data to read and from which user that schedule data is to be read.

A user may enable or disable the device location module 2C of their client device 1307, 1309, 1311 from transmitting location and/or time information to a server 1313. If a user has enabled the device location module 2C of their client device 1307, 1309, 1311 to transmit location and/or time information to a server 1313, then a server 1313 may analyze that location and/or time information and decide which events from the schedule of one or more users to process and how 1473. If the device location module 2C is enabled on a client device 1307, 1309, 1311, that device may constantly and/or intermittently transmit location and/or time information to a server 1313.

A server 1313 and/or computer application may analyze an event location and time as read from the schedule of one or more users, together with the current location of one or more users 1475 as transmitted from a device location module 2C of a client device 1307, 1309, 1311. The server 1313 and/or computer application may determine the travel time between one or more events in a schedule and may compare that travel time to a various data, which may include information from third-party sources such as traffic reports, reports from public transportation, reports from a city indicating areas of construction, etc. The computer application and/or server 1313 may determine travel time between events by inputting those events to a service such as Google Maps, a GPS service, or any other method of estimating travel time between locations. Through this input, a server 1313 and/or computer application may also determine one or more travel paths from the location of one event to the location of another event 1475. The computer application and/or server 1313 may also compare and supplement analysis of travel time between events with information from a third-party source or a subscription, such as Waze.

A server may determine the feasibility of the event schedule 1477 of one or more users and may alert all or a subset of the one or more users if an event schedule is not feasible 1477. Determining that a schedule is or is not feasible may be done by an algorithm and/or script executed by a server 1313 and/or by a computer application associated with the systems and methods described herein which may include information from third-party information sources 1315. Feasibility of an event schedule refers to the ability of one or more users to attend and/or participate in events as detailed in their schedule. A feasibility determination may comprise an analysis of the total time available to complete an event schedule, the travel time required between events in a schedule, the time of each event in a schedule (e.g., a one hour or three-hour meeting), and third-party information such as traffic reports which may affect the ability of one or more users to attend and/or participate in a schedule of events as planned.

To determine feasibility of an event schedule 1477, a computer application and/or server 1313 first determines a time period in which to analyze feasibility of an event schedule, which may be set by user preferences. The server 1313 and/or computer application then analyzes the schedule of events within that time period. The server 1313 and/or computer application may determine the travel time between successive events (e.g., the first event and the second event, the second event and the third event, etc.). The server 1313 and/or computer application may compare travel times between successive events to the time each event is scheduled for. The server 1313 and/or computer application may determine if sufficient time exists between successive events so that a user may attend and/or participate in those successive events. The server 1313 and/or computer application may also determine a time buffer zone period needed for the user to attend a set of events in succession. The travel time information between successive events may then be presented by the computer application and/or server 1313 to one or more users via the UI 1308, 1310, 1312 of that users' client device 1307, 1309, 1311, who may or may not be in a group 19.

The computer application and/or a server 1313 may then alert one or more users that their schedule of events may be feasible and/or infeasible 1477. Travel time information between successive events may be presented by the computer application and/or server 1313 to one or more users. If the computer application and/or server 1313 determines that insufficient time exists between successive events to account for the travel time between those events, an alert may be sent to the one or more users indicating that their schedule of events is infeasible. Alert data may be presented to the one or more users in any form which may include as a data table, a timetable, a text alert describing infeasibility, an email, a heat map with color differentiations indicating feasibility, a change in thickness and/or color of a travel path to indicate an alert to a user, or in any other way which may convey to one or more users that a schedule of events may be infeasible as scheduled. A user may set preferences for how alert information may be presented to them and for the reasons why alerts and/or travel time reports would be sent by the server 1313 and/or computer application to the user (e.g., user could only wish to receive alerts if insufficient time exists between successive events, a user could request a report of travel time for a specific section of their calendar.

A computer application and/or a server 1313 may also alert one or more users if intervening events, such as a traffic accident, which may compromise or otherwise effect the feasibility of an event schedule. A computer application and/or a server 1313 may import third-party information, (e.g., a Waze subscription, traffic updates from a website, etc.) in real time. The computer application and/or server 1313 may aggregate that third-party information with travel time and travel path information 1475 and alert a user of any changes and/or modifications to feasibility of the schedule in real time 1477. The server 1313 and/or computer application may also send alerts to one or more users of their need to leave a certain event to arrive at another event based on travel time between the locations of each event, which may be influenced and/or modified by an analysis of third-party information.

A computer application and/or server 1313 may execute one or more algorithms and/or scripts which may aggregate any combination of travel time, travel path, and third-party information and determine feasibility of a schedule from that data. A computer application and/or server 1313 analyzing that aggregated data may determine alternate travel paths, alternate modes of travel, or any other variable which may enable a user to feasibly complete an event schedule. The order of steps shown in FIGS. 14A and 14B are non-limiting as a server 1313 may act on schedule data in a variety of orders which may be influenced and/or set by user preferences.

### Example—Feasibility Alert

For example, a first event in a users' schedule is at a first location, starts at 12:00 pm and is scheduled for one hour until 1:00 pm. A second event is scheduled at 1:30 pm at a second location, giving the user thirty minutes of travel time between the first event and the second event. The server 1313 and/or computer application may determine the travel time between the location of the first event and the location of the second event. If the travel time is greater than the thirty minutes available between the two events, the server 1313 and/or computer application may alert the user that their current schedule is infeasible because there is not sufficient time to travel between the first and second events.

In another example, a user could input events and times for those events into their calendar (e.g., Event 1 at Location 1=two hours, Event 2 at Location 2=one hour, Event 3 at Location 3=three hours). The user may then request the server 1313 and/or computer application to schedule those events for the user to maximize, minimize, or otherwise take into account some value. For example, a user could request Events 1, 2 and 3 be scheduled to minimize traffic between the events which may take into account the traffic history of a location according to historical data.

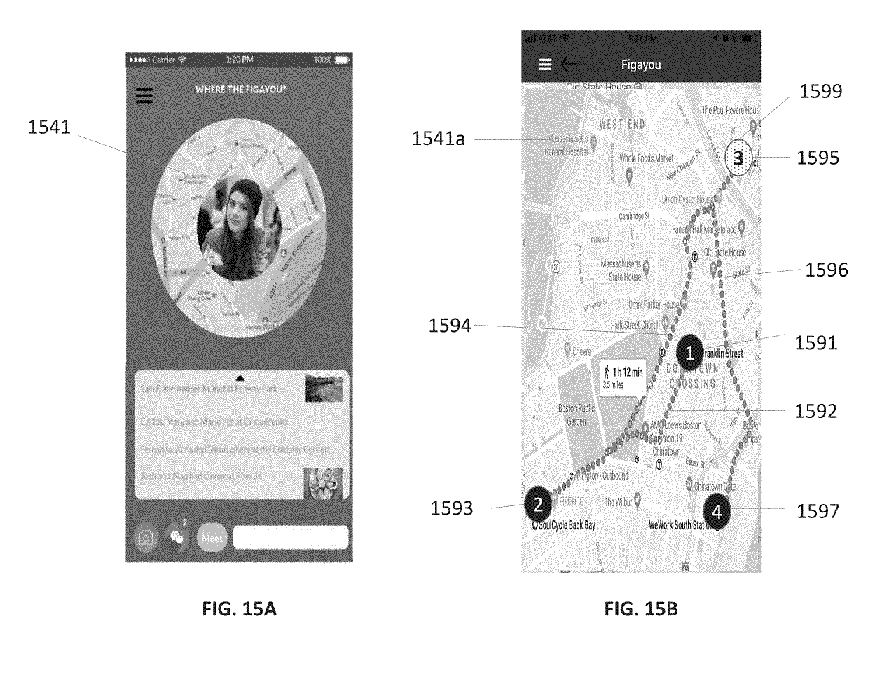

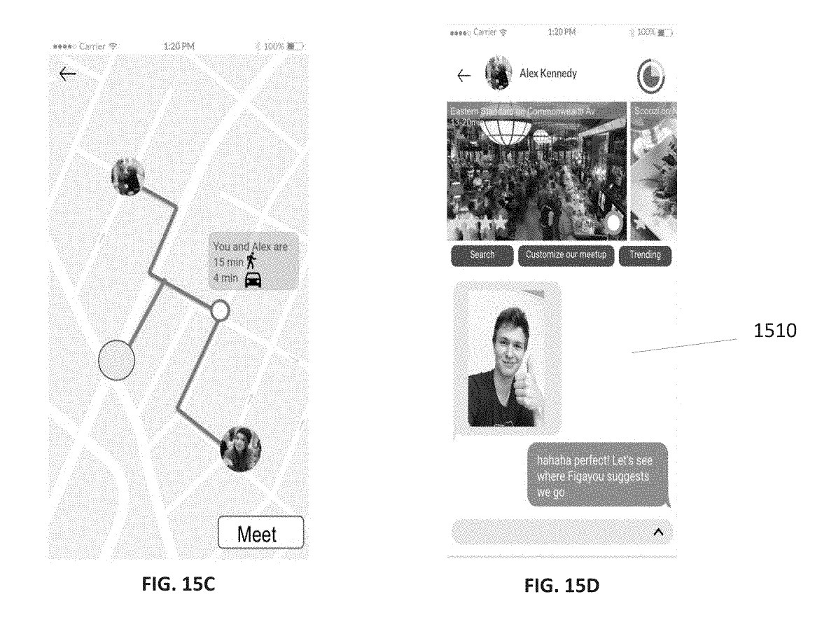

A computer application accessible through a UI 1308, 1310, 1312 of a client device 1307, 1309, 1311 may display scheduled events on a map viewport 1479, 1541, 1541a as shown for example in FIG. 15A and FIG. 15B. The computer application may show travel paths (1592, 1594, 1596) from one event to another. The order and/or direction of those travel paths may be determined by the temporal order in which each event is scheduled and/or may be modified by a user.

A server 1313 and/or computer application may sort events in the schedule of one or more users according to the time of each event. The server 1313 and/or computer application may then determine one or more travel paths from one event to one or more successive events. The directionality of travel paths may be determined by the time of each event in a schedule. For example, Event 1 at Location 1 is at 9:00 am, Event 2 at Location 2 is at 11:00 am and Event 3 is at Location 3 at 1:00 pm. The server 13 and/or computer application may determine travel paths from Location 1 to Location 2 then to Location 3, because the directionality may be determined by the time of successive events.

If one or more users enables the device location module 2C on their client device 1307, 1309, 1311 the server 1313 and/or computer application may include the current location of the one or more users in the calculation of travel paths and display that information on the map viewport 1541, 1541a of the one or more users.

A user may set preferences regarding a variety of elements of the systems and methods described herein. One element may include whether or not to include that user's current location in determining travel paths and travel times among scheduled events, which may be enabled or disabled by a user. Whether or not a user's current location applies in determining travel paths and travel times may also be determined by an algorithm and/or script executed by a server 1313 and/or computer application. The algorithm and/or script may determine not to include a user's current location if, for example, that user is viewing their scheduled events on their map viewport 1541, 1541a next week in a city across the country. The algorithm and/or script may remove that user's current location so the user may visualize their events in the other city. The algorithm may also include information such as that user's flight information and may automatically or by user request include travel information from the airport to the user's first scheduled event.

Another element may enable a user to determine the start and/or end dates for a time period in the schedule of one or more users which a user wants to display on their map viewport 1541, 1541a. For example, a user may be in Boston this week but may be planning a business trip to Los Angeles next week in which that user has many calendar events. The user will be able to set a start date and an end date during which they wish to view their events. In this example, the user may choose to see their entire week's event schedule in Los Angeles displayed on the map viewport 1541, 1541a and may also choose to see their event schedule for each day in Los Angeles displayed on the map viewport 1541, 1541a.

Another element may enable a user to determine the resolution of the map viewport 1541, 1541a, i.e., the user may determine how granular their view of the map viewport is (e.g., show a city block, a whole city, an entire country, etc.). A user may also determine through preference settings the events in a joint calendar between that user and one or more other users which may be displayed on that user's map viewport 1541, 1541a. A user may alter their preferences for specific groups they may be a party to.

As described in FIG. 14B, a computer application and/or server 1315 may also alert one or more users when they should leave their current location to move towards the location of a scheduled event 1481. The time at which the computer application and/or server 1313 alerts the one or more users to leave their current location and move towards the location of an event may be modified by a user according to user preferences. For example, a user may choose to be alerted thirty minutes before they must leave to arrive on time as determined by travel path and travel time, or a user may choose to be alerted at the moment they must leave to arrive on time, etc.

The alert sent to the user may be updated with third-party information (e.g., traffic information) which may modify the time at which an alert is sent to a user. For example, if a traffic report indicates the travel time may take thirty minutes longer than expected and a user has chosen to be alerted fifteen minutes before they must leave, the server 1313 and/or computer application may alert that user forty-five minutes before they must leave, to account for the user's chosen alert period and the traffic report.

Travel time information between successive events may be presented by the computer application and/or server 1313 to one or more users. If the computer application and/or server 1313 determines that one or more users' chosen alert time has been met to leave for an event, an alert may be sent to the one or more users indicating that they must leave their current location and move towards their next scheduled location.

A computer application and/or a server 1313 may also alert one or more users if intervening events, such as a traffic accident, which may compromise or otherwise effect travel time between events. A computer application and/or a server 1313 may import third-party information, (e.g., a Waze subscription, traffic updates from a website, etc.) in real time. The computer application and/or server 1313 may aggregate that third-party information with travel time and travel path information 1475 and alert a user of any changes and/or modifications to travel time between events and/or between current location and an event in real time 1477. The server 1313 and/or computer application may also send alerts to one or more users of their need to leave a certain event to arrive at another event based on travel time between the locations of each event, which may be influenced and/or modified by third-party information.

A computer application and/or server 1313 may execute one or more algorithms and/or scripts which may aggregate any combination of travel time, travel path, and third-party information and determine travel times of an event schedule from that data. A computer application and/or server 1313 analyzing that aggregated data may determine alternate travel paths, alternate modes of travel, or any other variable which may enable a user to feasibly complete an event schedule.

An embodiment of the present solution is shown in FIG. 15B, which shows a computer application showing a map viewport 1541a including a visual representation of a schedule of events. The map viewport 41a shows four scheduled events, numbered 1 (1591), 2 (1593), 3 (1595) and 4 (1597). In this example, the user has not enabled the device location module 2C of their client device 1307, 1309, 1311 because no directions are displayed from the user's current location to the location of event 1591. The device location module 2C may be enabled, which may accordingly display a travel path and a travel time/travel mode indicator 100 on the map viewport 1541a from that user's current location to event 91.

The user's schedule in FIG. 15B is displayed on the map viewport 1541a in accordance with the time of each event. Event 1591 is the first in time, followed by event 1593, then event 1595, then event 1597. Travel paths are shown between events in accordance with the timing of the events. Travel path 1592 shows a path between event 1591 and event 1593, travel path 1594 shows a path between event 1593 and event 1595, and travel path 1596 shows a path between event 1595 and event 1597.

Event 1591, event 1593 and event 1597 are shown as black circles, whereas event 1595 is shown in a light dotted circle, indicating an alert symbol 1599. Event 1595 is shown as an alert symbol 1599 because there is insufficient time allotted between the end of event 1593 and the beginning of event 1595 for the user to attend both events in succession. An alert may be sent to the user in any way described herein to indicate this time deficiency between events 1593 and 1595, along with visually displaying 1595 as an alert symbol 1599 in the map viewport 1541a. The display of an alert symbol and any other symbol shown in FIG. 15B may be customized according to user preferences and the alert sent to the user may also be customized according to user preferences. The systems and methods described herein may suggest changes to the timing of events 1591, 1593, 1595 and 1597 so that the user may feasibly complete these events in succession, which may be automatically generated, generated according to user preference settings or not generated at all.

When an alert is generated, for example as is shown by alert symbol 1599, or at any other time when a plurality of users may be in a group 1319, those users may communicate with one another through a group interface 1510, an example of which is shown in FIG. 15D. The users may use this group interface 1510, to for example, resolve scheduling issues and/or otherwise communicate.

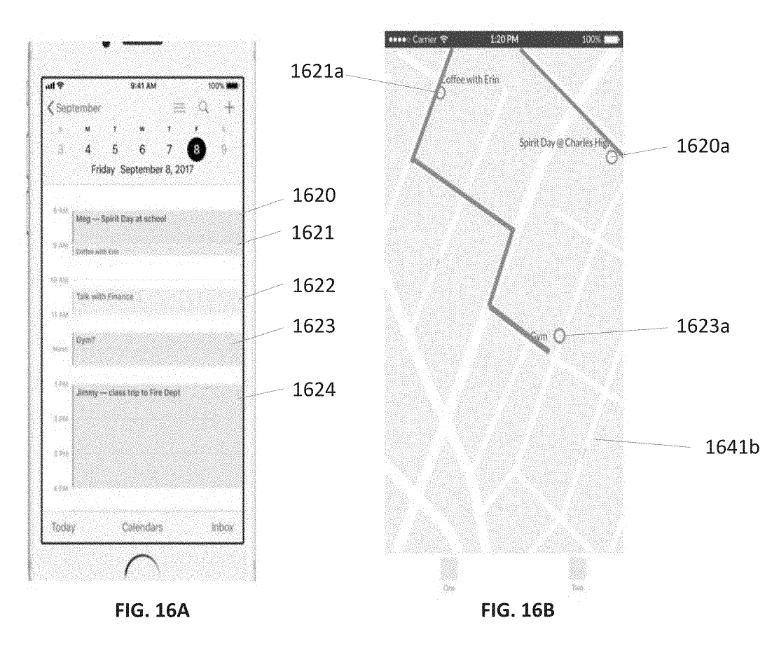

FIG. 16A shows an example of a schedule of events in a calendar of a computer application which may be displayed in a map viewport 1641b. FIG. 16A shows five events scheduled in the users' calendar, Spirit Day 1620, Coffee with Erin 1621, Talk with Finance 1622, Gym 1623, and Jimmy—class trip to Fire Dept. 124.

The user has chosen to display a subset of these events in their map viewport 41b to navigate between these events, Spirit Day 1620a, Coffee with Erin 1621a, and Gym 1623a. The map viewport shows travel paths from one event to the next in time order according to the time of events as scheduled in FIG. 16A.

The fact that Talk with Finance 1622 and Jimmy—class trip to Fire Dept. 1624 from FIG. 5A are not pictured in the map viewport 1641b in FIG. 16B may indicate the user has chosen to exclude these events from the map viewport of FIG. 16B. Further, the Talk with Finance 1622 may merely be a telephone conversation which the user may not attend at any physical location and Jimmy—class trip to Fire Dept. 1624 may be an event for someone other than the user which the user may also not attend at any physical location. Thus, the user may categorize events into subsets which may not require attendance at a physical location, which may be excluded from the map viewport 1641b. This feature may give the user flexibility to design a display of successive events in the map viewport 1641b consistent with a set of events that user may attend at a geographic location.

### F. Dynamically Coordinated Group Navigation

A feature of an embodiment of the systems and methods described herein may include the ability to form groups of one or more users, determine a point of interest (POI) among a group of users of a computer application, and enable a group of users to monitor one another's locations on a computer application map viewport in relation to the determined POI. A POI may be determined through a variety of methods enabled through the systems and methods described herein. A user may customize how one or more other users visualize that users' location on a map viewport. A POI may be a coordinate geographic location and may also be a movable object, such as a tour bus, the client device of a specific user, or any other object whose location may be determined.

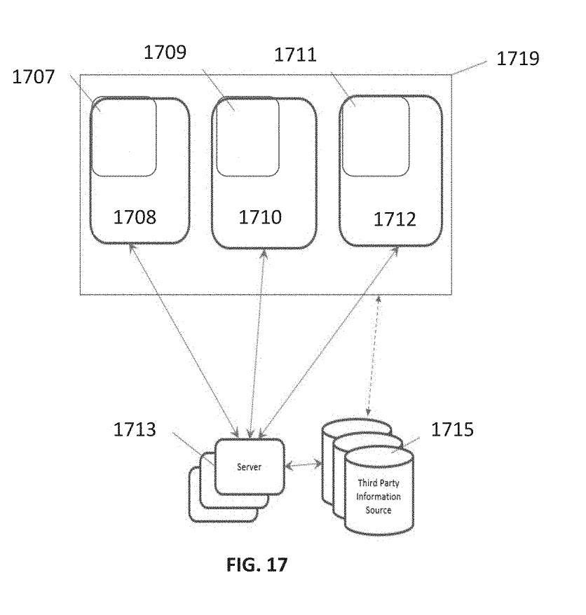

With reference now to the figures, exemplary diagrams of data processing environments are provided in which illustrative embodiments may be implemented. It should be appreciated that FIGS. 17-20 are only exemplary and are not intended to assert or imply any limitation with regard to the environments in which different embodiments may be implemented. Many modifications to the depicted environments may be made without departing from the spirit and scope of the present solution.

FIG. 17 depicts information exchange architecture between at least one client device 1707, 1709, 1711 associated with a user and at least one server 1713, which may have a message broker system enabled and may also exchange information with one or more third-party information sources 1315 in at least one embodiment of the system of the present solution. Each client device 1707, 1709, 1711 has at least one UI 1708, 1710, 1712, and each client device 1707, 1709, 1711 also has a communication unit 2, UI module 2B and device location module 2C as described above. A user of a client device 1707, 1709, 1711 may enter information through the UI 1708, 1710, 1712 to create an account. The user entered information is received by a server 1713 and the server 1713 creates an account for the user by assigning the user a unique identification number, which may correspond to each client device used by that user or may correspond to a subset of client devices associated with a given user's account. For the purposes of FIG. 17 and the following exemplary embodiments of the present solution, User A is associated with client device 1707, User B is associated with client device 1709 and User C is associated with client device 1711.

Grouping

The present solution enables users to interact with one another by communicating through the UI 1708, 1710, 1712, of their respective client devices 1707, 1709, 1711. One aspect of this communication includes the ability for users to form a communication group 19 with at least one other user. A communication group 1719 may be a computing group in which users within that group communicate various content items (e.g., images, text messages, current location, relative location, group invitations, directions request, third-party information, point of interest request etc.) with one another using their respective client devices 1707, 1709, 1711 to the exclusion of other users not included in that group 19.

In one embodiment, a communication group 1719 may be formed when, for example User A, using client device 7, explicitly invites User B and User C to join a group. This group invitation may be communicated from User A's client device 1707 to a server 1713, which may communicate the group invitation to Users B and C by the unique identification number associated with each Users' respective account. Users B and C may individually accept or reject User A's group invitation. If Users B and C reject User A's group invitation, then no group is formed. If Users B and C accept User A's invitation, then server 1713 may aggregate Users A, B and C into a group 1719 by the unique identification number associated with each user's account.

Once users are aggregated into a group 1719, content items may be communicated to and received on each client device 1707, 1709, 1711 associated with an account as defined by the unique identification number and be accessible on the first device to access the content item associated with that account. Content items may also be communicated to and received by all client devices associated with a unique identification number (e.g., iPhone, iPad and Android device all associated with same user's account) and be accessible on each device associated with that account, regardless of when access.

Embodiments of the present solution may enable users to individually or as a group easily meet at a particular POI, monitor one another's location and/or keep a group of individuals together through automatic adjustment of a POI to be located at the center of a group of users. Users of the present solution may enable or disable the device location module 2C of their client device 1. If a user enables the device location module 2C, the client device may continuously update the server 1713 with location data of the device 1. A user may enable or disable the sharing of location data with one or more other users and may selectively enable and disable sharing of location data with other users and/or groups of other users.

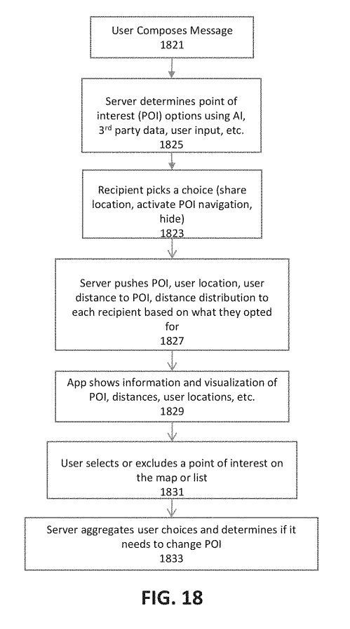

In an embodiment of the solution, for example, as described in FIGS. 17 and 18, a user may communicate a content item through the communication unit 2 of their client device 1707 (FIG. 18 1821). The content item may be communicated 1821 from the client device 1707 to a server 1713, to another user of a client device 1709, 1711 via the server 1713, and/or to the respective client devices of all or a subset of a group 1719 of users. The content item communicated 1821 may be a POI request, a text message, an image, a poll requesting feedback on user preferences for a POI, general third-party information such as a website, specific third-party information such as reviews of points of interest in a given area, for example reviews of a restaurant, or any other information communicable between users of computerized devices. A POI request may be an invitation to share and view one or more common POI's simultaneously on at least one client device associated with at least one user. When a POI request is made and accepted, one or more users who are parties to that POI request may simultaneously receive directions to that POI and view one another's location relative to that POI in real time. Without departing from the spirit and scope of the present solution, a POI request can be made and accepted through a variety of methods and formats and users may visualize one another's location pursuant to that POI request in a variety of ways. One or more content items may be communicated together, for example, a POI request may be communicated together with a text message and a poll requesting users to vote on a list of POI's. A user may also communicate a POI request to a server 1713 and/or a third-party information source 1715.

A POI request may indicate that one or more users may wish to meet at a certain location, for example, a particular restaurant, and may prompt users with options to accept, deny, or otherwise modify the POI requested by the user who communicated the request. The POI request may appear to one or more recipient users as any type of communicable data which may be an individual data element or a combination of one or more data elements. The POI request may include an image, a map, a text message, an action button where a user may input a response to the POI request, or any combination of communicable data elements.

In at least one embodiment, a POI may be chosen 1825 by one or more users through a computer application enabled in a client device to communicate with one or more servers. A server 1713 may determine POI options 1823 for example, using artificial intelligence, third-party information, individual user input, collective user input, or any other means communicable between a client device and a server. A server 1713 may then push that POI 1827 to a group of one or more users together with associated data. Associated data may include location of client devices of one or more users in a group, distance of client device to one or more POI's, and a distance distribution of each client device based on user preferences indicating how that user wants to be visualized in the map viewport 1941, 1941a, of their own client device and in the map viewport 1941, 1941a of client devices of one or more other users in the same group.

In an embodiment, a user may communicate a POI request for a specified location to one or more other users in a group or to a server. This specified POI may be the POI which one or more users receiving that request may be able to reject, accept, or modify.

In an embodiment, a user may communicate an explicit request for one or more POI's matching all or a subset of characteristics indicated by the user. The user may indicate characteristics of desired POI's through a computer application accessible on that user's client device which may be communicated to a server 1713 or directly to a third-party information source 15. Based on the characteristics indicated by the user, the server 1713 may conduct a search for POI's matching that users indicated characteristic preferences through one or more third-party information sources 1715, for example, a Google search. A search may also be done by a server 1713 executing an application programming interface (API) which may execute search programs or algorithms to retrieve information fitting certain characteristics indicated by a user from one or more third-party information sources 1715. The server 1713 may then retrieve relevant information from one or more third-party information sources 1715 and communicate that retrieved information to the client device of the requesting user and/or to any client device associated with or designated by that requesting user. The information may be communicated in various forms, which may include a list of information, a map viewport 1941, 1941a populated with relevant POI's retrieved by the server which may or may not also show associated information such as reviews of the POI's, or in any other form.

Explicit requests for one or more POI's via a server 1713 searching one or more third-party information sources 15 may take a variety of forms. For example, a user may request a list of POI's in a specific geographic area. A user may also request POI's having certain characteristics (e.g., French restaurants near a specific location).

In various embodiments of the present solution, one or more points of interest may be determined, communicated and set through one or more methods and none of these are exclusive of one another. In one or more embodiments, a POI may be communicated and set by one or more users. In this embodiment, users may communicate with one another and for example, vote on POI's to set a POI for a group of one or more users. Further, one or more users may have different levels of access and only a user who has a certain level of access may determine, communicate and set a POI for a group of one or more users.

For example, a cruise ship company may bring a group of individuals to a new city and may have an event schedule planned for those individuals. The company may form a group 1719 for those individuals in accordance with one or more embodiments of the present solution, so that these individuals may communicate with one another and monitor one another's location in the new city. The company may give one of its employees, for example an event supervisor, the ability to set POI's for that event schedule which may be viewable by all of the individuals within that company's group. The company may give individuals the ability to join the group, but not to edit or modify the POI's of the event schedule so that the event schedule remains set according to the company's plans. In another example, a camp counselor may create a group with the campers whom the counselor is supervising. The counselor may be enabled to set and modify POI's, but the campers whom the counselor is supervising may not be enabled to change the POI. This would give the counselor's group the ability to monitor one another's location, but give the counselor control over the location objectives distributed to the campers.

In an embodiment, an artificial intelligence process, for example an algorithm or script executed through a server 1713, may determine a POI for one or more users based on user preferences and/or available user data. For example, the artificial intelligence process (e.g., an algorithm), may determine preference categories for a group 1719 of users. The artificial intelligence script could determine a POI to communicate to a user group 1719 in accordance with preference categories determined by the artificial intelligence algorithm.

In an embodiment, a computer application and/or a server may implement one or more algorithms which may be associated with one or more mathematical models and/or machine learning techniques. Algorithms and associated mathematical models may be defined by human who may program functionality of a computer application and/or a server. An algorithm implemented by a computer application and/or server may also predict user actions through one or more machine learning techniques and define content items to be delivered to a user based on actions predicted by the one or more machine learning techniques from the user and/or from one or more other users.

In an embodiment, an algorithm may apply a number of machine learning techniques to learn available history of a user and/or group of users to determine one or more POI's for that user and/or group of users. An embodiment of a machine learning technique applied by an algorithm of the present solution may include any machine learning technique such as back propagation, a clustering technique such as K-means, neural networks, a regression analysis such as logistic regression, or any other machine learning technique.

An algorithm applying a machine learning technique may retrieve information regarding available history of users involved in a POI request, GPS locations of one or more users who may be involved in a POI request, those users' preferences, events occurring in a local area to the POI request, or any other available information which may be relevant to a specific POI request. The algorithm may process that information and determine a POI, travel path for each user to a POI, way in which each user's location may be presented to one or more other users in a map viewport, and other relevant content information which may be presented to one or more users.

An algorithm may take into account the time of day of the POI request, the user participants to that POI request, user histories of choosing POIs, and histories of travel paths, along with any other available data. The algorithm may value POIs and travel paths based on weighted parameters relevant to one or more users participating in a POI request. For example, if a POI request is communicated in the morning, coffee shops a set of users may frequent may be presented to those users as POIs. If a POI request was communicated at night, bars that set of users may frequent may be presented to those users as POIs. The algorithm may also retrieve third-party information such as the operating hours of a business, promotions, weather, etc. which may influence the choice of which POIs may be presented to one or more users determined by the algorithm. An algorithm may implement a number of other algorithms which may function hierarchically, in series, in parallel, or through any other means of inputting and outputting data with one another. For example, one algorithm may determine values for POIs for each user in a group, another algorithm may compute a travel path which may maximize POIs relevant to a group on the path, and another algorithm may balance maximizing travel by POIs relevant to a group with travel time.

The one or more machine learning techniques applied by an algorithm may assign a value to a POI. The one or more machine learning techniques may also assign a value to an action taken by a user in a geographic space, such as visiting a certain store repeatedly, visiting a location at a specific time of the day, etc. The value assigned to a POI or action taken by a user may be determined by a weighted and/or unweighted aggregation of information. This aggregation of information may include travel time between a user's current GPS location and a POI, quality of a POI as compared to user history and/or preferences, proximity of a POI to one or more other users in a group, etc. Weights may be determined by a user, by a server, by an algorithm, by software of a computer application, or by any combination of these methods. For example, Italian restaurants may be valued higher for individuals who like eggplant parmesan on Facebook, and Starbucks may be valued higher for one or more users who may go to a Starbucks frequently.

Value assigned may be defined by the action taken and may also be defined by the relevance of that action to one or more other users. Actions which have one or more values above a threshold may be chosen by a machine learning technique and may determine one or more content items and/or data packages to deliver to that user, to a group of users associated with that user, and/or to a cluster of users having similar characteristics to that user as determined by a machine learning technique. The client devices of users to which a content item and/or data package may be delivered may be defined by a threshold value assigned to actions of one or more users. A value may be determined for travel path of one or more users to a POI and a POI may be modified by an algorithm to maximize the travel path value of each user to the POI and/or to maximize the value of the POI itself to the one or more users.

An algorithm may aggregate values for POIs from one or more users, sort POIs according to value and then may apply any rules required by a business rule and/or by a rules engine. For example, a men's jewelry store may advertise watches to users who have visited a Rolex website in the past month and pay to have their store appear as a POI to users whose artificial intelligence analysis fits the store's desired customer description. Once rules are applied, an algorithm may broadcast one or more POIs to one or more users and/or groups of users. One or more users may vote on POIs, communicate with one another about POIs, and/or ignore POIs broadcast to them and explicitly choose their own POI and initiate a POI request.

An algorithm will determine the display characteristics of a group of users relative to a POI in a map viewport. One or more algorithms may calculate a distance between a POI and the GPS location of all or a subset of users in a group. An algorithm may then compute a histogram of distances for the users and may identify concentrations of and/or clusters of users in the distance histogram. One or more algorithms may then choose a GPS coordinate point from the distance histogram that conveys a distribution of users, which may or may not display all users in a group and may be modified by a clustering analysis to ensure too much clumping between users and/or POIs on a map viewport occurs. An algorithm may then check the privacy settings of each user and will display a user on the map viewport of one or more other users according to that users' privacy settings. For example, a user may set their privacy settings to be shown to other users as an anonymized relative distance indicator, while another user may set their privacy settings to be shown to other users as an identifiable user indicator. An algorithm will analyze the privacy settings of each user and display that user on the map viewport of one or more other users in accordance with the privacy settings.

In an embodiment, an algorithm of the present solution may apply a machine learning technique which aggregates all or a subset of a user's history of actions taken on all or a subset of content items. For example, a machine learning technique may aggregate the store visit actions of a user within the past two years, two weeks, or any other time period which may be defined by a user, by a server, by an algorithm, or defined in any other way. Using this aggregated data, an algorithm may create an action-reaction map which may associate user actions with the subsequent actions of one or more other users.

An action-reaction map may be in many forms which may include a lookup table where an action by one user is defined in a first row and a reaction by one or more other users is defined in a second row. An action-reaction map may be a mathematical function which defines an action by one user as an input and computes the reaction of one or more other users as an output. The above examples are non-limiting and the algorithm may aggregate data in any way accessible and/or computable via a computer. One or more algorithms may run in series and/or in parallel with one or more other algorithms. Each algorithm may apply one or more machine learning techniques.

A machine learning technique applied by an algorithm may analyze an action-reaction map and may apply a machine learning technique, such as backpropagation, to discover a mathematical model that may predict reactions and/or POIs based on actions from the action-reaction map. Backpropagation may be an algorithmic machine learning technique which updates values of a set of parameters in a set of mathematical functions. In an embodiment, a backpropagation model may correlate reaction outputs and POI requests to action inputs and/or correlate action inputs to reaction outputs. A model may be discovered through backpropagation which predicts reactions from actions. From this model, an algorithm may predict a POI request which may be taken by a user when a user may be, for example, in a group of users who frequent a certain POI. That predicted action done by a user on a content item may be displayed to one or more other users in accordance with the prediction

One or more secondary algorithms may apply a model and/or prediction outputs as determined by an initial algorithm. The one or more secondary algorithms may apply an identical and/or different machine learning technique from the initial algorithm. The one or more secondary algorithms may use one or more outputs of other algorithms as inputs to other machine learning techniques and/or mathematical models which may exist individually and/or as a system. A system of machine learning techniques and associated algorithms may be programmed by a human and/or by one or more machine learning techniques over a period of time to process data inputs and outputs in a certain way.

A machine learning technique may learn parameters associated with one or more user actions and assign one or more values to those user actions. Parameters associated with one or more user actions and the values assigned to an action may be corrected over time through an iterative error calculation and correction process. An iterative error calculation and correction process may compute a prediction for a given reaction of one or more other users based on the action of a user. The algorithm may apply the machine learning technique to observe the actual reaction taken by one or more other users. The machine learning technique may then compute a difference between the prediction and the actual reaction, which is the error. The error may then be backpropagated through a mathematical model which updates the parameters of the mathematical model in real time to minimize error.

Over time through iterative error corrections, a machine learning algorithm applied by an algorithm of an implementation the present solution may enhance predictions of user actions and therefore optimize POIs displayed to users and POI requests generated by one or more algorithms based on predicted actions. Predictions may be used to inform decisions of a server and/or of a computer application executing an algorithm about which POIs and/or POI requests to distribute to a user and when to distribute. A server and/or computer application may distribute a POI and/or POI request to one or more users based on a prediction value determined by a machine learning algorithm. POIs and/or POI requests may also be delivered to one or more users in real time outside of an algorithmic prediction.

In another embodiment, POIs and/or POI requests may be delivered to a user or user group by at least one server according to artificial intelligence obtained from at least one user within a group. Artificial intelligence of users may include all or a subset of available history of a user or user group and may also include third party intelligence, which may include user age, preferences, historical use of the present system, social media history, location and current events occurring in that location. The artificial intelligence algorithm may determine POIs and/or POI requests displayed to a user or user group through an algorithm executed by at least one server of the system that may maximize or minimize at least one utility function, such as aggregate user preferences or aggregate available history, of the users of a group. The server may distribute POIs and/or Poi requests determined by that artificial intelligence algorithm to a user or user group which may be determined by a similarity measure and/or clustering.

In an embodiment, an artificial intelligence algorithm may apply a machine learning technique which may build similarity measures between users and available user histories, build clusters of users based on available data, predict user actions, and refine predictive algorithms based on collected user data. From inputting available user data such as social media history and interactions (e.g., likes, retweets, friends, etc.), internet browsing data and any other available data, POIs may be selected and distributed to one or more users by a server.

A similarity measure may determine, for example, how similar two users are to one another based on available data and/or how well a certain user fits within a group of users based on available data. An algorithm may apply a variety of techniques to determine a similarity measure, for example, hemming distance. A plurality of users may be determined to be similar when a machine learning technique determined that the users' history of actions are similar. For example, an algorithm may look up an action taken by one user in an action-reaction map defined by a specific circumstance or by a specific user preference. The algorithm may compare that action taken in that specific circumstance with an action taken by one or more other users in a similar or identical circumstance. The comparison of actions in similar circumstances may cause an algorithm to predict an action, and this prediction may serve as a basis for selecting and distributing a POI to one or more similar users or to a group of users.

An algorithm may apply a machine learning technique to cluster groups of a plurality of users together based on a number of human-chosen and/or algorithmically determined attributes of those users. For example, a plurality of users may be clustered into a group based on a POI common to that group, POI's historically visited by users in a group, and/or POI's which may correspond to one or more characteristics retrieved from available histories of users in a group, etc. Users may be clustered by any clustering technique known in the art, for example, K-means. A machine learning technique applied by an algorithm may learn behavior of the one or more users through, for example, creation and analysis of an action-reaction map for each user which may be updated in real time. Based on the machine learning technique analysis, the algorithm may be able to predict POI's for a group and/or for one or more users in a cluster. From these predicted actions, an algorithm may determine a POI for one or more users in a cluster and may modify a POI according to available information from a cluster.

An algorithm decides what information to display on a map viewport of one or more users and computes a spatial distribution to determine if too much information is displayed on the map viewport. The algorithm may complete a clustering analysis to determine an optimal granularity for the amount of information presented on a map viewport. For example, an algorithm may compute a distance between the client devices of each pair of users in a group and/or cluster. An algorithm may apply K-means or another clustering algorithm to identify clusters and/or sub-clusters of users. For each sub-cluster, the algorithm may compute the space between a spatial distribution of each cluster and may identify whether one or more sub-clusters overlap with one another. Clustering analysis through K-means or another machine learning technique may calculate a histogram of differences between individual elements, such as individual users, and clusters, such as a group of users in a concentrated area of space relative to one or more other individual elements. An algorithm decides on the granularity of the display shown on the map viewport of a user, for example, the algorithm may only display a user who is the shortest distance from a POI, all users in a group with the user at the maximum distance from the POI at the outer edge of the map viewport, or may only display all information within a median distance of the users to the POI. The algorithm may also complete a clustering analysis on the distribution of elements in a map viewport to determine if there are higher concentrations of information on one area of the map viewport than others, and may selectively show and/or not show those concentrated information areas on the map viewport of one or more users in a group. The algorithm may continue iterating this cluster analysis until there are no more clusters.

Density of information presented on the map viewport of a user may be determined by a user, by a server, and/or by the software of a computer application installed on a client device. For example, if a majority of users in a group are one mile away from a POI while one user is five feet from that POI, the map viewport may display that information by, for example, altering the thickness of user indicators according to their distance from a POI, or otherwise changing how the group as a whole appears to include all or a subset of information about the locations of members of the group.

In an embodiment, an algorithm which may apply a machine learning technique may maximize and/or minimize a utility function. Maximization and/or minimization of one or more utility functions may influence a POI chosen for a group and/or POI options displayed to a group. A utility function may be a value an algorithm and/or machine learning technique seeks to maximize and may be associated with a business objective. For example, a business may want to target advertisements to a cluster of users that maximizes profitability for that business, profitability being the utility function. The business may advertise their, for example, restaurant through a server and/or computer application as a POI available to client devices of users. The algorithm applying a machine learning technique may track user reactions to the advertisement, e.g., who clicks on advertisement and who visits restaurants similar to the advertised restaurant based on available user history. The algorithm may cluster users who visited the restaurant pursuant to the first advertisement into a group to which a second advertisement may be sent at a later date, the maximum profitability group. The algorithm will iterate this process again for the second advertisement and so on to track individual users and/or clusters of users to whom advertisements may be most effectively sent to maximize profitability of those advertisements. The algorithm may employ a machine learning technique, such as neural networks, to generate predictions of future user actions based on previous actions. Advertisements may be distributed and displayed jointly to clusters of individuals based on user actions learned through a machine learning technique that maximizes a desired utility function. An algorithm may adjust the parameters of an advertisement distribution through an iterative error minimization process refined through a machine learning technique.

Predicting may be used by a server and/or computer application to determine POI's which may be of interest to one or more users in a group, determine similarity of users, group users in clusters, or to accomplish any other function desired by a human and/or computer.

In another embodiment, a POI may be determined for a user or user group by at least one server according to third party information, such as an event, or according to a device's location. An event may be defined by third party information, such as promotional advertising, a problem occurring in a specific location in a factory, a remote medical event such as a disease outbreak, and may also be defined by location of a client device, such as the location of a user's device in a museum. The POI may be delivered to a user or user group according to such event or location when, for example, an algorithm of at least one server of the system is triggered by the occurrence of an event or by a location change of a user's client device, which may cause the server to retrieve content from third parties, such as the world wide web or social media platforms, and deliver that retrieved content to a user or user group.

For example, a server and/or computer application may apply an algorithm to determine a POI for a group pursuant to common group interests, that maximizes a utility function, for example, available history of users in a group. One or more POI's may be defined by a human user and/or discovered through a machine learning technique which may create a mathematical model that may maximize a utility function. Models may be computed in series, in parallel, and/or in any combination with another model or sub-model which may perform similar and/or disparate functions. A utility function may be determined by a user, by a server, by a computer application, by other software, and/or by any computer-readable means.

An algorithm may apply a mathematical model which may predict a POI based on, for example, characteristics indicated by a business as being common among their customer base or common characteristics of users in a group. POI's may be distributed to a plurality of users' client devices clustered by the defined characteristics and users in a group may vote on POI's distributed to them. The algorithm may analyze the actions taken by the plurality of users and value POI's according to observed outcomes (e.g., level of user engagement and votes cast), and value a strategy according to the observed outcomes. Through subsequent iterations of this prediction, distribution, observance, and scoring process, an algorithm may determine a POI that maximizes the utility function of user preferences and interest.

The POI determined and communicated to one or more users may be determined by any individual artificial intelligence factor or any aggregation of artificial intelligence factors, including but not limited to any available information or history about a user, which may be, for example, age, user preferences, available history of using a computer application such as an application associated with the system and methods described herein, available internet history, social media history, current location, historical locations, events which may occur or have occurred at a given location associated with a user. The artificial intelligence script or process may aggregate artificial intelligence from one or more users in a group 19 and may maximize, minimize, or in any other way statistically determine preferences of a group 19 or individual user. The POI may be determined by the programming of the artificial intelligence process, which may instruct the server to, for example,

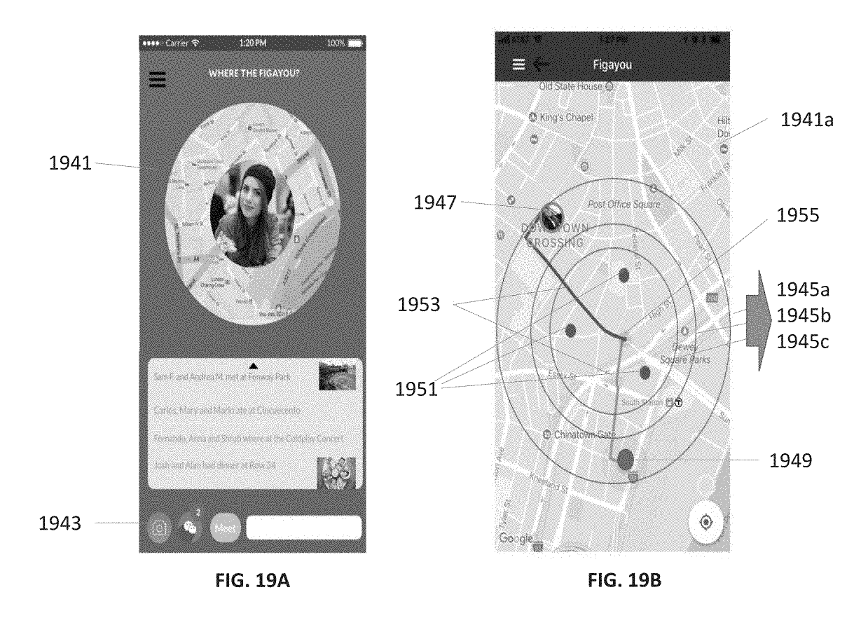

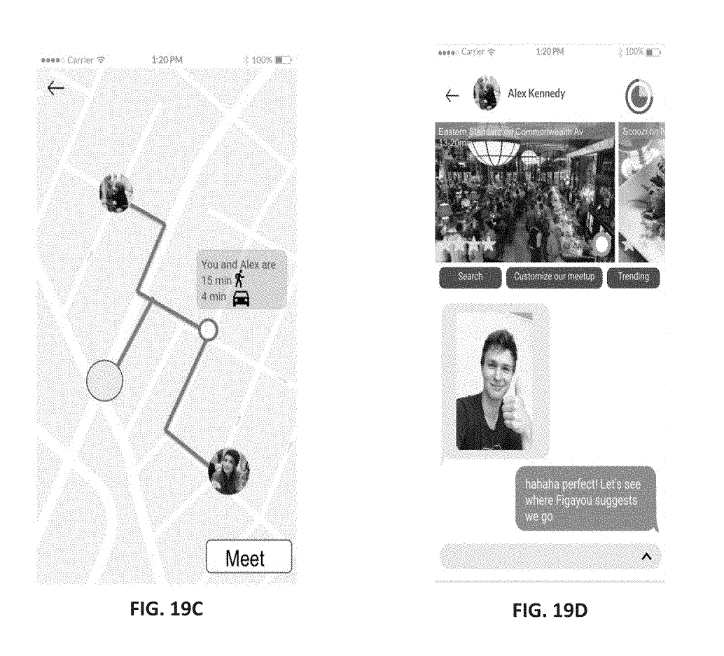

In another embodiment, one or more third-party information sources 1715 may influence and/or determine a POI 1825 among one or more users. For example, if one or more users explicitly choose Restaurant A as their POI, that restaurant will close at a certain time. A server 1713 may communicate with a third-party information source 1715, such as a website, to retrieve information about Restaurant A. This information may include reviews of the restaurant which may be displayed to users in a computer application, the hours of operation of Restaurant A, and may also include similar restaurants to Restaurant A in the area, which may or may not have different hours of operation. If the one or more users planned to have dinner at Restaurant A at 10:00 pm, for example, and Restaurant A closes at 9:30 pm, the server 1713 may retrieve that information from the third-party information source 1715 and notify the one or more users of the discrepancy (e.g., that Restaurant A will be closed at the users' planned meeting time). The server 1713 may further change the POI to a new restaurant with similar characteristics to Restaurant A, which may or may not be in a similar geographic location. The server may push a message to each user describing the changed POI and may further update the map viewport (FIG. 19A 1941 and FIG. 19B 1941a) in each or in a subset of the one or more users in a group computer application accessible through the UI of their client device. The server 1713 may also push a list of alternative POI's 1951 to Restaurant A to the one or more users retrieved from a third-party information source 1715, to enable the users to choose a new POI. This list of potential new POI's may be visible to the one or more users as a list, as POI's in the map viewport 1941, 1941a or in any other way and may include any data associated with the alternative POI's 1951 from the third-party information source 1715.

In various embodiments of the present solution, a user may request and use third-party information via a server 1713 and/or execute an algorithm executable through the server 1713 to determine and communicate POI's 25.

A user may also request a POI or information associated with one or more POI's from one or more third-party information sources 1715 through their client device via a server 1713. The server 1713 may retrieve information from one or more third-party information sources 1715 and communicate that information to the requesting user. The user may manually enter that retrieved information into a computer application associated with at least one system and method described herein. For example, a human resource coordinator may request information from a third-party information source, such as monster.com, via a server about candidates for a job description who match a specific set of characteristics. The server may retrieve information about candidates whose resumes match all or a subset of the characteristics defined in the human resource coordinator's search. The human resource coordinator may then browse that list, choose desired candidates, and enter their information into a system which may indicate a POI at which that candidate's interview will be conducted.

In an embodiment, POI's may also be chosen and/or updated from a third-party information source, for example from a subscription to a feed. A feed may be an intermittently or constantly updated set of information, such as weather conditions or traffic conditions, taken from a third-party information source.

For example, a user may seek to eat at a three-star or above restaurant and may have chosen a restaurant fitting these criteria, Restaurant B, in a given area as a POI 1955. An API, algorithm, or other programmed means executable on a server 1713 may retrieve information from a subscription to a traffic feed that is constantly updated. Between the time the user selects Restaurant B as a POI and the time the user embarks on their journey to Restaurant B, a car accident on a highway occurs which may severely extend that user's travel time. Information may be retrieved by the server 1713 from the subscription to the traffic feed and alert the user to this change of travel time. The server may further update the user with additional options of three-star or above restaurants in a given area, the travel to which may not be affected by the car accident indicated by the traffic feed. The user may be prompted to choose between staying on the same course to Restaurant B, to choose a new POI unaffected by the car accident, and/or a new restaurant may be automatically chosen for the user and directions in the computer application may be automatically re-routed to that new POI. The action taken by the server in updating the POI of the user may be set and modified by user preferences and the user may override any choice made by the server.

In some embodiments, a POI may be chosen and/or modified by collective input of a plurality of users in a group 1719. In an embodiment, all or a subset of the alternative POI's, as viewable by users in the map viewport 1941, 1941a, may be interactive polls which one or more users in a group may vote on. For example, FIG. 19B shows three alternative POI's 1951 to the POI 1955 to which one or more users have obtained directions. To vote on these three alternative POI's 1951, a user may take an action on the icon indicating the alternative POI 1951 by, for example, pressing on the alternative POI 1951 on a touch screen of a client device. The alternative POI's may indicate levels of interest of a group of one or more users by aggregating the votes of users and by for example, changing color and/or shape based on vote total, being highlighted in a specific way, growing or shrinking in size based on vote totals, or any combination. The POI 1955 of the one or more users may change to an alternative POI 1951 if, for example, a majority of the group votes for that alternative POI, if a vote total reaches a threshold value, or any other way which may be set and/or modified by user preferences. User preferences may be set which may require a new POI to be determined by at least a threshold level of agreement of one or more users. User preferences may also enable a server 1713 to automatically update the POI of one or more users based on information retrieved from one or more third-party information sources 1715.

In another embodiment, one or more users in a group may send a poll to one or more other users in that group, which may be a poll viewed as a list of POI options and/or viewed as POI points on a map. One or more users who did not send the poll may send POI suggestions to the group and these suggestions may be automatically added to the poll. When users in a group populate a poll with suggested choices, users in that group may choose from the choices suggested by other users in that group in real-time.

Changing a POI from one POI to another may be determined by any set of rules programmable into a computer interface and/or created or set by one or more users in a group. For example, changing from one POI to another may be determined by a majority vote, by a pre-determined vote threshold, a majority vote subject to one or more users having the ability to veto a decision, a pre-determined vote threshold having a veto provision, or any other method which may be programmed, created, and/or set by the parties. The set of rules may be set by user preferences within for example, a computer application. A server may communicate a decision of POI changes to all or a subset of devices in a group and a POI change may be based on an artificial intelligence process, third-party information, a collective user vote, an individual user vote, or any other means communicable through a computer readable medium.

When a content item is communicated from the client device 1707 of a user to the client device of one or more other users 1709, 1711, the recipient users may take an action on the content item communicated (FIG. 18 1825). For example, if a user communicates a POI request to one or more other users, those recipient users may share their location both as a relative position to a POI and as an absolute coordinate location, may activate POI navigation in the user's map viewport 1941, 1941a (See, FIG. 19B), may hide their own location and activate POI navigation allowing that user to see other users' locations in the map viewport 1941, 1941a, may hide their own location and not activate POI navigation, and/or may take no action at all. When a user does take an action on a POI request, that action is pushed to a server 1713. The subsequent action of the server 1713 depends on the action taken on the POI request by the user and on preferences set by the user.

In an embodiment of the present solution, if a user accepts a POI request, the server 1713 may activate POI navigation (See, FIG. 4B) on the client device of a user who has accepted a POI request. In activating POI navigation, the server 1713 may push 1827 the one or more POI's of the POI request accepted by the user, the location of the client device of the user, the distance between the user's client device and the distance distribution of each client device based on user preferences indicating how that user wants to be visualized in the map viewport 1941, 1941a, of their own client device and in the map viewport 1941, 1941a of client devices of one or more other users in the same group.

The device location module 2C of the recipient user's client device 1709, 1711 may send location information of that recipient user's client device to the server 1713. The server 1713 may, by processing that recipient user's response through an algorithm or by retrieving third-party information related to that user's response, may push directions 1953 from the current location of the recipient user's client device 1709, 1711, to a POI or client device of another user.

If a recipient user denies a POI request, the server 1713 will not push 27 that denying user's location to one or more other users and will not include that user in a POI activation among a group 1719.

In an embodiment, if a user accepts a POI request that user may determine through preference settings how one or more other users in a group may view that users' personal profile and/or absolute or relative location on the map viewport 1941, 1941a. There may be various dimensions of visibility for a user on a map viewport 1941, 1941a which may include appearing identifiable or anonymous and appearing at an absolute location or at a location relative to the POI. A user may choose to be shown as any combination of identifiable/anonymous/absolute location/relative location and these categories are not exclusive as the user may also have additional preference options which may determine how that user appears in the map viewport 1941, 1941a of their own client device and in the client device of other users. Users may change their visibility preferences for each group 1719 they may be associated with and may change their visibility preferences for each POI request. A user's distance may be expressed on the map viewport 1941, 1941a as a physical distance, a time-travel distance or in any way a distance may be measured from one or more POI's 1955 or from one or more other users.

In an embodiment, a user may opt to be shown to other users who may be parties to an identical POI request on a map viewport 1941, 1941a, or in the same group, as an identifiable user indicator 1947. A user choosing to be shown as an identifiable user indicator 1947 may show personal information to other parties to the POI request such as a photo, name, and any other personal information that user may wish to share with members of a group.

In an embodiment, a user may opt to be shown to other users who may be parties to an identical POI request on a map viewport 1941, 1941a, or in the same group, as an anonymized user indicator 1949. A user choosing to be shown as an anonymized user indicator 1949 will not allow other users who may be in the same group or who may be parties to the same POI request to view any personal information associated with that user.

A user may also choose to be identifiable as a relative distance user indicator 1945, which would enable one or more other users to view that user as a line relative to a POI 1955 consistent with that user's distance from the POI 1955 without revealing that user's absolute location. A user may choose to be either an identifiable relative distance user indicator 1945a or an anonymous relative distance user indicator 1945b.

A user choosing to be shown as an identifiable relative distance user indicator 45a will appear as a line relative to a POI 1955 which will show that user's personal information such as name and photo. The user's personal information may be visible when another user, for example, scrolls over that identifiable relative distance user indicator 1945a or selects that user's identifiable relative distance user indicator 1945a.

A user choosing to be shown as an anonymous relative distance user indicator 1945b will appear as a line relative to a POI 1955 which will not show any of that user's personal information if another user, for example, scrolls over or selects that user's anonymous relative distance user indicator 1945b.

A user may also to not share their location in any way with any other user in a group or who may be a party to an identical POI request. In denying one or more other users in a group or users who may be parties to an identical POI request access to any location or personal information associated with that denying user, that denying user may still activate POI navigation pursuant to that same request. Thus, the user may be able to see themselves in relation to a POI on their own device, but none of this denying user's location or personal information may be pushed by the server 1713 to any other client devices.

In an embodiment, only those users who mutually agree to share their own location may be able to see the location of other users in a group or who may be a party to an identical POI request. In another embodiment, any user who does or does not share their location may be able to see the location of other users in a group or who may be a party to an identical POI request. In another embodiment, roles can be specified for specific users (e.g., a doctor or group leader may have different location share settings than other users in a group).

A user may determine rules for how other individual users, groups of users, and individuals and groups in a specific location view that user on their respective map viewports 1941, 1941a.

In an embodiment, a user may explicitly designate a particular person and/or a particular group of people to have a specified level of access to a given user's information. A user may selectively choose to share certain information with certain users in a group or who may be parties to an identical POI request. A user may also selectively deny access to all or a subset of other users in a group or who may be parties to an identical POI request to all or a subset of that user's personal information. A user may also designate certain users or groups of users to have full or any level of limited access to that user's personal or location information. For example, a user may explicitly designate their ex-wife to not be able to see any of their information, but may allow their brother to see all of their information. A user also may selectively allow, for example, their parents to see personal information, but not see all location information if for example that user was in Las Vegas. A user may also grant or deny access to all or a subset of personal and/or location information to all users of a computer application who may be within a certain geographic area, for example, in the same bar, in the same block, in the same city, or within the same country, etc.

Once a recipient of a POI request makes a choice and acts on that request, the server 1713 may push 1827 information to the client devices of one or more other users in a group who may be parties to the same POI request in accordance with the preferences of the user acting on the request. The server 1713 may push the recipient user's location, the POI of the request, POI's suggested by the recipient user, distance of recipient user to the POI 1955 and/or a relative distance distribution of that recipient, in accordance with the user's preferences. Once a user activates a POI navigation request, a server 1713 may locate all or a subset of devices who may be parties to an identical POI request. If a user has location preferences disabled, the server 1713 may still be able to locate the client device of that user, but may not push that user's location to one or more other users in a group or users who may be parties to an identical POI request.

In an embodiment, a server 1713 of the present system may have a sharing policy engine which may execute an algorithm and/or script that determines how user information may be shared and also determine which user may have access to which information of one or more other users. The engine may analyze a database and/or tables of information and may execute an algorithm and/or script that weighs various factors of user preferences and data sharing. The algorithm and/or script of this sharing policy engine may first determine a first users' location share settings. Then, the sharing policy engine may determine the location share settings of one or more other users, for example, a second user. Then, the sharing policy engine may determine whether the location share settings of the first user and second user permit the server to push the first users' and second users' location information to one another. A server 1713 maintains a record of each users' settings and these settings may be compared by the sharing policy engine to determine the eligibility of information from each user to be shared with any and all other users. Different groups of users and different individual users may have different share settings which may increase or decrease the amount of information able to be shared amongst users via the sharing policy engine of the server 1713.

### Example 1

In an embodiment, other users in a group may only be able to view a given user on their map viewport 1941, 1941a at the location share setting the other users set for themselves. For example, User 1 may set their preferences so that other users may only view them on the map viewport as an anonymous relative distance user indicator 1945b from the POI 1955. User 1 will be able to see themselves as a point 1949 at an absolute location on the map viewport 1941, 1941a, but all other users in the group may only view User 1 as an anonymous relative distance user indicator 1945b. If other users enable others in the group to view them as an identifiable user indicator 1949, User 1 will still only be able to see those other users as anonymous relative distance indicators 1945b because those are the settings User 1 chose to be viewable as. If User 1 chose to not share their location at all, then User 1 would not be able to see the locations of any other users. In this embodiment, a user may only view other users in the map viewport 1941, 1941a as specifically as that user allows others to see them in the map viewport 1941, 1941a.

### Example 2

In another embodiment, any user may see all other users in a group according to the location share settings of each user. For example, User 1 dos not share location settings, User 2 enables an identifiable user indicator 1947 and User 3 enables an anonymous relative distance user indicator 1945b. Each user will view the other users at the location share setting that each user set. User 1 will view User 2 as an identifiable user indicator 1947 and view User 3 as an anonymous relative distance user indicator 1945b, even though User 1 has chosen not to share their location at all.

Any combination of settings may be chosen by a group or by one or more individual users to control how users in a group or who may be parties to a particular POI request view one another in the map viewport 1941, 1941a.

In an embodiment, when the server 1713 pushes 1827 appropriate data to appropriate client devices, a computer application accessible through the UI of an appropriate client device may display the pushed data 1829 through a visualization shown for example, in FIG. 19B.

One or more devices operating a computer application in accordance with one or more embodiments of the present solution may continuously communicate with a server 1713. When a user enables location sharing on their device, that device may continuously send the location of that device to the server 1713. The server 1713 may execute an algorithm and/or script which processes data sent from each device. The algorithm and/or script may process data in accordance with a user's preferences, so that when a users' data is pushed 1827 to one or more external devices, that users' data is displayed 1829 on the client devices of one or more other users in accordance with that users' preferences. The way the algorithm and/or script executed by the server 1713 processes data to present that data to one or more external client devices can be determined by user preferences, by an algorithm, can be pre-set or any combination.

The concentric circles shown in FIG. 19B may be relative distance user indicators 1945a, anonymous relative distance user indicators 1945b, and may also be statistical distribution indicators 1945c which relate to the distance users in a group may be from one or more POI's 1955. Statistical distribution indicators 45c may be computed by an algorithm executed on the server 1713 and may represent a statistical distribution of the distances of one or more devices from a POI 1955. The statistical distribution indicators 1945c may represent points in the calculated distribution of devices in an area based on the desired granularity of the distribution according to the algorithm, which may be set by user preferences, pre-determined, specific for a certain group size or determined in any other way. The statistical distribution indicators 1945c may represent a variety of calculations of data of device distances from a POI, including statistical estimates of the quartile group distances from the POI 1955, the median distance of devices in the group from the POI 1955, the mean distance of devices in the group from the POI 1955, only the distance of a single device furthest from the POI 1955, the distance of every single device in the group from the POI 1955, a line indicating that 80% of devices in a group are closer to a POI 1955 than the device of a specific user is, or any other statistical analysis of device distances or measurement of device distances from one or more POI's 1955.

Statistical distribution indicators 45c are not limited to concentric circles around a POI 1955. Statistical distribution indicators may be displayed in a computer application on a client device as, for example, numbers indicating any measure of statistical distance from a POI 1955 either absolutely and/or relative to grouped devices, a text narrative describing one or more features of a statistical distribution, in a graphical representation such as a pie chart, line chart, bar chart, as visualizations on the map viewport 1941, 1941a such as one or more circles, squares, triangles, or any other shape around or relative to a POI 1955 where each visualization represents a statistical distribution of a desired granularity, or any other way to convey statistical data to a user of a computing device.

The limits of a map viewport 1941a may be automatically scaled to fit an entire distribution of devices in a group. The limits of a map viewport 1941a may also be pre-determined, for example, set by an algorithm to show 80% of user devices in a group. The limits of a map viewport 1941a may also be set by pre-determined preferences to a specific geographic area on a map at a desired granularity.

A user may select or exclude 31 a POI 55 displayed on the map viewport 1941, 1941a or from a list of POI's 1955. It is envisioned herein that multiple POI's may be displayed to a user and/or group of users. It is further envisioned herein that a user may selectively exclude one or more POI's 1955 from their own map viewport 1941a which may or may not affect that same POI 1955 as it appears on the map viewports 1941a of one or more other users.

A server 1713 may aggregate the choices of one or more users, which may be choices to vote on POI's, exclude POI's, choose POI's, distance of users from POI's, or otherwise interact with POI's and with one another in a group 1719. The server may execute an algorithm and/or script to determine whether, based on user choices, the server may or must modify a POI 1955 of a group of one or more users.

As a POI may be a coordinate geographic location and may also be a movable object, such the client device of a specific user, or a tour bus none of the embodiments described herein referring to a POI at a fixed geographic location, such as a restaurant, are to be construed as limiting in any way. POI's of the present solution may be dynamic and/or static. It is envisioned herein that any embodiment herein described relating to a static POI may also be practiced according to the systems and methods described herein relating to a dynamic POI.

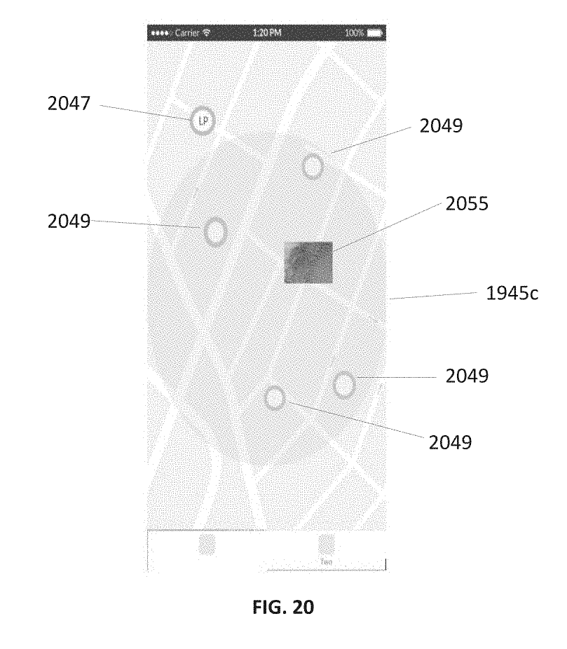

An example embodiment of the systems and methods of the present solution is shown in FIG. 20. FIG. 20 shows a screenshot of a client device operating a computer application with activated POI navigation showing the locations of the client devices of a group 1719 of five users in relation to a POI 1955 and a statistical distribution indicator 1945c. Four of the five users are shown as anonymized user indicators 49 while one of the users is shown as an identifiable user indicator 2047, the screenshot shows that user identified by initials “LP”. Compared to the identifiable user indicator 2047 in FIG. 4B, the identifiable user indicator 2047 shown here in FIG. 5 reveals much less information about the user. The level of information revealed about a user based on the indicator shown to other users in a group 1719 may be controlled by user preferences. The statistical distribution indicator 1945c here shows 80% (4/5) of the users in the group 1719 within the radius of the statistical distribution indicator 1945c in relation to the point of interest and/or in relation to one another.

The present solution has been described in particular detail with respect to a limited number of embodiments. Those of skill in the art will appreciate that the solution may additionally be practiced in other embodiments.

Within this written description, the particular naming of the components, capitalization of terms, the attributes, data structures, or any other programming or structural aspect is not mandatory or significant, and the mechanisms that implement the solution or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the feature of the present solution in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “selecting” or “computing” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present solution include process steps and instructions described herein in the form of an algorithm. It should be noted that the process steps and instructions of the present solution could be embodied in software, firmware or hardware, and when embodied in software, could be downloaded to reside on and be operated from different platforms used by real time network operating systems.

The present solution also relates to an apparatus for performing the operations herein. This apparatus may be specially constructed for the required purposes, or it may comprise a general-purpose computer selectively activated or reconfigured by a computer program stored in the computer. Such a computer program may be stored on a non-transitory computer readable storage medium, such as, but is not limited to, any type of disk including floppy disks, optical disks, DVDs, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present solution is not described with reference to any particular programming language. It is appreciated that a variety of programming languages may be used to implement the teachings of the present solution as described herein, and any references to specific languages are provided for disclosure of enablement and best mode of the present solution.

Finally, it should be noted that the language used in the specification has been principally selected for readability and instructional purposes, and may not have been selected to delineate or circumscribe the inventive subject matter. Accordingly, the disclosure of the present solution is intended to be illustrative, but not limiting, of the scope of the solution.

What is claimed is:

1. A method for group navigation using mobile computing devices, the method comprising:
(a) establishing, via a server, a communication group between mobile computing devices of a plurality of users;
(b) receiving, by the server, from a first computing device of a first user of the plurality of user in the communication group a request for a point of interest for the plurality of users to navigate to as a common meeting location among the plurality of users;
(c) determining, by the server, one or more points of interests for the plurality of users to meet based at least on each user's current location of respective mobile computing devices and user data;
(d) communicating, by the server, to each of the mobile computing devices of the plurality of users in the communication group one or more locations of the one or more points of interest determined by the server; and
(e) communicating, by the server, information about a current location of each of the users of the plurality of users relative to the one or more locations of the one or more points of interest to be displayed on a map viewport shared by each of the mobile computing devices.

2. The method of claim 1, further comprising communicating, by the server, updates to each location of each of the users relative to the one or more locations of the one or more points of interests as the users navigate towards the one or more points of interest to be displayed on the may viewport of each of the mobile computing devices.

3. The method of claim 1, wherein user data comprises one or more of the following: user preferences, user history of selecting points of interests and user history of travel paths.

4. The method of claim 1, wherein (c) further comprises determining, by the server, the one or more points of interest at least based on a time of day.

5. The method of claim 1, wherein (c) further comprises determining, by the server, the one or more points of interests at least based on events occurring near the one or more locations of the one or more points of interest or a current locations of one or more of the plurality of users.

6. The method of claim 1, wherein (c) further comprises determining, by the server, the one or more points of interests at least based on a travel time from a current location of one or more users of the plurality of users to the one or more locations of the one or more points of interest.

7. The method of claim 1, wherein (c) further comprises determining, by the server, the one or more points of interests at least based on a proximity of the one or more locations of the one or more points of interest to each of a current location of the one or more users of the plurality of users.

8. The method of claim 1, wherein (d) further comprises communicating, by the server, a travel path from a current location of a user of the plurality of users to a location of the one or more locations of the one or more points of interests to the mobile computing device of the user of the plurality of users.

9. The method of claim 1, wherein (d) further comprises receiving, by the server, a selection of the one or more points of interest from one or more of the users, wherein each mobile computing device displays the one or more points of interest to each user of the plurality of users to take a poll on which point of interest to meet at.

10. The method of claim 1, wherein (b) further comprises receiving, by the server, the request comprising information for a type or category of the point of interest or a name of the point of interest.
